(19) United States
(12) Patent Application Publication
(10) Pub. No.: US 2026/0032234 A1
(43) Pub. Date: Jan. 29, 2026

(54) METHODS AND DEVICES FOR INTRA BLOCK COPY

(71) Applicant: BEIJING DAJIA INTERNET INFORMATION TECHNOLOGY CO., LTD., Beijing (CN)

(72) Inventors: Wei CHEN, San Diego, CA (US); Xiaoyu XIU, San Diego, CA (US); Changyue MA, San Diego, CA (US); Hong-Jheng JHU, San Diego, CA (US); Che-Wei KUO, San Diego, CA (US); Ning YAN, San Diego, CA (US); Xianglin WANG, San Diego, CA (US); Bing YU, Beijing (CN)

(73) Assignee: BEIJING DAJIA INTERNET INFORMATION TECHNOLOGY CO., LTD., Beijing (CN)

(21) Appl. No.: 19/344,206

(22) Filed: Sep. 29, 2025

Related U.S. Application Data
(63) Continuation-in-part of application No. PCT/US2024/022361, filed on Mar. 29, 2024.
(63) Continuation-in-part of application No. PCT/US2024/025061, filed on Apr. 17, 2024.
(63) Continuation-in-part of application No. PCT/US2024/029016, filed on May 12, 2024.
(60) Provisional application No. 63/455,544, filed on Mar. 29, 2023.
(60) Provisional application No. 63/460,294, filed on Apr. 18, 2023.
(60) Provisional application No. 63/466,133, filed on May 12, 2023.

(51) Int. Cl. H04N 19/105; H04N 19/139; H04N 19/176; H04N 19/513; H04N 19/52; H04N 19/86

(52) U.S. Cl. CPC H04N 19/105; H04N 19/139; H04N 19/176; H04N 19/52; H04N 19/521; H04N 19/86

(57) ABSTRACT

Methods for video decoding and encoding, and apparatuses are provided. In one video decoding method, a decoder may obtain fractional motion information for a current block in an intra block copy (IBC) mode; obtain a block vector (BV) for the current block based on the fractional motion information; obtain a prediction block for the current block based on the BV; and in response to meeting a condition, conduct, or skip partially or fully, a padding process on one or more samples associated with an interpolation filter.

### CROSS-REFERENCE TO RELATED APPLICATION

The present application is based upon and claims priority to International Application No. PCT/US2024/022361, filed on Mar. 29, 2024, which claims priority to U.S. Provisional Application No. 63/455,544, filed on Mar. 29, 2023, and to International Application No. PCT/US2024/025061, filed on Apr. 17, 2024, which claims priority to U.S. Provisional Application No. 63/460,294 filed on Apr. 18, 2023, and to International Application No. PCT/US2024/029016, filed on May 12, 2024, which claims priority to Provisional Application No. 63/466,133 filed on May 12, 2023, all disclosures of which are incorporated herein by reference in their entireties for all purposes.

### TECHNICAL FIELD

The present disclosure is related to video coding and compression, and in particular but not limited to, methods and apparatus on improving the Intra Block Copy (IBC) method in a video encoding or decoding process.

### BACKGROUND

Digital video is supported by a variety of electronic devices, such as digital televisions, laptop or desktop computers, tablet computers, digital cameras, digital recording devices, digital media players, video gaming consoles, smart phones, video teleconferencing devices, video streaming devices, etc. The electronic devices transmit and receive or otherwise communicate digital video data across a communication network, and/or store the digital video data on a storage device. Due to a limited bandwidth capacity of the communication network and limited memory resources of the storage device, video coding may be used to compress the video data according to one or more video coding standards before it is communicated or stored. For example, video coding standards include Versatile Video Coding (VVC), Joint Exploration test Model (JEM), High-Efficiency Video Coding (HEVC/H.265), Advanced Video Coding (AVC/H.264), Moving Picture Expert Group (MPEG) coding, or the like. Video coding generally utilizes prediction methods (e.g., inter-prediction, intra-prediction, or the like) that take advantage of redundancy inherent in the video data. Video coding aims to compress video data into a form that uses a lower bit rate, while avoiding or minimizing degradations to video quality.

### SUMMARY

The present disclosure provides examples of techniques relating to improving the Intra Block Copy method in a video encoding or decoding process.

According to a first aspect of the present disclosure, there is provided a method for video decoding, including: obtaining, by a decoder, fractional motion information for a current block in an intra block copy (IBC) mode; obtaining, by the decoder, a block vector (BV) for the current block based on the fractional motion information; obtaining, by the decoder, a prediction block for the current block based on the BV; and in response to meeting a condition, conducting, or skipping partially or fully, by the decoder, a padding process on one or more samples associated with an interpolation filter.

According to a second aspect of the present disclosure, there is provided an apparatus for video decoding, including: one or more processors; and a memory coupled to the one or more processors and configured to store instructions executable by the one or more processors, wherein the one or more processors, upon execution of the instructions, are configured to perform operations comprising: obtaining fractional motion information for a current block in an intra block copy (IBC) mode; obtaining a block vector (BV) for the current block based on the fractional motion information; obtaining a prediction block for the current block based on the BV; and in response to meeting a condition, conducting, or skipping partially or fully, by the decoder, a padding process on one or more samples associated with an interpolation filter.

According to a third aspect of the present disclosure, there is provided a method for storing a bitstream, comprising: generating a bitstream by performing an encoding method; and storing the bitstream, wherein the encoding method comprises: obtaining, by an encoder, fractional motion information for a current block in an intra block copy (IBC) mode; obtaining, by the encoder, a block vector (BV) for the current block based on the fractional motion information; obtaining, by the encoder, a prediction block for the current block based on the BV; and in response to meeting a condition, conducting, or skipping partially or fully, by the encoder, a padding process on one or more samples associated with an interpolation filter.

It is to be understood that both the foregoing general description and the following detailed description are examples only and are not restrictive of the present disclosure.

### BRIEF DESCRIPTION OF THE DRAWINGS

The accompanying drawings, which are incorporated in and constitute a part of this specification, illustrate examples consistent with the present disclosure and, together with the description, serve to explain the principles of the disclosure.

FIG. 1 is a block diagram illustrating an exemplary system for encoding and decoding video blocks in accordance with some implementations of the present disclosure.

FIG. 2 is a block diagram illustrating an exemplary video encoder in accordance with some implementations of the present disclosure.

FIG. 3 is a block diagram illustrating an exemplary video decoder in accordance with some implementations of the present disclosure.

FIGS. 4A through 4E are block diagrams illustrating how a frame is recursively partitioned into multiple video blocks of different sizes and shapes in accordance with some implementations of the present disclosure.

FIGS. 5A-5B show examples of 4-parameter affine model in accordance with some examples of the present disclosure.

FIG. 5C shows an example of 6-parameter affine model in accordance with some examples of the present disclosure.

FIG. 6 shows an example of adjacent neighboring blocks for inherited affine merge candidates in accordance with some examples of the present disclosure.

FIG. 7 shows an example of adjacent neighboring blocks for constructed affine merge candidates in accordance with some examples of the present disclosure.

FIG. 8 shows a current CTU processing order and its available reference samples in current and left CTU in accordance with some examples of the present disclosure.

FIG. 9 shows padding candidates for the replacement of the zero-vector in the IBC list in accordance with some examples of the present disclosure.

FIG. 10 shows reference area for IBC when CTU (m,n) is coded in accordance with some examples of the present disclosure.

FIG. 11 shows IBC reference area for camera-captured content in accordance with some examples of the present disclosure.

FIGS. 12A-12B show the division methods for angular modes in accordance with some examples of the present disclosure.

FIG. 13A shows spatial neighboring blocks used by ATVMP in accordance with some examples of the present disclosure.

FIG. 13B shows an example of deriving sub-CU motion field by applying a motion shift from spatial neighbor and scaling the motion information from the corresponding collocated sub-CUs in accordance with some examples of the present disclosure.

FIG. 14 is a flow chart of decoding a bin in accordance with some examples of the present disclosure.

FIG. 15 shows intra template matching search area used in some examples of the present disclosure.

FIG. 16A shows an example of BV adjustment for horizontal flip in accordance with some examples of the present disclosure.

FIG. 16B shows an example of BV adjustment for vertical flip in accordance with some examples of the present disclosure.

FIG. 17 shows an example of the five locations in reconstructed luma samples in accordance with some examples of the present disclosure.

FIG. 18 shows an example of the prediction process of DBV method in accordance with some examples of the present disclosure.

FIG. 19 shows an example of AMVP IBC candidate clustering based on the L2 distance and the TM cost in accordance with some examples of the present disclosure.

FIG. 20 is a diagram illustrating a computing environment coupled with a user interface in accordance with some examples of the present disclosure.

FIG. 21 is a flow chart illustrating a method for video decoding in accordance with some examples of the present disclosure.

FIG. 22 is a flow chart illustrating a method for video decoding in accordance with some examples of the present disclosure.

FIG. 23 is a flow chart illustrating a method for video decoding in accordance with some examples of the present disclosure.

FIG. 24 is a flow chart illustrating a method for video decoding in accordance with some examples of the present disclosure.

FIG. 25 is a flow chart illustrating a method for video decoding in accordance with some examples of the present disclosure.

FIG. 26 is a flow chart illustrating a method for video decoding in accordance with some examples of the present disclosure.

FIG. 27 is a flow chart illustrating a method for video decoding in accordance with some examples of the present disclosure.

FIG. 28 is a flow chart illustrating a method for video decoding in accordance with some examples of the present disclosure.

FIG. 29 is a flow chart illustrating a method for video decoding in accordance with some examples of the present disclosure.

FIG. 30 is a flow chart illustrating a method for video decoding in accordance with some examples of the present disclosure.

FIG. 31 is a flow chart illustrating a method for video encoding in accordance with some examples of the present disclosure.

FIG. 32 is a flow chart illustrating a method for video encoding in accordance with some examples of the present disclosure.

FIG. 33 is a flow chart illustrating a method for video encoding in accordance with some examples of the present disclosure.

FIG. 34 is a flow chart illustrating a method for video encoding in accordance with some examples of the present disclosure.

FIG. 35 is a flow chart illustrating a method for video encoding in accordance with some examples of the present disclosure.

FIG. 36 is a flow chart illustrating a method for video encoding in accordance with some examples of the present disclosure.

FIG. 37 is a flow chart illustrating a method for video encoding in accordance with some examples of the present disclosure.

FIG. 38 is a flow chart illustrating a method for video encoding in accordance with some examples of the present disclosure.

FIG. 39 is a flow chart illustrating a method for video encoding in accordance with some examples of the present disclosure.

FIG. 40 is a flow chart illustrating a method for video encoding in accordance with some examples of the present disclosure.

FIG. 41 is a flow chart illustrating a method for video decoding in accordance with some examples of the present disclosure.

FIG. 42 is a flow chart illustrating a method for video encoding corresponding to the method for video decoding as shown in FIG. 41 in accordance with some examples of the present disclosure.

FIG. 43 is a flow chart illustrating a method for video decoding in accordance with some examples of the present disclosure.

FIG. 44 is a flow chart illustrating a method for video encoding corresponding to the method for video decoding as shown in FIG. 43 in accordance with some examples of the present disclosure.

FIG. 45 is a flow chart illustrating a method for video decoding in accordance with some examples of the present disclosure.

FIG. 46 is a flow chart illustrating a method for video encoding corresponding to the method for video decoding as shown in FIG. 45 in accordance with some examples of the present disclosure.

FIG. 47 is a flow chart illustrating a method for video decoding in accordance with some examples of the present disclosure.

FIG. 48 is a flow chart illustrating a method for video encoding corresponding to the method for video decoding as shown in FIG. 47 in accordance with some examples of the present disclosure.

FIG. 49 is a flow chart illustrating a method for video decoding in accordance with some examples of the present disclosure.

FIG. 50 is a flow chart illustrating a method for video encoding corresponding to the method for video decoding as shown in FIG. 49 in accordance with some examples of the present disclosure.

### DETAILED DESCRIPTION

Reference will now be made in detail to specific implementations, examples of which are illustrated in the accompanying drawings. In the following detailed description, numerous non-limiting specific details are set forth in order to assist in understanding the subject matter presented herein. But various alternatives may be used without departing from the scope of claims and the subject matter may be practiced without these specific details. For example, the subject matter presented herein can be implemented on many types of electronic devices with digital video capabilities.

It should be illustrated that the terms “first.” “second,” and the like used in the description, claims of the present disclosure, and the accompanying drawings are used to distinguish objects, and not used to describe any specific order or sequence. It should be understood that the data used in this way may be interchanged under an appropriate condition, such that the embodiments of the present disclosure described herein may be implemented in orders besides those shown in the accompanying drawings or described in the present disclosure.

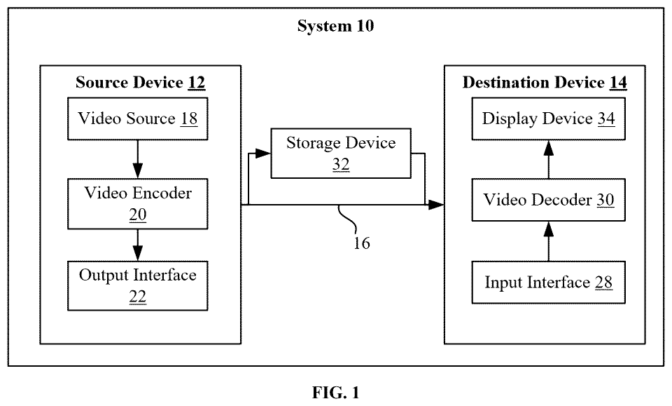

FIG. 1 is a block diagram illustrating an exemplary system 10 for encoding and decoding video blocks in parallel in accordance with some implementations of the present disclosure. As shown in FIG. 1, the system 10 includes a source device 12 that generates and encodes video data to be decoded at a later time by a destination device 14. The source device 12 and the destination device 14 may comprise any of a wide variety of electronic devices, including cloud servers, server computers, desktop or laptop computers, tablet computers, smart phones, set-top boxes, digital televisions, cameras, display devices, digital media players, video gaming consoles, video streaming device, or the like. In some implementations, the source device 12 and the destination device 14 are equipped with wireless communication capabilities.

In some implementations, the destination device 14 may receive the encoded video data to be decoded via a link 16. The link 16 may comprise any type of communication medium or device capable of moving the encoded video data from the source device 12 to the destination device 14. In one example, the link 16 may comprise a communication medium to enable the source device 12 to transmit the encoded video data directly to the destination device 14 in real time. The encoded video data may be modulated according to a communication standard, such as a wireless communication protocol, and transmitted to the destination device 14. The communication medium may comprise any wireless or wired communication medium, such as a Radio Frequency (RF) spectrum or one or more physical transmission lines. The communication medium may form part of a packet-based network, such as a local area network, a wide-area network, or a global network such as the Internet. The communication medium may include routers, switches, base stations, or any other equipment that may be useful to facilitate communication from the source device 12 to the destination device 14.

In some other implementations, the encoded video data may be transmitted from an output interface 22 to a storage device 32. Subsequently, the encoded video data in the storage device 32 may be accessed by the destination device 14 via an input interface 28. The storage device 32 may include any of a variety of distributed or locally accessed data storage media such as a hard drive, Blu-ray discs, Digital Versatile Disks (DVDs), Compact Disc Read-Only Memories (CD-ROMs), flash memory, volatile or non-volatile memory, or any other suitable digital storage media for storing the encoded video data. In a further example, the storage device 32 may correspond to a file server or another intermediate storage device that may hold the encoded video data generated by the source device 12. The destination device 14 may access the stored video data from the storage device 32 via streaming or downloading. The file server may be any type of computer capable of storing the encoded video data and transmitting the encoded video data to the destination device 14. Exemplary file servers include a web server (e.g., for a website), a File Transfer Protocol (FTP) server, Network Attached Storage (NAS) devices, or a local disk drive. The destination device 14 may access the encoded video data through any standard data connection, including a wireless channel (e.g., a Wireless Fidelity (Wi-Fi) connection), a wired connection (e.g., Digital Subscriber Line (DSL), cable modem, etc.), or a combination of both that is suitable for accessing encoded video data stored on a file server. The transmission of the encoded video data from the storage device 32 may be a streaming transmission, a download transmission, or a combination of both.

As shown in FIG. 1, the source device 12 includes a video source 18, a video encoder 20 and the output interface 22. The video source 18 may include a source such as a video capturing device, e.g., a video camera, a video archive containing previously captured video, a video feeding interface to receive video from a video content provider, and/or a computer graphics system for generating computer graphics data as the source video, or a combination of such sources. As one example, if the video source 18 is a video camera of a security surveillance system, the source device 12 and the destination device 14 may form camera phones or video phones. However, the implementations described in the present application may be applicable to video coding in general, and may be applied to wireless and/or wired applications.

The captured, pre-captured, or computer-generated video may be encoded by the video encoder 20. The encoded video data may be transmitted directly to the destination device 14 via the output interface 22 of the source device 12. The encoded video data may also (or alternatively) be stored onto the storage device 32 for later access by the destination device 14 or other devices, for decoding and/or playback. The output interface 22 may further include a modem and/or a transmitter.

The destination device 14 includes the input interface 28, a video decoder 30, and a display device 34. The input interface 28 may include a receiver and/or a modem and receive the encoded video data over the link 16. The encoded video data communicated over the link 16, or provided on the storage device 32, may include a variety of syntax elements generated by the video encoder 20 for use by the video decoder 30 in decoding the video data. Such syntax elements may be included within the encoded video data transmitted on a communication medium, stored on a storage medium, or stored on a file server.

In some implementations, the destination device 14 may include the display device 34, which can be an integrated display device and an external display device that is configured to communicate with the destination device 14. The display device 34 displays the decoded video data to a user, and may comprise any of a variety of display devices such as a Liquid Crystal Display (LCD), a plasma display, an Organic Light Emitting Diode (OLED) display, or another type of display device.

The video encoder 20 and the video decoder 30 may operate according to proprietary or industry standards, such as VVC, HEVC, MPEG-4, Part 10, AVC, or extensions of such standards. It should be understood that the present application is not limited to a specific video encoding/decoding standard and may be applicable to other video encoding/decoding standards. It is generally contemplated that the video encoder 20 of the source device 12 may be configured to encode video data according to any of these current or future standards. Similarly, it is also generally contemplated that the video decoder 30 of the destination device 14 may be configured to decode video data according to any of these current or future standards.

The video encoder 20 and the video decoder 30 each may be implemented as any of a variety of suitable encoder and/or decoder circuitry, such as one or more microprocessors, Digital Signal Processors (DSPs), Application Specific Integrated Circuits (ASICs), Field Programmable Gate Arrays (FPGAs), discrete logic, software, hardware, firmware or any combinations thereof. When implemented partially in software, an electronic device may store instructions for the software in a suitable, non-transitory computer-readable medium and execute the instructions in hardware using one or more processors to perform the video encoding/decoding operations disclosed in the present disclosure. Each of the video encoder 20 and the video decoder 30 may be included in one or more encoders or decoders, either of which may be integrated as part of a combined encoder/decoder (CODEC) in a respective device.

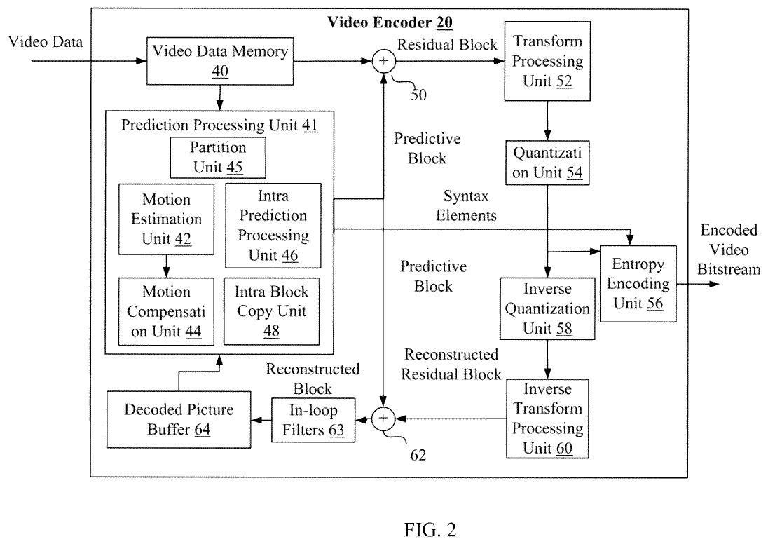

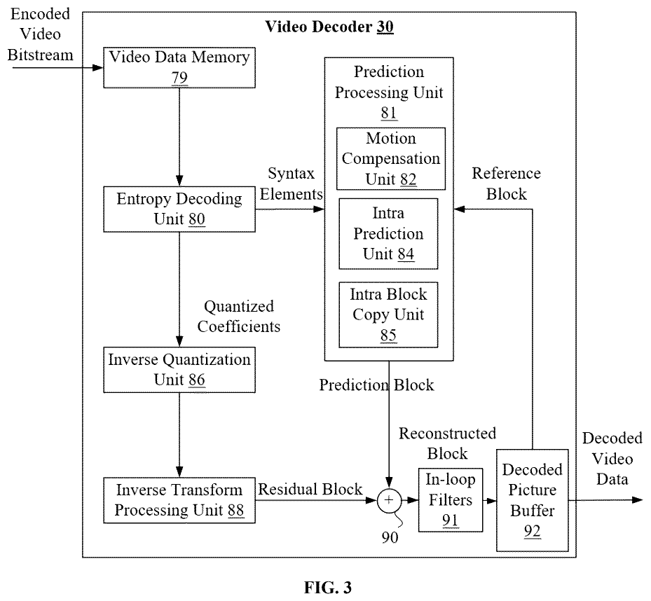

In some implementations, at least a part of components of the source device 12 (for example, the video source 18, the video encoder 20 or components included in the video encoder 20 as described below with reference to FIG. 2, and the output interface 22) and/or at least a part of components of the destination device 14 (for example, the input interface 28, the video decoder 30 or components included in the video decoder 30 as described below with reference to FIG. 3, and the display device 34) may operate in a cloud computing service network which may provide software, platforms, and/or infrastructure, such as Software as a Service (SaaS), Platform as a Service (PaaS), or Infrastructure as a Service (IaaS). In some implementations, one or more components in the source device 12 and/or the destination device 14 which are not included in the cloud computing service network may be provided in one or more client devices, and the one or more client devices may communicate with server computers in the cloud computing service network through a wireless communication network (for example, a cellular communication network, a short-range wireless communication network, or a global navigation satellite system (GNSS) communication network) or a wired communication network (e.g., a local area network (LAN) communication network or a power line communication (PLC) network). In an embodiment, at least a part of operations described herein may be implemented as cloud-based services provided by one or more server computers which are implemented by the at least a part of the components of the source device 12 and/or the at least a part of the components of the destination device 14 in the cloud computing service network; and one or more other operations described herein may be implemented by the one or more client devices. In some implementations, the cloud computing service network may be a private cloud, a public cloud, or a hybrid cloud. The terms such as “cloud,” “cloud computing,” “cloud-based” etc. herein may be used interchangeably as appropriate without departing from the scope of the present disclosure. It should be understood that the present disclosure is not limited to being implemented in the cloud computing service network described above. Instead, the present disclosure may also be implemented in any other type of computing environments currently known or developed in the future.

FIG. 2 is a block diagram illustrating an exemplary video encoder 20 in accordance with some implementations described in the present application. The video encoder 20 may perform intra and inter predictive coding of video blocks within video frames. Intra predictive coding relies on spatial prediction to reduce or remove spatial redundancy in video data within a given video frame or picture. Inter predictive coding relies on temporal prediction to reduce or remove temporal redundancy in video data within adjacent video frames or pictures of a video sequence. It should be noted that the term “frame” may be used as synonyms for the term “image” or “picture” in the field of video coding.

As shown in FIG. 2, the video encoder 20 includes a video data memory 40, a prediction processing unit 41, a Decoded Picture Buffer (DPB) 64, a summer 50, a transform processing unit 52, a quantization unit 54, and an entropy encoding unit 56. The prediction processing unit 41 further includes a motion estimation unit 42, a motion compensation unit 44, a partition unit 45, an intra prediction processing unit 46, and an intra Block Copy (BC) unit 48. In some implementations, the video encoder 20 also includes an inverse quantization unit 58, an inverse transform processing unit 60, and a summer 62 for video block reconstruction. An in-loop filter 63, such as a deblocking filter, may be positioned between the summer 62 and the DPB 64 to filter block boundaries to remove blockiness artifacts from reconstructed video. Another in-loop filter, such as Sample Adaptive Offset (SAO) filter, Cross Component Sample Adaptive Offset (CCSAO) filter and/or Adaptive in-Loop Filter (ALF), may also be used in addition to the deblocking filter to filter an output of the summer 62. It should be illustrated that for the CCSAO technique, the present application is not limited to the embodiments described herein, and instead, the application may be applied to a situation where an offset is selected for any of a luma component, a Cb chroma component and a Cr chroma component according to any other of the luma component, the Ch chroma component and the Cr chroma component to modify said any component based on the selected offset. Further, it should also be illustrated that a first component mentioned herein may be any of the luma component, the Cb chroma component and the Cr chroma component, a second component mentioned herein may be any other of the luma component, the Cb chroma component and the Cr chroma component, and a third component mentioned herein may be a remaining one of the luma component, the Cb chroma component and the Cr chroma component. In some examples, the in-loop filters may be omitted, and the decoded video block may be directly provided by the summer 62 to the DPB 64. The video encoder 20 may take the form of a fixed or programmable hardware unit or may be divided among one or more of the illustrated fixed or programmable hardware units.

The video data memory 40 may store video data to be encoded by the components of the video encoder 20. The video data in the video data memory 40 may be obtained, for example, from the video source 18 as shown in FIG. 1. The DPB 64 is a buffer that stores reference video data (for example, reference frames or pictures) for use in encoding video data by the video encoder 20 (e.g., in intra or inter predictive coding modes). The video data memory 40 and the DPB 64 may be formed by any of a variety of memory devices. In various examples, the video data memory 40 may be on-chip with other components of the video encoder 20, or off-chip relative to those components.

As shown in FIG. 2, after receiving the video data, the partition unit 45 within the prediction processing unit 41 partitions the video data into video blocks. This partitioning may also include partitioning a video frame into slices, tiles (for example, sets of video blocks), or other larger Coding Units (CUs) according to predefined splitting structures such as a Quad-Tree (QT) structure associated with the video data. The video frame is or may be regarded as a two-dimensional array or matrix of samples with sample values. A sample in the array may also be referred to as a pixel or a pel. A number of samples in horizontal and vertical directions (or axes) of the array or picture define a size and/or a resolution of the video frame. The video frame may be divided into multiple video blocks by, for example, using QT partitioning. The video block again is or may be regarded as a two-dimensional array or matrix of samples with sample values, although of smaller dimension than the video frame. A number of samples in horizontal and vertical directions (or axes) of the video block define a size of the video block. The video block may further be partitioned into one or more block partitions or sub-blocks (which may form again blocks) by, for example, iteratively using QT partitioning, Binary-Tree (BT) partitioning or Triple-Tree (TT) partitioning or any combination thereof. It should be noted that the term “block” or “video block” as used herein may be a portion, in particular a rectangular (square or non-square) portion, of a frame or a picture. With reference, for example, to HEVC and VVC, the block or video block may be or correspond to a Coding Tree Unit (CTU), a CU, a Prediction Unit (PU) or a Transform Unit (TU) and/or may be or correspond to a corresponding block, e.g. a Coding Tree Block (CTB), a Coding Block (CB), a Prediction Block (PB) or a Transform Block (TB) and/or to a sub-block.

The prediction processing unit 41 may select one of a plurality of possible predictive coding modes, such as one of a plurality of intra predictive coding modes or one of a plurality of inter predictive coding modes, for the current video block based on error results (e.g., coding rate and the level of distortion). The prediction processing unit 41 may provide the resulting intra or inter prediction coded block to the summer 50 to generate a residual block and to the summer 62 to reconstruct the encoded block for use as part of a reference frame subsequently. The prediction processing unit 41 also provides syntax elements, such as motion vectors, intra-mode indicators, partition information, and other such syntax information, to the entropy encoding unit 56.

In order to select an appropriate intra predictive coding mode for the current video block, the intra prediction processing unit 46 within the prediction processing unit 41 may perform intra predictive coding of the current video block relative to one or more neighbor blocks in the same frame as the current block to be coded to provide spatial prediction. The motion estimation unit 42 and the motion compensation unit 44 within the prediction processing unit 41 perform inter predictive coding of the current video block relative to one or more predictive blocks in one or more reference frames to provide temporal prediction. The video encoder 20 may perform multiple coding passes, e.g., to select an appropriate coding mode for each block of video data.

In some implementations, the motion estimation unit 42 determines the inter prediction mode for a current video frame by generating a motion vector, which indicates the displacement of a video block within the current video frame relative to a predictive block within a reference video frame, according to a predetermined pattern within a sequence of video frames. Motion estimation, performed by the motion estimation unit 42, is the process of generating motion vectors, which estimate motion for video blocks. A motion vector, for example, may indicate the displacement of a video block within a current video frame or picture relative to a predictive block within a reference frame relative to the current block being coded within the current frame. The predetermined pattern may designate video frames in the sequence as P frames or B frames. The intra BC unit 48 may determine vectors, e.g., block vectors, for intra BC coding in a manner similar to the determination of motion vectors by the motion estimation unit 42 for inter prediction, or may utilize the motion estimation unit 42 to determine the block vector.

A predictive block for the video block may be or may correspond to a block or a reference block of a reference frame that is deemed as closely matching the video block to be coded in terms of pixel difference, which may be determined by Sum of Absolute Difference (SAD), Sum of Square Difference (SSD), or other difference metrics. In some implementations, the video encoder 20 may calculate values for sub-integer pixel positions of reference frames stored in the DPB 64. For example, the video encoder 20 may interpolate values of one-quarter pixel positions, one-eighth pixel positions, or other fractional pixel positions of the reference frame. Therefore, the motion estimation unit 42 may perform a motion search relative to the full pixel positions and fractional pixel positions and output a motion vector with fractional pixel precision.

The motion estimation unit 42 calculates a motion vector for a video block in an inter prediction coded frame by comparing the position of the video block to the position of a predictive block of a reference frame selected from a first reference frame list (List 0) or a second reference frame list (List 1), each of which identifies one or more reference frames stored in the DPB 64. The motion estimation unit 42 sends the calculated motion vector to the motion compensation unit 44 and then to the entropy encoding unit 56.

Motion compensation, performed by the motion compensation unit 44, may involve fetching or generating the predictive block based on the motion vector determined by the motion estimation unit 42. Upon receiving the motion vector for the current video block, the motion compensation unit 44 may locate a predictive block to which the motion vector points in one of the reference frame lists, retrieve the predictive block from the DPB 64, and forward the predictive block to the summer 50. The summer 50 then forms a residual video block of pixel difference values by subtracting pixel values of the predictive block provided by the motion compensation unit 44 from the pixel values of the current video block being coded. The pixel difference values forming the residual video block may include luma or chroma component differences or both. The motion compensation unit 44 may also generate syntax elements associated with the video blocks of a video frame for use by the video decoder 30 in decoding the video blocks of the video frame. The syntax elements may include, for example, syntax elements defining the motion vector used to identify the predictive block, any flags indicating the prediction mode, or any other syntax information described herein. Note that the motion estimation unit 42 and the motion compensation unit 44 may be highly integrated, but are illustrated separately for conceptual purposes.

In some implementations, the intra BC unit 48 may generate vectors and fetch predictive blocks in a manner similar to that described above in connection with the motion estimation unit 42 and the motion compensation unit 44, but with the predictive blocks being in the same frame as the current block being coded and with the vectors being referred to as block vectors as opposed to motion vectors. In particular, the intra BC unit 48 may determine an intra-prediction mode to use to encode a current block. In some examples, the intra BC unit 48 may encode a current block using various intra-prediction modes, e.g., during separate encoding passes, and test their performance through rate-distortion analysis. Next, the intra BC unit 48 may select, among the various tested intra-prediction modes, an appropriate intra-prediction mode to use and generate an intra-mode indicator accordingly. For example, the intra BC unit 48 may calculate rate-distortion values using a rate-distortion analysis for the various tested intra-prediction modes, and select the intra-prediction mode having the best rate-distortion characteristics among the tested modes as the appropriate intra-prediction mode to use. Rate-distortion analysis generally determines an amount of distortion (or error) between an encoded block and an original, unencoded block that was encoded to produce the encoded block, as well as a bitrate (i.e., a number of bits) used to produce the encoded block. Intra BC unit 48 may calculate ratios from the distortions and rates for the various encoded blocks to determine which intra-prediction mode exhibits the best rate-distortion value for the block.

In other examples, the intra BC unit 48 may use the motion estimation unit 42 and the motion compensation unit 44, in whole or in part, to perform such functions for Intra BC prediction according to the implementations described herein. In either case, for Intra block copy, a predictive block may be a block that is deemed as closely matching the block to be coded, in terms of pixel difference, which may be determined by SAD, SSD, or other difference metrics, and identification of the predictive block may include calculation of values for sub-integer pixel positions.

Whether the predictive block is from the same frame according to intra prediction, or a different frame according to inter prediction, the video encoder 20 may form a residual video block by subtracting pixel values of the predictive block from the pixel values of the current video block being coded, forming pixel difference values. The pixel difference values forming the residual video block may include both luma and chroma component differences.

The intra prediction processing unit 46 may intra-predict a current video block, as an alternative to the inter-prediction performed by the motion estimation unit 42 and the motion compensation unit 44, or the intra block copy prediction performed by the intra BC unit 48, as described above. In particular, the intra prediction processing unit 46 may determine an intra prediction mode to use to encode a current block. To do so, the intra prediction processing unit 46 may encode a current block using various intra prediction modes, e.g., during separate encoding passes, and the intra prediction processing unit 46 (or a mode selection unit, in some examples) may select an appropriate intra prediction mode to use from the tested intra prediction modes. The intra prediction processing unit 46 may provide information indicative of the selected intra-prediction mode for the block to the entropy encoding unit 56. The entropy encoding unit 56 may encode the information indicating the selected intra-prediction mode in the bitstream.

After the prediction processing unit 41 determines the predictive block for the current video block via either inter prediction or intra prediction, the summer 50 forms a residual video block by subtracting the predictive block from the current video block. The residual video data in the residual block may be included in one or more TUs and is provided to the transform processing unit 52. The transform processing unit 52 transforms the residual video data into residual transform coefficients using a transform, such as a Discrete Cosine Transform (DCT) or a conceptually similar transform.

The transform processing unit 52 may send the resulting transform coefficients to the quantization unit 54. The quantization unit 54 quantizes the transform coefficients to further reduce the bit rate. The quantization process may also reduce the bit depth associated with some or all of the coefficients. The degree of quantization may be modified by adjusting a quantization parameter. In some examples, the quantization unit 54 may then perform a scan of a matrix including the quantized transform coefficients. Alternatively, the entropy encoding unit 56 may perform the scan.

Following quantization, the entropy encoding unit 56 entropy encodes the quantized transform coefficients into a video bitstream using, e.g., Context Adaptive Variable Length Coding (CAVLC), Context Adaptive Binary Arithmetic Coding (CABAC), Syntax-based context-adaptive Binary Arithmetic Coding (SBAC), Probability Interval Partitioning Entropy (PIPE) coding or another entropy encoding methodology or technique. The encoded bitstream may then be transmitted to the video decoder 30 as shown in FIG. 1, or archived in the storage device 32 as shown in FIG. 1 for later transmission to or retrieval by the video decoder 30. The entropy encoding unit 56 may also entropy encode the motion vectors and the other syntax elements for the current video frame being coded.

The inverse quantization unit 58 and the inverse transform processing unit 60 apply inverse quantization and inverse transformation, respectively, to reconstruct the residual video block in the pixel domain for generating a reference block for prediction of other video blocks. As noted above, the motion compensation unit 44 may generate a motion compensated predictive block from one or more reference blocks of the frames stored in the DPB 64. The motion compensation unit 44 may also apply one or more interpolation filters to the predictive block to calculate sub-integer pixel values for use in motion estimation.

The summer 62 adds the reconstructed residual block to the motion compensated predictive block produced by the motion compensation unit 44 to produce a reference block for storage in the DPB 64. The reference block may then be used by the intra BC unit 48, the motion estimation unit 42 and the motion compensation unit 44 as a predictive block to inter predict another video block in a subsequent video frame.

FIG. 3 is a block diagram illustrating an exemplary video decoder 30 in accordance with some implementations of the present application. The video decoder 30 includes a video data memory 79, an entropy decoding unit 80, a prediction processing unit 81, an inverse quantization unit 86, an inverse transform processing unit 88, a summer 90, and a DPB 92. The prediction processing unit 81 further includes a motion compensation unit 82, an intra prediction unit 84, and an intra BC unit 85. The video decoder 30 may perform a decoding process generally reciprocal to the encoding process described above with respect to the video encoder 20 in connection with FIG. 2. For example, the motion compensation unit 82 may generate prediction data based on motion vectors received from the entropy decoding unit 80, while the intra-prediction unit 84 may generate prediction data based on intra-prediction mode indicators received from the entropy decoding unit 80.

In some examples, a unit of the video decoder 30 may be tasked to perform the implementations of the present application. Also, in some examples, the implementations of the present disclosure may be divided among one or more of the units of the video decoder 30. For example, the intra BC unit 85 may perform the implementations of the present application, alone, or in combination with other units of the video decoder 30, such as the motion compensation unit 82, the intra prediction unit 84, and the entropy decoding unit 80. In some examples, the video decoder 30 may not include the intra BC unit 85 and the functionality of intra BC unit 85 may be performed by other components of the prediction processing unit 81, such as the motion compensation unit 82.

The video data memory 79 may store video data, such as an encoded video bitstream, to be decoded by the other components of the video decoder 30. The video data stored in the video data memory 79 may be obtained, for example, from the storage device 32, from a local video source, such as a camera, via wired or wireless network communication of video data, or by accessing physical data storage media (e.g., a flash drive or hard disk). The video data memory 79 may include a Coded Picture Buffer (CPB) that stores encoded video data from an encoded video bitstream. The DPB 92 of the video decoder 30 stores reference video data for use in decoding video data by the video decoder 30 (e.g., in intra or inter predictive coding modes). The video data memory 79 and the DPB 92 may be formed by any of a variety of memory devices, such as dynamic random access memory (DRAM), including Synchronous DRAM (SDRAM), Magneto-resistive RAM (MRAM), Resistive RAM (RRAM), or other types of memory devices. For illustrative purpose, the video data memory 79 and the DPB 92 are depicted as two distinct components of the video decoder 30 in FIG. 3. But it will be apparent to one skilled in the art that the video data memory 79 and the DPB 92 may be provided by the same memory device or separate memory devices. In some examples, the video data memory 79 may be on-chip with other components of the video decoder 30, or off-chip relative to those components.

During the decoding process, the video decoder 30 receives an encoded video bitstream that represents video blocks of an encoded video frame and associated syntax elements. The video decoder 30 may receive the syntax elements at the video frame level and/or the video block level. The entropy decoding unit 80 of the video decoder 30 entropy decodes the bitstream to generate quantized coefficients, motion vectors or intra-prediction mode indicators, and other syntax elements. The entropy decoding unit 80 then forwards the motion vectors or intra-prediction mode indicators and other syntax elements to the prediction processing unit 81.

When the video frame is coded as an intra predictive coded (I) frame or for intra coded predictive blocks in other types of frames, the intra prediction unit 84 of the prediction processing unit 81 may generate prediction data for a video block of the current video frame based on a signaled intra prediction mode and reference data from previously decoded blocks of the current frame.

When the video frame is coded as an inter-predictive coded (i.e., B or P) frame, the motion compensation unit 82 of the prediction processing unit 81 produces one or more predictive blocks for a video block of the current video frame based on the motion vectors and other syntax elements received from the entropy decoding unit 80. Each of the predictive blocks may be produced from a reference frame within one of the reference frame lists. The video decoder 30 may construct the reference frame lists, List 0 and List 1, using default construction techniques based on reference frames stored in the DPB 92.

In some examples, when the video block is coded according to the intra BC mode described herein, the intra BC unit 85 of the prediction processing unit 81 produces predictive blocks for the current video block based on block vectors and other syntax elements received from the entropy decoding unit 80. The predictive blocks may be within a reconstructed region of the same picture as the current video block defined by the video encoder 20.

The motion compensation unit 82 and/or the intra BC unit 85 determines prediction information for a video block of the current video frame by parsing the motion vectors and other syntax elements, and then uses the prediction information to produce the predictive blocks for the current video block being decoded. For example, the motion compensation unit 82 uses some of the received syntax elements to determine a prediction mode (e.g., intra or inter prediction) used to code video blocks of the video frame, an inter prediction frame type (e.g., B or P), construction information for one or more of the reference frame lists for the frame, motion vectors for each inter predictive encoded video block of the frame, inter prediction status for each inter predictive coded video block of the frame, and other information to decode the video blocks in the current video frame.

Similarly, the intra BC unit 85 may use some of the received syntax elements, e.g., a flag, to determine that the current video block was predicted using the intra BC mode, construction information of which video blocks of the frame are within the reconstructed region and should be stored in the DPB 92, block vectors for each intra BC predicted video block of the frame, intra BC prediction status for each intra BC predicted video block of the frame, and other information to decode the video blocks in the current video frame.

The motion compensation unit 82 may also perform interpolation using the interpolation filters as used by the video encoder 20 during encoding of the video blocks to calculate interpolated values for sub-integer pixels of reference blocks. In this case, the motion compensation unit 82 may determine the interpolation filters used by the video encoder 20 from the received syntax elements and use the interpolation filters to produce predictive blocks.

The inverse quantization unit 86 inverse quantizes the quantized transform coefficients provided in the bitstream and entropy decoded by the entropy decoding unit 80 using the same quantization parameter calculated by the video encoder 20 for each video block in the video frame to determine a degree of quantization. The inverse transform processing unit 88 applies an inverse transform, e.g., an inverse DCT, an inverse integer transform, or a conceptually similar inverse transform process, to the transform coefficients in order to reconstruct the residual blocks in the pixel domain.

After the motion compensation unit 82 or the intra BC unit 85 generates the predictive block for the current video block based on the vectors and other syntax elements, the summer 90 reconstructs decoded video block for the current video block by summing the residual block from the inverse transform processing unit 88 and a corresponding predictive block generated by the motion compensation unit 82 and the intra BC unit 85. An in-loop filter 91 such as deblocking filter, SAO filter, CCSAO filter and/or ALF may be positioned between the summer 90 and the DPB 92 to further process the decoded video block. In some examples, the in-loop filter 91 may be omitted, and the decoded video block may be directly provided by the summer 90 to the DPB 92. The decoded video blocks in a given frame are then stored in the DPB 92, which stores reference frames used for subsequent motion compensation of next video blocks. The DPB 92, or a memory device separate from the DPB 92, may also store decoded video for later presentation on a display device, such as the display device 34 of FIG. 1.

In a typical video coding process, a video sequence typically includes an ordered set of frames or pictures. Each frame may include three sample arrays, denoted SL, SCb, and SCr. SL is a two-dimensional array of luma samples. SCb is a two-dimensional array of Cb chroma samples. SCr is a two-dimensional array of Cr chroma samples. In other instances, a frame may be monochrome and therefore includes only one two-dimensional array of luma samples.

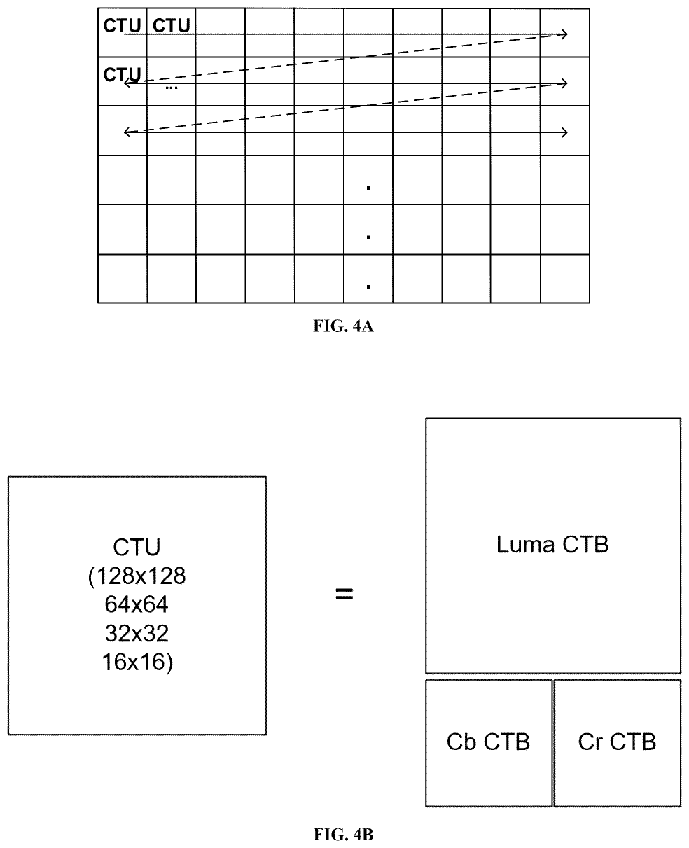

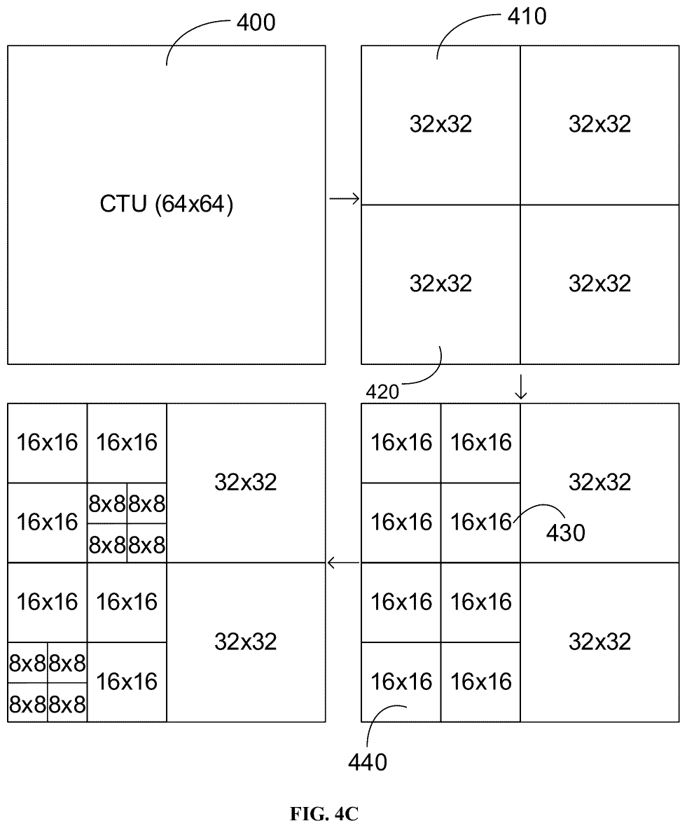

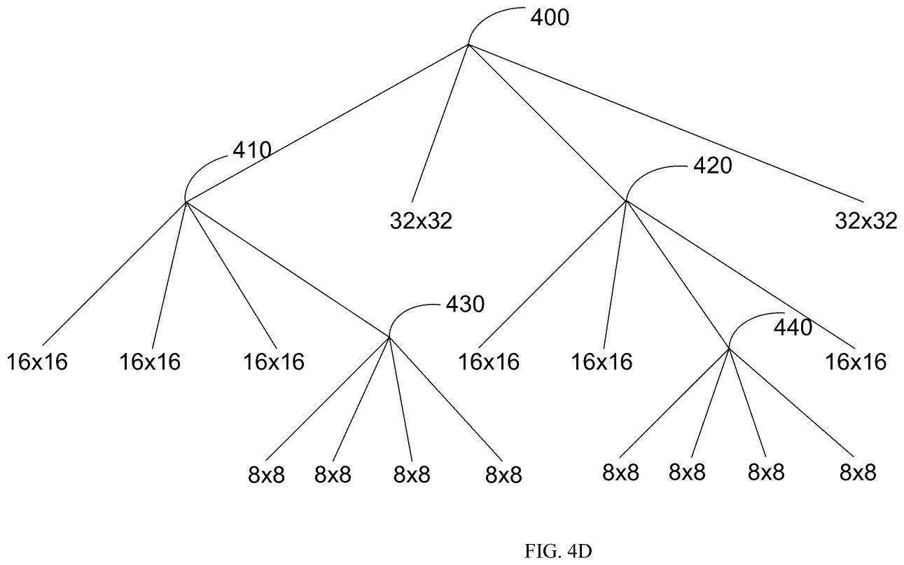

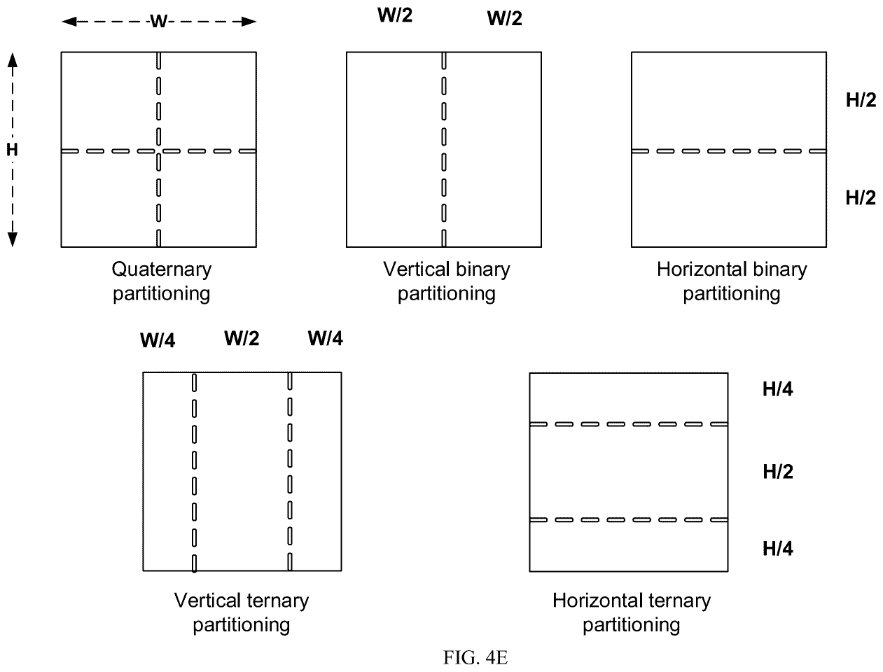

As shown in FIG. 4A, the video encoder 20 (or more specifically the partition unit 45) generates an encoded representation of a frame by first partitioning the frame into a set of CTUs. A video frame may include an integer number of CTUs ordered consecutively in a raster scan order from left to right and from top to bottom. Each CTU is a largest logical coding unit and the width and height of the CTU are signaled by the video encoder 20 in a sequence parameter set, such that all the CTUs in a video sequence have the same size being one of 128×128, 64×64, 32×32, and 16×16. But it should be noted that the present application is not necessarily limited to a particular size. As shown in FIG. 4B, each CTU may comprise one CTB of luma samples, two corresponding coding tree blocks of chroma samples, and syntax elements used to code the samples of the coding tree blocks. The syntax elements describe properties of different types of units of a coded block of pixels and how the video sequence can be reconstructed at the video decoder 30, including inter or intra prediction, intra prediction mode, motion vectors, and other parameters. In monochrome pictures or pictures having three separate color planes, a CTU may comprise a single coding tree block and syntax elements used to code the samples of the coding tree block. A coding tree block may be an N×N block of samples.

To achieve a better performance, the video encoder 20 may recursively perform tree partitioning such as binary-tree partitioning, ternary-tree partitioning, quad-tree partitioning or a combination thereof on the coding tree blocks of the CTU and divide the CTU into smaller CUs. As depicted in FIG. 4C, the 64×64 CTU 400 is first divided into four smaller CUs, each having a block size of 32×32. Among the four smaller CUs, CU 410 and CU 420 are each divided into four CUs of 16×16 by block size. The two 16×16 CUs 430 and 440 are each further divided into four CUs of 8×8 by block size. FIG. 4D depicts a quad-tree data structure illustrating the end result of the partition process of the CTU 400 as depicted in FIG. 4C, each leaf node of the quad-tree corresponding to one CU of a respective size ranging from 32×32 to 8×8. Like the CTU depicted in FIG. 4B, each CU may comprise a CB of luma samples and two corresponding coding blocks of chroma samples of a frame of the same size, and syntax elements used to code the samples of the coding blocks. In monochrome pictures or pictures having three separate color planes, a CU may comprise a single coding block and syntax structures used to code the samples of the coding block. It should be noted that the quad-tree partitioning depicted in FIGS. 4C and 4D is only for illustrative purposes and one CTU can be split into CUs to adapt to varying local characteristics based on quad/ternary/binary-tree partitions. In the multi-type tree structure, one CTU is partitioned by a quad-tree structure and each quad-tree leaf CU can be further partitioned by a binary and ternary tree structure. As shown in FIG. 4E, there are five possible partitioning types of a coding block having a width W and a height H, i.e., quaternary partitioning, horizontal binary partitioning, vertical binary partitioning, horizontal ternary partitioning, and vertical ternary partitioning.

In some implementations, the video encoder 20 may further partition a coding block of a CU into one or more M×N PBs. A PB is a rectangular (square or non-square) block of samples on which the same prediction, inter or intra, is applied. A PU of a CU may comprise a PB of luma samples, two corresponding PBs of chroma samples, and syntax elements used to predict the PBs. In monochrome pictures or pictures having three separate color planes, a PU may comprise a single PB and syntax structures used to predict the PB. The video encoder 20 may generate predictive luma, Cb, and Cr blocks for luma, Cb, and Cr PBs of each PU of the CU.

The video encoder 20 may use intra prediction or inter prediction to generate the predictive blocks for a PU. If the video encoder 20 uses intra prediction to generate the predictive blocks of a PU, the video encoder 20 may generate the predictive blocks of the PU based on decoded samples of the frame associated with the PU. If the video encoder 20 uses inter prediction to generate the predictive blocks of a PU, the video encoder 20 may generate the predictive blocks of the PU based on decoded samples of one or more frames other than the frame associated with the PU.

After the video encoder 20 generates predictive luma, Cb, and Cr blocks for one or more PUs of a CU, the video encoder 20 may generate a luma residual block for the CU by subtracting the CU's predictive luma blocks from its original luma coding block such that each sample in the CU's luma residual block indicates a difference between a luma sample in one of the CU's predictive luma blocks and a corresponding sample in the CU's original luma coding block. Similarly, the video encoder 20 may generate a Cb residual block and a Cr residual block for the CU, respectively, such that each sample in the CU's Cb residual block indicates a difference between a Cb sample in one of the CU's predictive Cb blocks and a corresponding sample in the CU's original Cb coding block and each sample in the CU's Cr residual block may indicate a difference between a Cr sample in one of the CU's predictive Cr blocks and a corresponding sample in the CU's original Cr coding block.

Furthermore, as illustrated in FIG. 4C, the video encoder 20 may use quad-tree partitioning to decompose the luma, Cb, and Cr residual blocks of a CU into one or more luma, Cb, and Cr transform blocks respectively. A transform block is a rectangular (square or non-square) block of samples on which the same transform is applied. A TU of a CU may comprise a transform block of luma samples, two corresponding transform blocks of chroma samples, and syntax elements used to transform the transform block samples. Thus, each TU of a CU may be associated with a luma transform block, a Cb transform block, and a Cr transform block. In some examples, the luma transform block associated with the TU may be a sub-block of the CU's luma residual block. The Cb transform block may be a sub-block of the CU's Cb residual block. The Cr transform block may be a sub-block of the CU's Cr residual block. In monochrome pictures or pictures having three separate color planes, a TU may comprise a single transform block and syntax structures used to transform the samples of the transform block.

The video encoder 20 may apply one or more transforms to a luma transform block of a TU to generate a luma coefficient block for the TU. A coefficient block may be a two-dimensional array of transform coefficients. A transform coefficient may be a scalar quantity. The video encoder 20 may apply one or more transforms to a Cb transform block of a TU to generate a Cb coefficient block for the TU. The video encoder 20 may apply one or more transforms to a Cr transform block of a TU to generate a Cr coefficient block for the TU.

After generating a coefficient block (e.g., a luma coefficient block, a Cb coefficient block or a Cr coefficient block), the video encoder 20 may quantize the coefficient block. Quantization generally refers to a process in which transform coefficients are quantized to possibly reduce the amount of data used to represent the transform coefficients, providing further compression. After the video encoder 20 quantizes a coefficient block, the video encoder 20 may entropy encode syntax elements indicating the quantized transform coefficients. For example, the video encoder 20 may perform CABAC on the syntax elements indicating the quantized transform coefficients. Finally, the video encoder 20 may output a bitstream that includes a sequence of bits that forms a representation of coded frames and associated data, which is either saved in the storage device 32 or transmitted to the destination device 14.

After receiving a bitstream generated by the video encoder 20, the video decoder 30 may parse the bitstream to obtain syntax elements from the bitstream. The video decoder 30 may reconstruct the frames of the video data based at least in part on the syntax elements obtained from the bitstream. The process of reconstructing the video data is generally reciprocal to the encoding process performed by the video encoder 20. For example, the video decoder 30 may perform inverse transforms on the coefficient blocks associated with TUs of a current CU to reconstruct residual blocks associated with the TUs of the current CU. The video decoder 30 also reconstructs the coding blocks of the current CU by adding the samples of the predictive blocks for PUs of the current CU to corresponding samples of the transform blocks of the TUs of the current CU. After reconstructing the coding blocks for each CU of a frame, video decoder 30 may reconstruct the frame.

As noted above, video coding achieves video compression using primarily two modes, i.e., intra-frame prediction (or intra-prediction) and inter-frame prediction (or inter-prediction). It is noted that IBC could be regarded as either intra-frame prediction or a third mode. Between the two modes, inter-frame prediction contributes more to the coding efficiency than intra-frame prediction because of the use of motion vectors for predicting a current video block from a reference video block.

But with the ever improving video data capturing technology and more refined video block size for preserving details in the video data, the amount of data required for representing motion vectors for a current frame also increases substantially. One way of overcoming this challenge is to benefit from the fact that not only a group of neighboring CUs in both the spatial and temporal domains have similar video data for predicting purpose but the motion vectors between these neighboring CUs are also similar. Therefore, it is possible to use the motion information of spatially neighboring CUs and/or temporally co-located CUs as an approximation of the motion information (e.g., motion vector) of a current CU by exploring their spatial and temporal correlation, which is also referred to as “Motion Vector Predictor (MVP)” of the current CU.

Instead of encoding, into the video bitstream, an actual motion vector of the current CU determined by the motion estimation unit 42 as described above in connection with FIG. 2, the motion vector predictor of the current CU is subtracted from the actual motion vector of the current CU to produce a Motion Vector Difference (MVD) for the current CU. By doing so, there is no need to encode the motion vector determined by the motion estimation unit 42 for each CU of a frame into the video bitstream and the amount of data used for representing motion information in the video bitstream can be significantly decreased.

Like the process of choosing a predictive block in a reference frame during inter-frame prediction of a code block, a set of rules need to be adopted by both the video encoder 20 and the video decoder 30 for constructing a motion vector candidate list (also known as a “merge list”) for a current CU using those potential candidate motion vectors associated with spatially neighboring CUs and/or temporally co-located CUs of the current CU and then selecting one member from the motion vector candidate list as a motion vector predictor for the current CU. By doing so, there is no need to transmit the motion vector candidate list itself from the video encoder 20 to the video decoder 30 and an index of the selected motion vector predictor within the motion vector candidate list is sufficient for the video encoder 20 and the video decoder 30 to use the same motion vector predictor within the motion vector candidate list for encoding and decoding the current CU.

The main focus of this disclosure is to further enhance the Intra Block Copy method by either improving the coding efficiency and/or reducing its coding complexities.

### Affine Model

In HEVC, only translation motion model is applied for motion compensated prediction. While in the real world, there are many kinds of motion, e.g. zoom in/out, rotation, perspective motions and other irregular motions. In the VVC, affine motion compensated prediction is applied by signaling one flag for each inter coding block to indicate whether the translation motion model or the affine motion model is applied for inter prediction. In the current VVC, two affine modes, including 4-parameter affine mode and 6-parameter affine mode, are supported for one affine coding block.

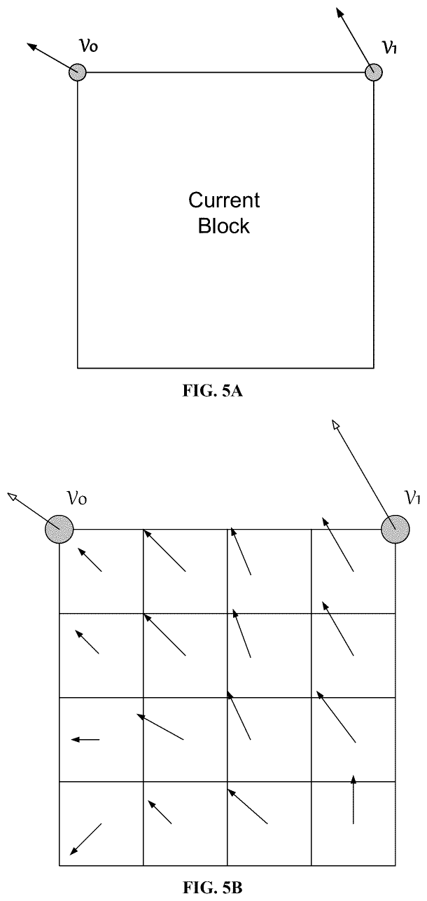

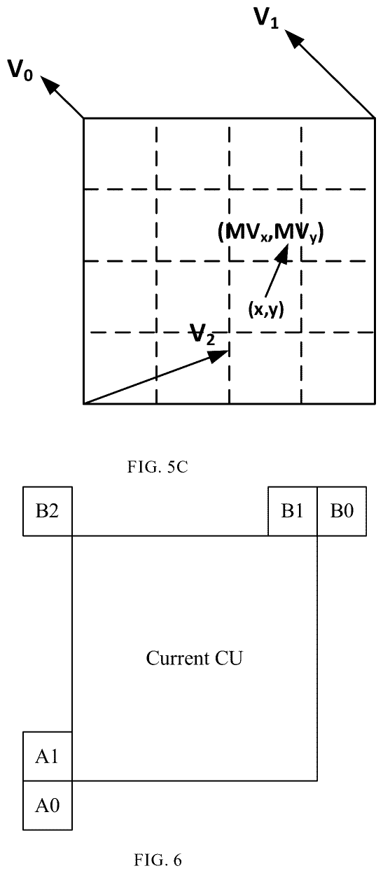

The 4-parameter affine model has the following parameters: two parameters for translation movement in horizontal and vertical directions respectively, one parameter for zoom motion and one parameter for rotational motion for both directions. In this model, horizontal zoom parameter is equal to vertical zoom parameter, and horizontal rotation parameter is equal to vertical rotation parameter. To achieve a better accommodation of the motion vectors and affine parameter, those affine parameters are to be derived from two MVs (which are also called control point motion vector (CPMV)) located at the top-left corner and top-right corner of a current block. As shown in FIGS. 5A-5B, the affine motion field of the block is described by two CPMVs (V₀, V₁). Based on the control point motion, the motion field (vₓ, v_{y}) of one affine coded block is described as

$$\begin{matrix}{v}_{x} = \frac{( {v}_{1 x} - {v}_{0 x} )}{w} * x - \frac{( {v}_{1 y} - {v}_{0 y} )}{w} * y + {v}_{0 x} \\ {v}_{y} = \frac{( {v}_{1 y} - {v}_{0 y} )}{w} * x + \frac{( {v}_{1 x} - {v}_{0 x} )}{w} * y + {v}_{0 y}\end{matrix} \qquad ( 1 )$$

The 6-parameter affine mode has the following parameters: two parameters for translation movement in horizontal and vertical directions respectively, two parameters for zoom motion and rotation motion respectively in horizontal direction, another two parameters for zoom motion and rotation motion respectively in vertical direction. The 6-parameter affine motion model is coded with three CPMVs. As shown in FIG. 5, the three control points of one 6-parameter affine block are located at the top-left, top-right and bottom left corner of the block. The motion at top-left control point is related to translation motion, and the motion at top-right control point is related to rotation and zoom motion in horizontal direction, and the motion at bottom-left control point is related to rotation and zoom motion in vertical direction. Compared to the 4-parameter affine motion model, the rotation and zoom motion in horizontal direction of the 6-parameter may not be same as those motion in vertical direction. Assuming (V₀, V₁, V₂) are the MVs of the top-left, top-right and bottom-left corners of the current block in FIG. 5, the motion vector of each sub-block (vₓ, v_{y}) is derived using the three MVs at control points as:

$$\begin{matrix}{v}_{x} = {v}_{0 x} + ( {v}_{1 x} - {v}_{0 x} ) * \frac{x}{w} + ( {v}_{2 x} - {v}_{0 x} ) * \frac{y}{h} \\ {v}_{y} = {v}_{0 y} + ( {v}_{1 y} - {v}_{0 y} ) * \frac{x}{w} + ( {v}_{2 y} - {v}_{0 y} ) * \frac{y}{h}\end{matrix} \qquad ( 2 )$$

### Affine Merge Mode

In affine merge mode, the CPMVs for the current block are not explicitly signaled but derived from neighboring blocks. Specifically, in this mode, motion information of spatial neighbor blocks is used to generate CPMVs for the current block. The affine merge mode candidate list has a limited size. For example, in the current VVC design, there may be up to five candidates. The encoder may evaluate and choose the best candidate index based on rate-distortion optimization algorithms. The chosen candidate index is then signaled to the decoder side. The affine merge candidates can be decided in three ways:
Inherited from neighboring affine coded blocks
Constructed from translational MVs from neighboring blocks
Zero MVs

For the inherited method, there may be up to two candidates. The candidates are obtained from the neighboring blocks located at the bottom-left of the current block (e.g., scanning order is from A0 to A1 as shown in FIG. 6) and from the neighboring blocks located at the top-right of the current block (e.g., scanning order is from B0 to B2 as shown in FIG. 6), if available.

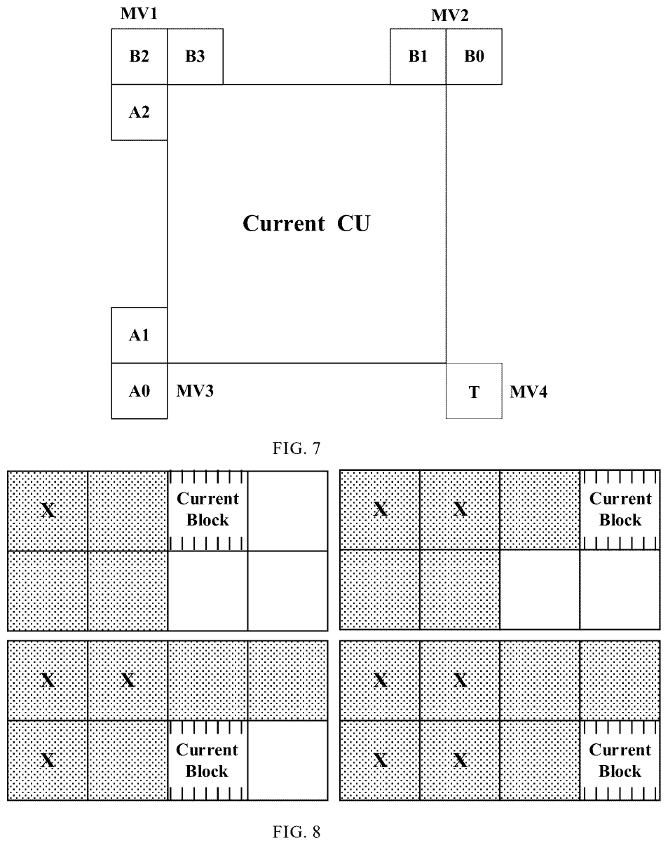

For the constructed method, the candidates are the combinations of neighbor's translational MVs, which are generated by two steps.
Step 1: obtain four translational MVs from available neighbors.
   MV1: MV from the one of the three neighboring blocks close to the top-left corner of the current block. As shown in the FIG. 7, the scanning order is B2, B3 and A2.
   MV2: MV from the one of the one from the two neighboring blocks close to the top-right corner of the current block. As shown in the FIG. 7, the scanning order is Bland B0.
   MV3: MV from the one of the one from the two neighboring blocks close to the bottom-left corner of the current block. As shown in the FIG. 7, the scanning order is A1 and A0.
   MV4: MV from the temporally collocated block of the neighboring block close to the bottom-right corner of current block. As shown in the FIG. 7, the neighboring block is T.
Step 2: derive combinations based on the four translational MVs from step 1.
   Combination 1: MV1, MV2, MV3
   Combination 2: MV1, MV2, MV4
   Combination 3: MV1, MV3, MV4
   Combination 4: MV2, MV3, MV4
   Combination 5: MV1, MV2
   Combination 6: MV1, MV3

When the merge candidate list is not full after filling with inherited and constructed candidates, zero MVs are inserted at the end of the list.

### Affine AMVP Mode

Affine AMVP (advanced motion vector prediction) mode may be applied for CUs with both width and height larger than or equal to 16. An affine flag in CU level is signalled in the bitstream to indicate whether affine AMVP mode is used and then another flag is signalled to indicate whether 4-parameter affine or 6-parameter affine. In this mode, the difference of the CPMVs of current CU and their predictors CPMVPs is signalled in the bitstream. The affine AMVP candidate list size is 2 and the affine AMVP candidate list is generated by using the following four types of CPMV candidate in order:
Inherited affine AMVP candidates that extrapolated from the CPMVs of the neighbour CUs
Constructed affine AMVP candidates CPMVPs that are derived using the translational MVs of the neighbour CUs
Translational MVs from neighboring CUs
Temporal MVs from collocated CUs
Zero MVs

The checking order of inherited affine AMVP candidates is the same to the checking order of inherited affine merge candidates. The only difference is that, for AMVP candidate, only the affine CU that has the same reference picture as in current block is considered. No pruning process is applied when inserting an inherited affine motion predictor into the candidate list.

Constructed AMVP candidate is derived from the same spatial neighbors as affine merge mode. The same checking order is used as done in affine merge candidate construction. In addition, reference picture index of the neighboring block is also checked. The first block in the checking order that is inter coded and has the same reference picture as in current CUs is used. When the current CU is coded with 4-parameter affine mode, and mv₀ and mv₁ are both available, mv₀ and mv₁ are added as one candidate in the affine AMVP candidate list. When the current CU is coded with 6-parameter affine mode, and all three CPMVs are available, they are added as one candidate in the affine AMVP candidate list. Otherwise, constructed AMVP candidate is set as unavailable.

If the number of affine AMVP list candidates is still less than 2 after valid inherited affine AMVP candidates and constructed AMVP candidate are inserted, mv₀, mv₁ and mv₂ will be added, in order, as the translational MVs to predict all control point MVs of the current CU, when available. Finally, zero MVs are used to fill the affine AMVP list if it is still not full.

### Intra Block Copy in Versatile Video Coding (VVC)

Intra block copy (IBC) is a tool adopted in HEVC extensions on SCC. It is well known that it significantly improves the coding efficiency of screen content materials. Since IBC mode is implemented as a block level coding mode, block matching (BM) is performed at the encoder to find the optimal block vector (or motion vector) for each CU. Here, a block vector is used to indicate the displacement from the current block to a reference block, which is already reconstructed inside the current picture. The luma block vector of an IBC-coded CU is in integer precision. The chroma block vector rounds to integer precision as well. When combined with AMVR, the IBC mode can switch between 1-pel and 4-pel motion vector precisions. An IBC-coded CU is treated as the third prediction mode other than intra or inter prediction modes. The IBC mode is applicable to the CUs with both width and height smaller than or equal to 64 luma samples.

At the encoder side, hash-based motion estimation is performed for IBC. The encoder performs RD check for blocks with either width or height no larger than 16 luma samples. For non-merge mode, the block vector search is performed using hash-based search first. If hash search does not return valid candidate, block matching based local search will be performed.

In the hash-based search, hash key matching (32-bit CRC) between the current block and a reference block is extended to all allowed block sizes. The hash key calculation for every position in the current picture is based on 4×4 subblocks. For the current block of a larger size, a hash key is determined to match that of the reference block when all the hash keys of all 4×4 subblocks match the hash keys in the corresponding reference locations. If hash keys of multiple reference blocks are found to match that of the current block, the block vector costs of each matched reference are calculated and the one with the minimum cost is selected.

In block matching search, the search range is set to cover both the previous and current CTUs.

At CU level, IBC mode is signalled with a flag and it can be signaled as IBC AMVP mode or IBC skip/merge mode as follows:
IBC skip/merge mode: a merge candidate index is used to indicate which of the block vectors in the list from neighboring candidate IBC coded blocks is used to predict the current block. The merge list consists of spatial, HMVP, and pairwise candidates.
IBC AMVP mode: block vector difference is coded in the same way as a motion vector difference. The block vector prediction method uses two candidates as predictors, one from left neighbor and one from above neighbor (if IBC coded). When either neighbor is not available, a default block vector will be used as a predictor. A flag is signaled to indicate the block vector predictor index.

### IBC Reference Region

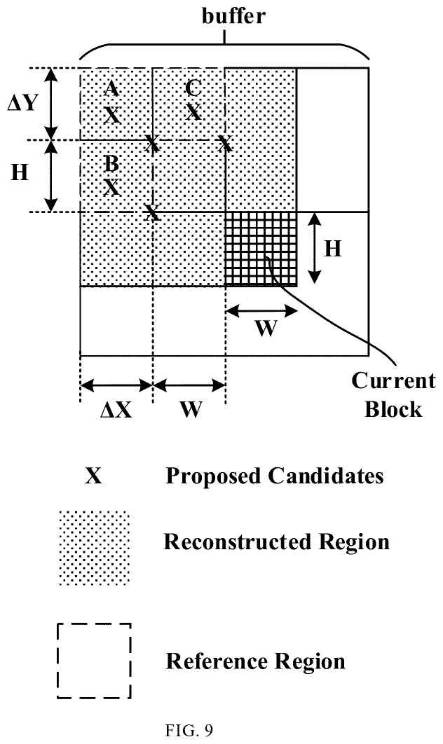

To reduce memory consumption and decoder complexity, the IBC in VVC allows only the reconstructed portion of the predefined area including the region of current CTU and some region of the left CTU. FIG. 8 illustrates the reference region of IBC Mode, where each block represents 64×64 luma sample unit.

Depending on the location of the current coding CU location within the current CTU, the following applies:
If current block falls into the top-left 64×64 block of the current CTU, then in addition to the already reconstructed samples in the current CTU, it can also refer to the reference samples in the bottom-right 64×64 blocks of the left CTU, using CPR mode. The current block can also refer to the reference samples in the bottom-left 64×64 block of the left CTU and the reference samples in the top-right 64×64 block of the left CTU, using CPR mode.
If current block falls into the top-right 64×64 block of the current CTU, then in addition to the already reconstructed samples in the current CTU, if luma location (0, 64) relative to the current CTU has not yet been reconstructed, the current block can also refer to the reference samples in the bottom-left 64×64 block and bottom-right 64×64 block of the left CTU, using CPR mode; otherwise, the current block can also refer to reference samples in bottom-right 64×64 block of the left CTU.
If current block falls into the bottom-left 64×64 block of the current CTU, then in addition to the already reconstructed samples in the current CTU, if luma location (64, 0) relative to the current CTU has not yet been reconstructed, the current block can also refer to the reference samples in the top-right 64×64 block and bottom-right 64×64 block of the left CTU, using CPR mode. Otherwise, the current block can also refer to the reference samples in the bottom-right 64×64 block of the left CTU, using CPR mode.
If current block falls into the bottom-right 64×64 block of the current CTU, it can only refer to the already reconstructed samples in the current CTU, using CPR mode.

This restriction allows the IBC mode to be implemented using local on-chip memory for hardware implementations.

IBC Interaction with Other Coding Tools

The interaction between IBC mode and other inter coding tools in VVC, such as pairwise merge candidate, history based motion vector predictor (HMVP), combined intra/inter prediction mode (CIIP), merge mode with motion vector difference (MMVD), and geometric partitioning mode (GPM) are as follows:
IBC can be used with pairwise merge candidate and HMVP. A new pairwise IBC merge candidate can be generated by averaging two IBC merge candidates. For HMVP, IBC motion is inserted into history buffer for future referencing.
IBC cannot be used in combination with the following inter tools: affine motion, CIIP, MMVD, and GPM.
IBC is not allowed for the chroma coding blocks when DUAL_TREE partition is used.

Unlike in the HEVC screen content coding extension, the current picture is no longer included as one of the reference pictures in the reference picture list 0 for IBC prediction. The derivation process of motion vectors for IBC mode excludes all neighboring blocks in inter mode and vice versa. The following IBC design aspects are applied:
IBC shares the same process as in regular MV merge including with pairwise merge candidate and history-based motion predictor, but disallows TMVP and zero vector because they are invalid for IBC mode.
Separate HMVP buffer (5 candidates each) is used for conventional MV and IBC.
Block vector constraints are implemented in the form of bitstream conformance constraint, the encoder needs to ensure that no invalid vectors are present in the bitstream, and merge shall not be used if the merge candidate is invalid (out of range or 0). Such bitstream conformance constraint is expressed in terms of a virtual buffer as described below.
For deblocking, IBC is handled as inter mode.
If the current block is coded using IBC prediction mode, AMVR does not use quarter-pel; instead, AMVR is signaled to only indicate whether MV is inter-pel or 4 integer-pel.
The number of IBC merge candidates can be signalled in the slice header separately from the numbers of regular, subblock, and geometric merge candidates.

A virtual buffer concept is used to describe the allowable reference region for IBC prediction mode and valid block vectors. Denote CTU size as ctbSize, the virtual buffer, ibcBuf, has width being wIbcBuf=128×128/ctbSize and height hIbcBuf=ctbSize. For example, for a CTU size of 128×128, the size of ibcBuf is also 128×128; for a CTU size of 64×64, the size of ibcBuf is 256×64; and a CTU size of 32×32, the size of ibcBuf is 512×32.

The size of a VPDU is min (ctbSize, 64) in each dimension, Wᵥ=min (ctbSize, 64).

The virtual IBC buffer, ibcBuf is maintained as follows.
At the beginning of decoding each CTU row, refresh the whole ibcBuf with an invalid value −1.
At the beginning of decoding a VPDU (xVPDU, yVPDU) relative to the top-left corner of the picture, set the ibcBuf[x][y]=−1, with x=xVPDU % wIbcBuf, . . . , xVPDU % wIbcBuf+Wᵥ−1; y=yVPDU % ctbSize, . . . , yVPDU % ctbSize+Wᵥ−1.
After decoding a CU contains (x, y) relative to the top-left corner of the picture, set ibcBuf[x % wIbcBuf][y % ctbSize]=recSample[x][y]

For a block covering the coordinates (x, y), if the following is true for a block vector bv=(bv[0], bv[1]), then it is valid; otherwise, it is not valid:
ibcBuf[(x+bv[0]) % wIbcBuf] [(y+bv[1]) % ctbSize] shall not be equal to −1.

### Intra Block Copy in Enhanced Compression Model (ECM)

In ECM, IBC is improved from aspects below.

### IBC Merge/AMVP List Construction

The IBC merge/AMVP list construction is modified as follows:
Only if an IBC merge/AMVP candidate is valid, it can be inserted into the IBC merge/AMVP candidate list.
Above-right, bottom-left, and above-left spatial candidates and one pairwise average candidate can be added into the IBC merge/AMVP candidate list.
Template based adaptive reordering (ARMC-TM) is applied to IBC merge list.

The HMVP table size for IBC is increased to 25. After up to 20 IBC merge candidates are derived with full pruning, they are reordered together. After reordering, the first 6 candidates with the lowest template matching costs are selected as the final candidates in the IBC merge list.

The zero vectors' candidates to pad the IBC Merge/AMVP list are replaced with a set of BVP candidates located in the IBC reference region. A zero vector is invalid as a block vector in IBC merge mode, and consequently, it is discarded as BVP in the IBC candidate list.

Three candidates are located on the nearest corners of the reference region, and three additional candidates are determined in the middle of the three sub-regions (A, B, and C), whose coordinates are determined by the width, and height of the current block and the ΔX and ΔY parameters, as is depicted in FIG. 9.

IBC with Template Matching

Template Matching is used in IBC for both IBC merge mode and IBC AMVP mode.

The IBC-TM merge list is modified compared to the one used by regular IBC merge mode such that the candidates are selected according to a pruning method with a motion distance between the candidates as in the regular TM merge mode. The ending zero motion fulfillment is replaced by motion vectors to the left (−W, 0), top (0, −H) and top-left (−W, −H), where W is the width and H the height of the current CU.

In the IBC-TM merge mode, the selected candidates are refined with the Template Matching method prior to the RDO or decoding process. The IBC-TM merge mode has been put in competition with the regular IBC merge mode and a TM-merge flag is signaled.

In the IBC-TM AMVP mode, up to 3 candidates are selected from the IBC-TM merge list. Each of those 3 selected candidates are refined using the Template Matching method and sorted according to their resulting Template Matching cost. Only the 2 first ones are then considered in the motion estimation process as usual.

The Template Matching refinement for both IBC-TM merge and AMVP modes is quite simple since IBC motion vectors are constrained (i) to be integer and (ii) within a reference region as shown in FIG. 8. So, in IBC-TM merge mode, all refinements are performed at integer precision, and in IBC-TM AMVP mode, they are performed either at integer or 4-pel precision depending on the AMVR value. Such a refinement accesses only to samples without interpolation. In both cases, the refined motion vectors and the used template in each refinement step must respect the constraint of the reference region.

### IBC Reference Area

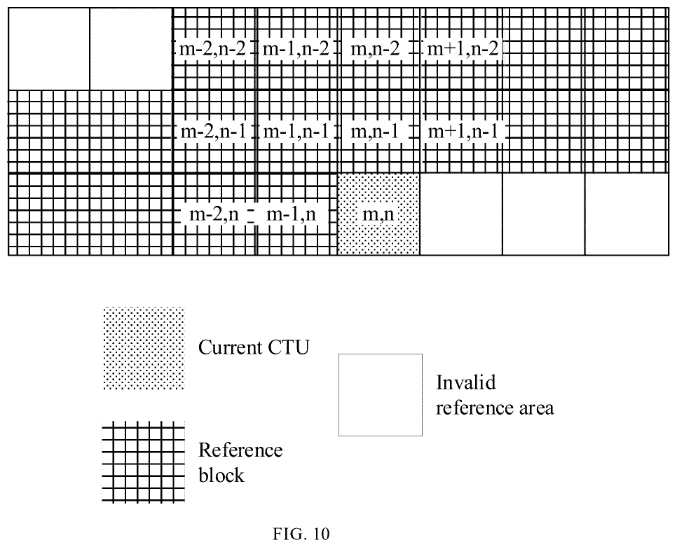

The reference area for IBC is extended to two CTU rows above. FIG. 10 illustrates the reference area for coding CTU (m,n). Specifically, for CTU (m,n) to be coded, the reference area includes CTUs with index (m−2,n−2) . . . (W,n−2), (0,n−1) . . . (W,n−1), (0,n) . . . (m,n), where W denotes the maximum horizontal index within the current tile, slice or picture. This setting ensures that for CTU size being 128, IBC does not require extra memory in the current ETM platform. The per-sample block vector search (or called local search) range is limited to [−(C<<1), C>>2] horizontally and [−C, C>>2] vertically to adapt to the reference area extension, where C denotes the CTU size.

IBC Merge Mode with Block Vector Differences

IBC merge mode with block vector differences is adopted in ECM. The distance set is {1-pel, 2-pel, 4-pel, 8-pel, 12-pel, 16-pel, 24-pel, 32-pel, 40-pel, 48-pel, 56-pel, 64-pel, 72-pel, 80-pel, 88-pel, 96-pel, 104-pel, 112-pel, 120-pel, 128-pel}, and the BVD directions are two horizontal and two vertical directions.

The base candidates are selected from the first five candidates in the reordered IBC merge list. And based on the SAD cost between the template (one row above and one column left to the current block) and its reference for each refinement position, all the possible MBVD refinement positions (20×4) for each base candidate are reordered. Finally, the top 8 refinement positions with the lowest template SAD costs are kept as available positions, consequently for MBVD index coding.

### IBC Adaptation for Camera-Captured Content

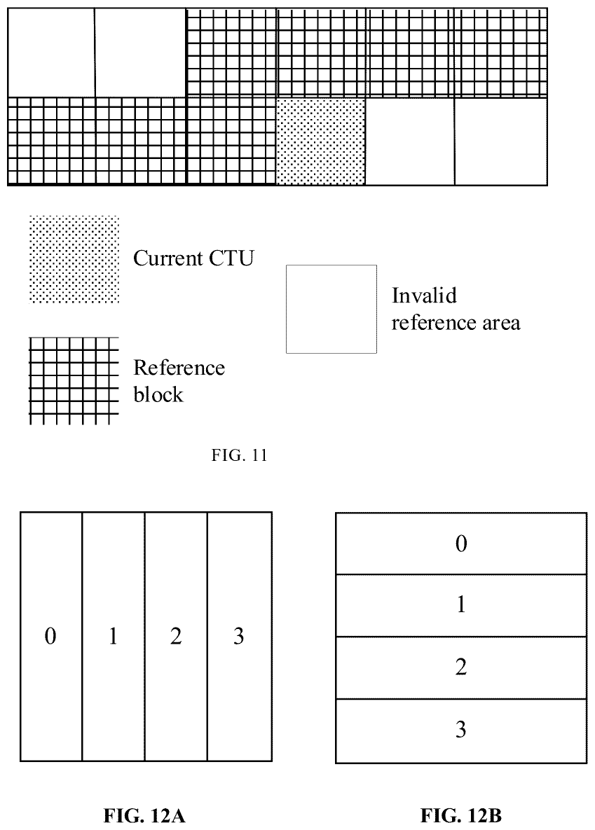

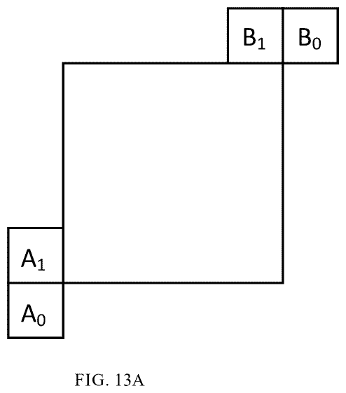

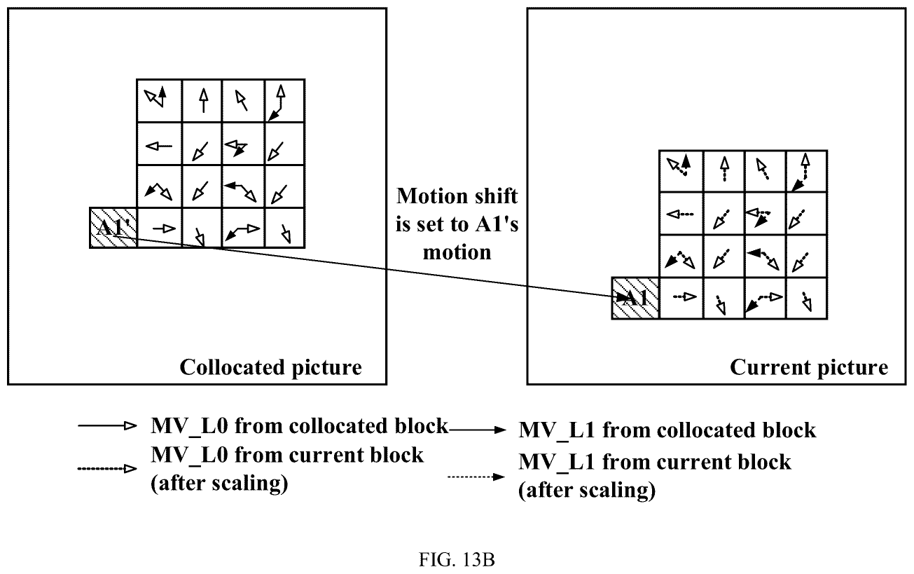

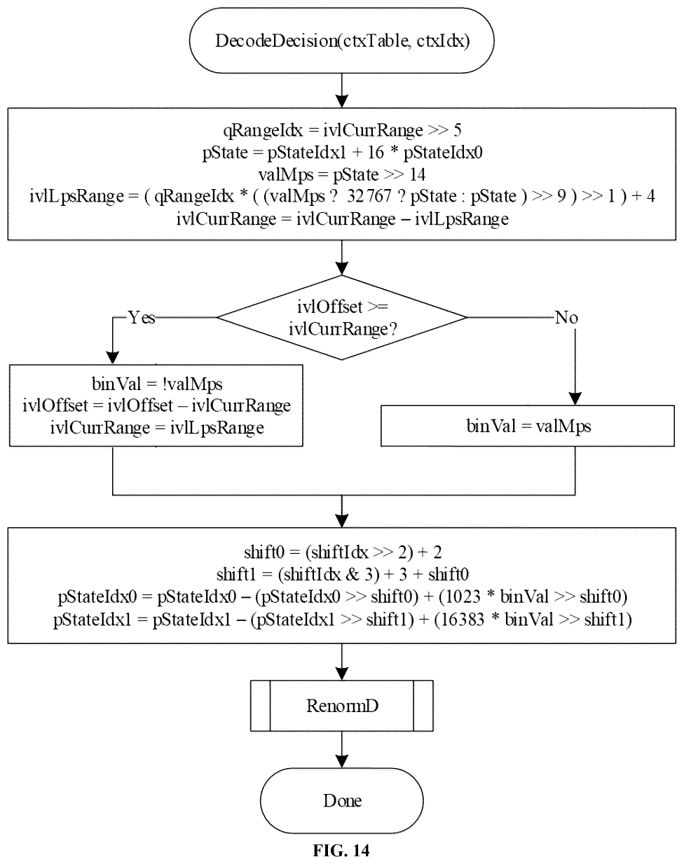

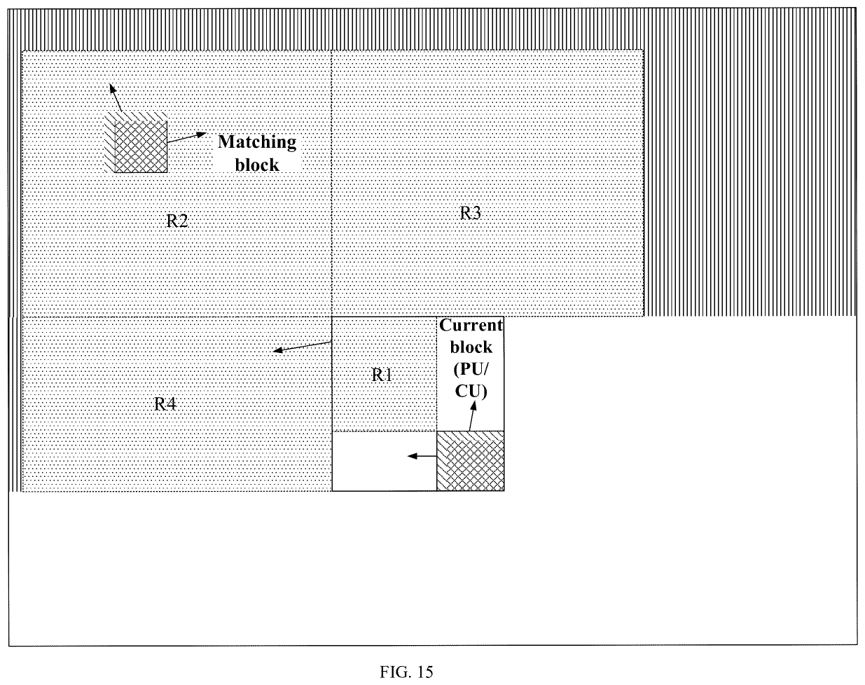

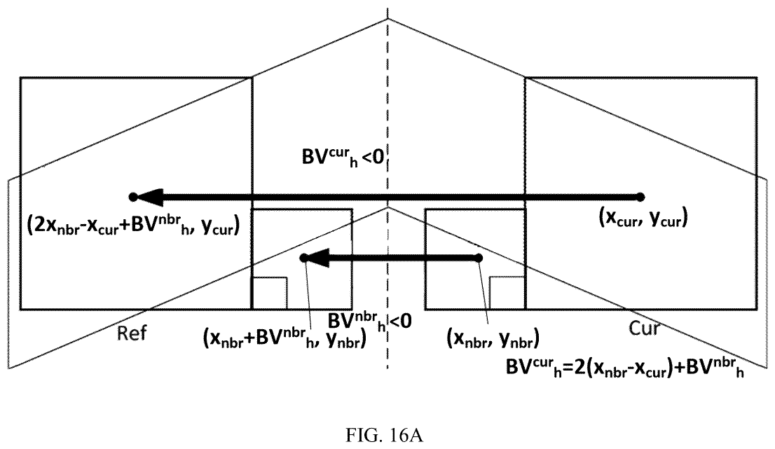

When adapt IBC for camera-captured content, IBC reference range is reduced from 2 CTU rows to 2×128 rows as shown in FIG. 11. At encoder side to reduce the complexity, the local search range is set to [−8,8] horizontally and [−8,8] vertically centered at the first block vector predictor of the current CU. This encoder modification is not applied to SCC sequences.

### Subblock-Based Temporal Motion Vector Prediction (SbTMVP)

VVC supports the subblock-based temporal motion vector prediction (SbTMVP) method. Similar to the temporal motion vector prediction (TMVP) in HEVC, SbTMVP uses the motion field in the collocated picture to improve motion vector prediction and merge mode for CUs in the current picture. The same collocated picture used by TMVP is used for SbTMVP. SbTMVP differs from TMVP in the following two main aspects:
TMVP predicts motion at CU level but SbTMVP predicts motion at sub-CU level;
Whereas TMVP fetches the temporal motion vectors from the collocated block in the collocated picture (the collocated block is the bottom-right or center block relative to the current CU), SbTMVP applies a motion shift before fetching the temporal motion information from the collocated picture, where the motion shift is obtained from the motion vector from one of the spatial neighboring blocks of the current CU.

The SbTMVP process is illustrated in FIGS. 13A-13B. SbTMVP predicts the motion vectors of the sub-CUs within the current CU in two steps. In the first step, the spatial neighbor A1 in FIG. 13A is examined. If A1 has a motion vector that uses the collocated picture as its reference picture, this motion vector is selected to be the motion shift to be applied. If no such motion is identified, then the motion shift is set to (0, 0).

In the second step, the motion shift identified in Step 1 is applied (i.e., added to the current block's coordinates) to obtain sub-CU-level motion information (motion vectors and reference indices) from the collocated picture as shown in FIG. 13B. The example in FIG. 13B assumes the motion shift is set to block A1's motion. Then, for each sub-CU, the motion information of its corresponding block (the smallest motion grid that covers the center sample) in the collocated picture is used to derive the motion information for the sub-CU. After the motion information of the collocated sub-CU is identified, it is converted to the motion vectors and reference indices of the current sub-CU in a similar way as the TMVP process of HEVC, where temporal motion scaling is applied to align the reference pictures of the temporal motion vectors to those of the current CU.

In VVC, a combined subblock based merge list which contains both SbTMVP candidate and affine merge candidates is used for the signalling of subblock based merge mode. The SbTMVP mode is enabled/disabled by a sequence parameter set (SPS) flag. If the SbTMVP mode is enabled, the SbTMVP predictor is added as the first entry of the list of subblock based merge candidates, and followed by the affine merge candidates. The size of subblock based merge list is signalled in SPS and the maximum allowed size of the subblock based merge list is 5 in VVC.

The sub-CU size used in SbTMVP is fixed to be 8×8, and as done for affine merge mode, SbTMVP mode is only applicable to the CU with both width and height are larger than or equal to 8.

The encoding logic of the additional SbTMVP merge candidate is the same as for the other merge candidates, that is, for each CU in Por B slice, an additional RD check is performed to decide whether to use the SbTMVP candidate.

### Intra Template Matching

Intra template matching prediction (Intra TMP) is a special intra prediction mode that copies the best prediction block from the reconstructed part of the current frame, whose L-shaped template matches the current template. For a predefined search range, the encoder searches for the most similar template to the current template in a reconstructed part of the current frame and uses the corresponding block as a prediction block. The encoder then signals the usage of this mode, and the same prediction operation is performed at the decoder side.

The prediction signal is generated by matching the L-shaped causal neighbor of the current block with another block in a predefined search area in FIG. 4 consisting of:
R1: current CTU
R2: top-left CTU
R3: above CTU
R4: left CTU

Sum of absolute differences (SAD) is used as a cost function.

Within each region, the decoder searches for the template that has the minimum SAD with respect to the current one and uses its corresponding block as a prediction block.

The dimensions of all regions (SearchRange_w, SearchRange_h) are set proportional to the block dimension (BlkW, BlkH) to have a fixed number of SAD comparisons per pixel. That is:

$$\begin{matrix}SearchRange\_w = a * BlkW \\ SearchRange\_h = a * BlkH\end{matrix}$$

where ‘a’ is a constant that controls the gain/complexity trade-off. In practice, ‘a’ is equal to 5.

The Intra template matching tool is enabled for CUs with size less than or equal to 64 in width and height. This maximum CU size for Intra template matching is configurable.

The Intra template matching prediction mode is signaled at CU level through a dedicated flag when DIMD is not used for current CU.

### The Probability Estimation Technique for the CABAC in the AVC and HEVC

The CABAC (the context-based adaptive binary arithmetic coding) was originally introduced in the H.264/AVC standard, as one of two supported entropy coding schemes. In the CABAC, arithmetic coding is composed of two modules: codeword mapping (also known as binarization) and probability estimation. In the process of codeword mapping, the syntax elements are mapped into strings of bins. The mapping is realized by the so-called binarizer which translates the syntax elements into several group of bins based on different binarization schemes. In practice, various binarization schemes may be applied for such translation, such as fixed-length code, unary code, truncated unary code, and k^{th}-order Exponential-Golomb code and so forth. The purpose of the probability estimation module is to determine the likelihood of one bin having the value of 1 or 0. In the AVC, the probabilities of bins are calculated based on an exponential aging model, where the probability that one current bin is equal to 1 or 0 is dependent on the values of previous bins that are previously coded. Additionally, according to common data statistics, the influence of bins that are immediately precede one current bin are usually larger than the bins that are coded long ago. Taking such into consideration, one parameter α is introduced in the CABAC, which controls the number N of previously coded bins that are used to estimate the probability of the current bin, i.e., N=1/α. The parameter translates into the adaptation speed with which the probability is updated along with the increased coded bins. Specifically, with the adaptation parameter α, the probability that one bin is the least probable symbol (LPS) is calculated recursively as

$$p ( t + 1 ) = p ( t ) \cdot ( 1 - α ) + x ( t ) \cdot α \qquad ( 3 )$$

where p(t) is the probability of the LPS symbol at instant t; p(t+1) is the updated probability of the LPS symbol at instant t+1; x(t) is equal to 1 when the current bin is LPS symbol and 0 when the current bin is the most probable symbol (MPS). In the CABAC engine of the AVC and the HEVC, the probability is independently updated according to (3) for each syntax element with a fixed value of α≈1/19.69, i.e., around 19.69 previously coded bins are considered when estimating the probability of one current bin. Moreover, in order to avoid multiplications during the probability estimation, the probability p(t) in (3), which is real number and ranges from 0 to 1, is quantized into a set of fixed probability states. For example, in both the AVC and the HEVC, the probability has 7-bit precision, corresponding to 128 probability states.

In the AVC and the HEVC, a video bitstream usually consists one or more independently decodable slices. At beginning of each slice, the probabilities of all the contexts are initialized to some pre-defined values. Theoretically, with knowing the statistic nature of one given context, uniform distribution (i.e., pᵢₙᵢₜ=0.5) should be used to initialize the context probability. However, to enable a faster catchup of the probability of one context to its corresponding statistical distribution, it was found that to be beneficial to provide some appropriate initial probability values (which may not be equiprobable) for each context. Specifically, in the AVC and HEVC, given the initial QP of one slice SliceQP_{Y}, the initial probability state of one context InitProbState is calculated as follows:

$$\begin{matrix}m = SlopeIdx \cdot 5 - 45 \\ n = ( OffsetIdx ≪ 3 ) - 16 \\ InitProbState = Clip 3 ( 1 , 1 \; 27 , ( m \cdot {SliceQP}_{Y} ) ≫ 4 + n )\end{matrix} \qquad ( 4 )$$

where SlopeIdx and OffsetIdx (both in the range from 0 to 15) are two initialization parameters, which are predefined and stored as look-up table (LUT), to calculate the initial probability of one context. As shown in (4), the initial probability state is modeled by a linear function of the slice QP with the slope equal to (m>>4) and the offset equal to n.

The probability estimation technique for the CABAC in the VVC

The probability estimation module that is applied in the VVC is kept almost the same as that in the AVC and HEVC, except for the following key differences:
1. VVC maintains two probability estimates for each context, where each has its own probability adaptation rate α in (3). The final probability that is actually used for arithmetic coding is the average of the two estimates.
2. In the VVC, multiple probability LUTs are predefined and used to initialize the probabilities of different contexts of one slice. Meanwhile, similar to the AVC and the HEVC, the initial estimate of the probability is built upon one linear model taking the slice QP as the input. However, in the VVC, the derived value represents the actual probability value; whereas in the AVC/HEVC, it represents the index of the probability state.

### Multi-Hypothesis Probability Estimation

It is obvious that using one fixed adaptation parameter for all the syntax elements may not be optimal due to their different statistical characteristics. On the other hand, it has been proven in several scientific research that better estimation accuracy can be achieved by using multiple probability estimators compared to one single estimator. Therefore, one multi-hypothesis probability estimation scheme is applied in the CABAC design of the VVC, where two different adaptation parameter α₀ and α₁ are utilized, which correspond to one slow and fast speed for the probability adaptation. By such way, two different probabilities can be calculated for each bin using two adaptation parameters, which are then averaged to generate the final probability of the bin, i.e.,

$$\begin{matrix}{p}_{0} ( t + 1 ) = {p}_{0} ( t ) \cdot ( 1 - {α}_{0} ) + x ( t ) \cdot {α}_{0} \\ {p}_{1} ( t + 1 ) = {p}_{1} ( t ) \cdot ( 1 - {α}_{1} ) + x ( t ) \cdot {α}_{1} \\ p ( t + 1 ) = ( {p}_{0} ( t + 1 ) + {p}_{1} ( t + 1 ) ) / 2\end{matrix} \qquad ( 5 )$$

where α₀ and α₁ are the two adaptation parameters associated with the two probability hypotheses. In the VVC, the values of α₀ and α₁ are independently selected for each context using one training algorithm that is designed to jointly optimize the adaptation parameters as well as the initial probabilities. Specifically, according to the current design, each context is allowed to select α₀ from one set of predefined values of {¼, ⅛, 1/16, 1/32} and α₁ from another set of predefined values of { 1/32, 1/64, 1/128, 1/256, 1/512}.

### Initial Probability Calculation

As in the AVC/HEVC, the CABCA process of the VVC also invoke one QP dependent probability initialization process at the beginning of each slice. However, compared to the AVC/HEVC which initializes the state of one probability state machine, the actual value of the initial probability is directly derived, as depicted as

$$\begin{matrix}m = ( SlopeIdx ≫ 3 ) - 4 \\ n = ( ( OffsetIdx \& 7 ) \cdot 18 ) + 1 \\ InitState = Clip 3 ( 1 , 1 \; 27 , ( m \cdot {SliceQP}_{Y} - 16 ) ) ≫ 1 + n ) \\ {p}_{0}^{init} = initState ≪ 7 \\ {p}_{1}^{init} = initState ≪ 3\end{matrix} \qquad ( 6 )$$

where SlopeIdx and OffsetIdx are two initialization parameters for calculating the slope and offset of the linear model, each being represented in the precision of 3 bit; p₀^{init} and p₀^{init} are the two initial probabilities calculated for two probability estimators.

### Entropy Coding in ECM

### Extended Precision

The intermediate precision used in the arithmetic coding engine is increased, including three elements. First, the precisions for two probability states are both increased to 15 bits, in comparison to 10 bits and 14 bits in VVC. Second, the LPS range update process is modified as below,

If q >= 16384
q = 2¹⁵ − 1 − q
R_{LPS} = ((range * (q>>6))>>9) + 1,

where range is a 9-bit variable representing the width of the current interval, q is a 15-bit variable representing the probability state of the current context model, and R_{LPS} is the updated range for LPS. This operation can also be realized by looking up a 512×256-entry in 9-bit look-up table. Third, at the encoder side, the 256-entry look-up table used for bits estimation in VTM is extended to 512 entries.

### Slice-Type-Based Window Size

Since statistics are different with different slice types, it is beneficial to have a context's probability state updated at a rate that may provide more accurate probability estimation (e.g., to more accurately predict the likelihood of one bin having the value of 1 or 0) under the given slice type. Therefore, for each context model, three window sizes are pre-defined for I-, B-, and P-slices, respectively, like the initialization parameters.

The context initialization parameters and window sizes are retrained.

### Improved Probability Estimation for CABAC

Multi-Hypothesis Probability Estimation with Adaptive Weight

The multi-hypothesis-based probability is estimated based on adaptive weights (MHP-AW). Specifically, two separate probability estimates p₀ and p₁ are maintained for each context and updated according to their own adaptation rates. However, instead of using simple average, multiple weights are introduced to derive the resulting probability p used for the binary arithmetic coding, as illustrated as follows:

$$p = ( {ω}_{0} \cdot {p}_{0} + {ω}_{1} \cdot {p}_{1} ) ≫ s$$

where ω₀ and ω₁ are the weights selected from a pre-defined set {10, 12, 16, 20, 22}; s is the bitwise right-shift value, which is equal to 5 when (ω₀+ω₁)≤32 and 6 otherwise. Three different sets of weights are pre-determined for each context model at I-, B- and P-slice types. The weights of I-slice type are only allowed for intra slices while the weights of B- and P-slice types are allowed to be switched for inter slices at slice level.
CABAC Initialization from Previous Inter Slice and Windows Adjustment

Context initialization stored at previously coded picture after coding the last CTU can be used to initialize an inter slice having the same slice type, QP, and temporal ID. The buffer size for storing previous initializations is set equal to 5 for each slice type, when the buffer is full, the entry with the smallest QP and temporal ID is removed first before storing the initialization.

The CABAC employs two probability states that are updated with a short and a long window size, respectively. The window sizes, predefined for each context model, are not optimal for varying statistics in different regions, hence window sizes are adjusted according to the previously coded bin of each context.

The short and long window sizes used in CABAC update are adjusted by two delta parameters stored in a look-up table per context and retrieved by a previous coded bin used as an index. The previous coded bin is used as an index to get the adjustment parameters from a look-up table: delta0 for the short window and delta1 for the long window. Denote the original short and long window sizes stored in the existed initialization tables and defined for the context model as shift0 and shift1, respectively. The actual window sizes used to code the current bin after adjustment are respectively (shift0+delta0) and (shift1+delta1), where shift0 and shift1 are existed predefined windows sizes stored in the context initialization tables.

### Reconstruction-Reordered IBC for Screen Content Coding (RRIBC)

Symmetry is often observed in video content, especially in text character regions and computer-generated graphics in screen content sequences. A Reconstruction-Reordered IBC (RRIBC) mode was proposed for screen content video coding to further improve the coding efficiency of IBC in the ECM.

When RRIBC is applied, the samples in a reconstruction block are flipped according to the flip type of the current block. At the encoder side, the original block is flipped before motion search and residual calculation, while the prediction block is derived without flipping. At the decoder side, the reconstruction block is flipped back to restore the original block.

Specifically, two flip methods, horizontal flip and vertical flip, are supported for RRIBC coded blocks. A syntax flag is firstly signalled for an IBC AMVP coded block, indicating whether the reconstruction is flipped, and if it is flipped, another flag is further signaled specifying the flip type. For IBC merge, the flip type is inherited from neighbouring blocks, without syntax signalling. Considering the horizontal or vertical symmetry, the current block and the reference block are normally aligned horizontally or vertically. Therefore, when a horizontal flip is applied, the vertical component of the BV is not signaled and inferred to be equal to 0. Similarly, the horizontal component of the BV is not signaled and inferred to be equal to 0 when a vertical flip is applied.

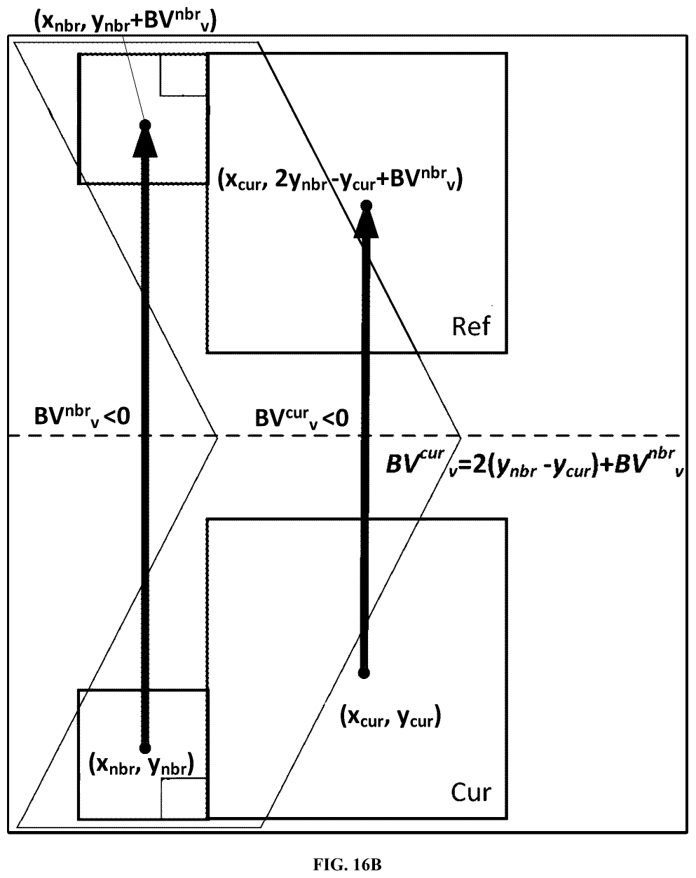

To better utilize the symmetry property, a flip-aware BV adjustment approach is applied to refine the block vector candidate. For example, as shown in FIGS. 16A and 16B, (x_{nbr}, y_{nbr}) and (x_{cur}, y_{cur}) represent the coordinates of the center sample of the neighbouring block and the current block, respectively, BV^{nbr} and BV^{cur} denotes the BV of the neighbouring block and the current block, respectively. Instead of directly inheriting the BV from a neighbouring block, the horizontal component of BV^{cur} is calculated by adding a motion shift to the horizontal component of BV^{nbr} (denoted as BV^{nbr}ₕ) in case that the neighbouring block is coded with a horizontal flip, i.e., BV^{cur}ₕ=2(x_{nbr}−x_{cur})+BV^{nbr}ₕ. Similarly, the vertical component of BV^{cur} is calculated by adding a motion shift to the vertical component of BV^{nbr} (denoted as BV^{nbr}ᵥ) in case that the neighbouring block is coded with a vertical flip, i.e., BV^{cur}ᵥ=2(y_{nbr}−y_{cur})+BV^{nbr}ᵥ.

### Direct Block Vector Mode for Chroma Prediction (DBV)

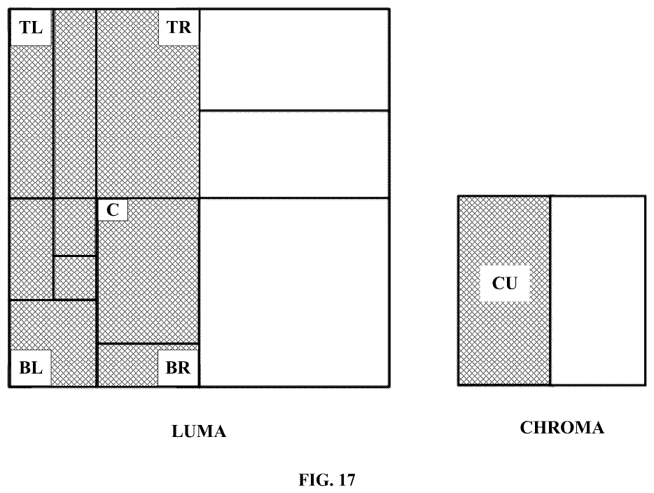

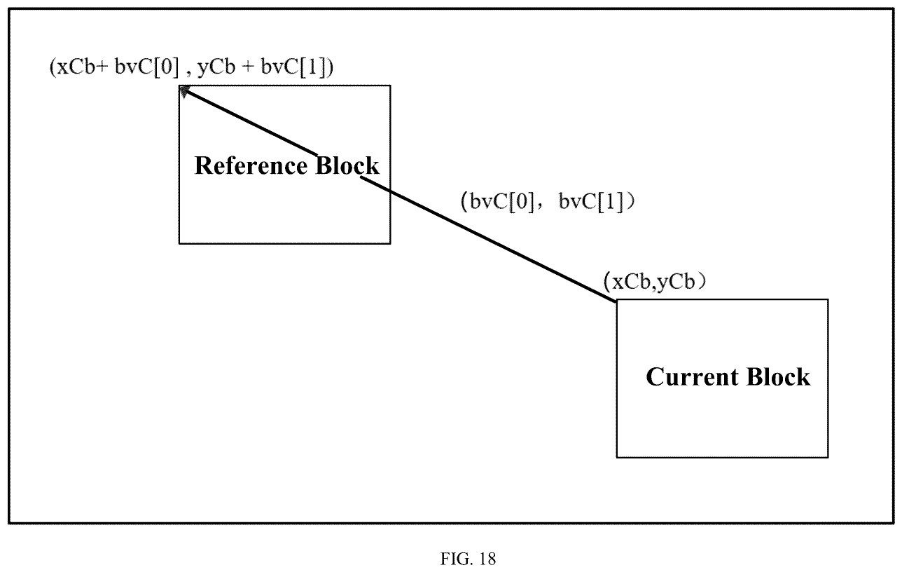

Direct block vector (DBV) is provided to improve the coding efficiency for chroma components when dual tree is activated in intra slice. When chroma dual tree is activated in intra slice, for a chroma CU coded as DBV mode, if the center block in FIG. 17 is coded with IBC mode or IntraTmp mode, its block vector bvL is used to derive chroma block vector bvC. The bv scaling process is determined according to template matching. If the luma block is coded with a RRIBC, a flip-aware BV adjustment is conducted for bvL, same as RRIBC. Then, as depicted in FIG. 18, by using the position of the current chroma block (xCb, yCb) and its bvC, the corresponding offset position (xCb+bvC_hor, yCb+bvC_ver) is determined, and a block copy prediction is performed.

### Block Vector Difference Prediction for IBC Blocks (IBC-BVDP)

IBC-BVDP is a technique to predict signs and magnitudes of x- and y-components of block vector differences (BVDs) for IBC blocks. In particular, BVD signs and suffix bins of exponential Golomb code used to represent BVD magnitudes are predicted by estimating template matching cost of candidate blocks to take advantage of regular CABAC mode rather than its by-pass mode at the entropy coding stage. Specifically, the most significant bins of magnitude suffixes of BVD horizontal and vertical components are predicted, and the prediction match result is coded in the bitstream using CABAC context mode. The less significant bins of magnitude suffixes of horizontal and vertical BVD components are coded in by-pass mode. The maximum number of bins to be predicted for a PU is controlled by a macro, and currently set as 4 in ECM8.0.

### BVP Candidates Clustering and BVD Sign Derivation for Reconstruction-Reordered IBC Mode (IBC-BVPC)

In this IBC-BVPC mode, the IBC AMVP list construction is modified based on the clustering of the block vector predictor (BVP) candidates according to the distance between them, and the sign prediction of the BVD if the BV has one null component.

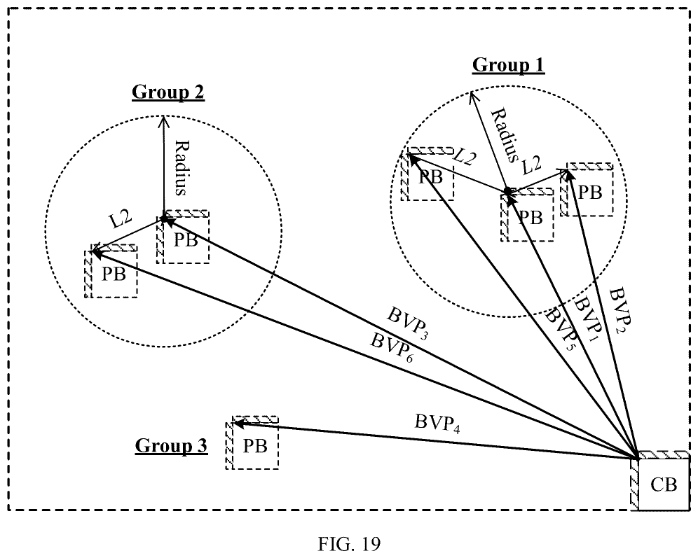

For the blocks whose BV has both non-null components, a clustering of the BVP candidates before selecting the two AMVP candidates is applied. The clustering is used if the number of valid BVP candidates exceeds two, and up to six BVP candidates are clustered based on the L2 Euclidean distance between them. The radius (R) determines a group (as shown in FIG. 19) of vectors as a logarithmic function of the width (cbWidth) and height (cbHeight) of the current block as follows:

$$R = {log}_{2} ( ( cbWidth \cdot cbHeight ) ≫ MIN\_PU \_SIZE ) \qquad ( 7 )$$

The clustering method is applied in the candidate list order, and the candidates assigned to a group are removed from the list for the subsequent clusters. In each group, the BVP with a lowest TM cost is selected as the representative candidate of that group. The representative candidates of the two first groups are chosen for the motion estimation process as in the regular IBC AMVP list.

On the contrary, BVs with one null component, including the RRIBC blocks, are signaled to the decoder by a bvOneNullComp flag. Instead of invoking the AMVP IBC list construction, two new BVP candidates are determined, which are adjusted to the boundaries of the valid IBC search region according to the horizontal or vertical direction indicated by a bvNullCompDir flag.

The AMVP BVP, is set to the nearest valid location to the current block (−cbWidth or −cbHeight), so the BVD, if it is not null, is always negative, pointing to the left for a BV with a null vertical component or to the above for a BV with a null horizontal component. Likewise, the AMVP BVP1 is set to the farthest position from the current block in the valid reference region, that is the left boundary or the top boundary of the IBC search region. Consequently, if the BVP1 is selected, the BVD always is positive, pointing to the right for BV with a null vertical component or to the bottom for BV with a null horizontal component.

The optimal IBC AMVP index is signaled, which allows deriving the sign of the non-null BVD component at the decoder side. Consequently, the absolute value of the non-null component of the BVD is signaled to the decoder, improving the coding efficiency. The RRIBC mode is signaled using the existing syntax flag, and the direction of the flipping mode is derived from the bvNullCompDir flag.

IBC with Local Illumination Compensation (IBC-LIC)

Intra block copy with local illumination compensation (IBC-LIC) is a coding tool which compensates the local illumination variation within a picture between the CU coded with IBC and its prediction block with a linear equation. The parameters of the linear equation are derived same as LIC for inter prediction except that the reference template is generated using block vector in IBC-LIC. IBC-LIC can be applied to IBC AMVP mode and IBC merge mode. For IBC AMVP mode, an IBC-LIC flag is signalled to indicate the use of IBC-LIC. For IBC merge mode, the IBC-LIC flag is inferred from the merge candidate.

### Combined Intra Block Copy and Intra Prediction (IBC-CIIP)

Combined intra block copy and intra prediction (IBC-CIIP) is a coding tool for a CU which uses IBC with merge mode and intra prediction to obtain two prediction signals, and the two prediction signals are weighted summed to generate the final prediction. Specifically, if the intra prediction is planar or DC mode, the final prediction is obtained as follows:

$$P = ( {w}_{i b c} * {P}_{i b c} + ( ( 1 ≪ shift ) - {w}_{ibc} ) * {P}_{intra} + ( 1 ≪ ( shift - 1 ) ) ) ≫ shift$$

wherein P_{ibc} and Pᵢₙₜᵣₐ denote the IBC prediction signal and intra prediction signal, respectively. (w_{ibc}, shift) are set equal to (1, 2) if both the up and left CUs are intra coded, (2, 2) if one of the up and left CUs are intra coded, (3, 2) if both the up and left CUs are IBC coded. Otherwise (i.e., if the intra prediction is directional mode), the final prediction is obtained by adaptively switching the prediction samples of the intra mode and the IBC. For purpose of illustration, assuming the size of the current CU is w*h and the intra mode is horizontal or vertical, the left ¾w*h part (horizontal mode) or top w*¾h part (vertical mode) of the final prediction is set to intra prediction signal if both the top and left neighboring CUs are intra coded; and the left ½w*h part (horizontal mode) or the top w*½h part (vertical mode) of the final prediction is set to intra prediction signal if only one of the top and left CUs are intra coded; and the left ¼w*h part (horizontal mode) or the top w*¼h part (vertical mode) of the final prediction is set to intra prediction signal if both the up and left CUs are IBC or inter coded. In the above, besides the intra prediction portion, the other part of the final prediction is set to the IBC prediction samples.
IBC Merge Mode with Block Vector Differences (IBC-MBVD)

Affine-MMVD and GPM-MMVD have been adopted to ECM as an extension of regular MMVD mode. This disclosure discloses methods and devices to extend the MMVD mode to the IBC merge mode.

In IBC-MBVD, the distance set is {1-pel, 2-pel, 4-pel, 8-pel, 12-pel, 16-pel, 24-pel, 32-pel, 40-pel, 48-pel, 56-pel, 64-pel, 72-pel, 80-pel, 88-pel, 96-pel, 104-pel, 112-pel, 120-pel, 128-pel}, and the BVD directions are two horizontal and two vertical directions.

The base candidates are selected from the first five candidates in the reordered IBC merge list. And based on the SAD cost between the template (one row above and one column left to the current block) and its reference for each refinement position, all the possible MBVD refinement positions (20×4) for each base candidate are reordered. Finally, the top 8 refinement positions with the lowest template SAD costs are kept as available positions, consequently for MBVD index coding. The MBVD index is binarized by the rice code with the parameter equal to 1.

An IBC-MBVD coded block does not inherit flip type from a RR-IBC coded neighbor block.

In video coding, intra block copy is well known to accurately predict screen content and artificially generated content where patterns and edges may repeat within the frame. Intra block copy may also be beneficial for natural content predictions where the current frame has repeated textures. For the coding scenarios without too much repeated content, the mode of intra block copy may not be selected while its minimum signaling bits are still transmitted. In this case, to further enhance the coding efficiency of intra block copy, it is desired to provide more flexible on/off control mechanisms at different granularities.

In the inter-predicted coding modes, fractional motion vectors are used to improve the prediction accuracy. However, in the current intra block copy mode, only integer motion vectors are used. It is desirable to explore the coding benefits of fractional motion vectors for intra block copy. When fractional motion is used in intra block copy, several subsequent problems need to be resolved: fractional motion derivation, signaling, interpolation padding, interpolation filtering selection, interactions with other coding tools, etc.

In this disclosure, the coding tool of intra block copy is improved from aspects below:
Flexible on/off control mechanisms
CABAC context window
Interpolation based fractional intra block copy
   Fractional motion search
   Fractional motion refinement
   Conditional sample/pixel padding for fractional interpolation
   Interpolation filter switch
   Multi-hypothesis fractional intra block copy
Signaling of motion information
IBC merge/AMVP motion candidate list construction
Combination with intra template matching
Combination with IBC merge mode with block vector differences
Combination of IBC-LIC and IBC with fractional motion vectors
Combination of DBV and IBC with fractional or integer motion vectors
Combination of RRIBC and IBC with fractional motion vectors
Combination of IBC-BVPC and IBC with fractional motion vectors
Combination of IBC-BVDP and IBC with fractional motion vectors
Combination of pairwise candidates and other IBC coding modes
   Flexible on/Off Control Mechanisms

In this section, several methods are proposed to do on/off control for the application of the IBC mode. The on/off control indicates whether the IBC mode is allowed to be possibly enabled for the current sequence, frame, slice, CTU, or block which is at different granularities. If IBC mode is on, further flags (e.g., whether IBC mode is enabled or disabled for a specific block) or/and information (e.g., block vectors) may be signaled. If IBC mode is off, no more flags or information is signaled.

In some embodiments, the on/off control of intra block copy may be based on explicit signaling methods.

In one embodiment, the on/off control is based on one or more, sequence level, or frame level, or slice level or Coding tree unit (CTU) level, or block level flag, or any combination of different levels of flags. When any combination of different levels of flags are used, the transmission of lower level of flags are dependent on the on/off of higher level of flags. In one example, if the frame level flag indicates the turned off of IBC mode, no more flags are transmitted at slice or block level. Otherwise, lower level flag(s) is/are further transmitted.

In another embodiment, the on/off control is based on different regions. The purpose of the region concept is to provide a more flexible granularity for IBC on/off control.

In one embodiment, the region here may be defined as non-overlapping areas within a frame or a slice or a CTU. For all the blocks located within a specific region, a single on/off control flag may be signed to indicate whether IBC mode is turned off for all these blocks are not. The size of the regions may be predefined as a set of fixed values such as M×N, or a group of signaled values.

In some other embodiments, the on/off control of intra block copy may be based on local information, and no explicit signaling is required.

In some embodiments, the on/off control is based on the prediction information. In one embodiment, the IBC mode is always turned off for inter predicted blocks. In another embodiment, the IBC mode is always turned off for uni-predicted or/and bi-predicted inter blocks.

Yet in another embodiment, the IBC mode is always turned off for blocks which are coded at sub-block modes. The sub-block mode is the mode which divides current block into sub-blocks and each sub-block may have its own motion information. For example, affine mode, SbTMVP mode. In another embodiment, the IBC mode is always turned off for blocks which are not coded at sub-block modes.

In some other embodiments, the on/off control is based on the other coding information. In one embodiment, the IBC model is always turned off when one or more other coding mode(s) is/are applied for the current block. For example, the IBC mode is always turned off when affine mode is enabled.

In some other embodiments, the on/off control is based on the frame type. In one embodiment, the IBC mode are always turned off for B frame or/and P frame.

In some other embodiments, the on/off control is based on the block information. In one embodiment, the IBC mode is always turned off for coding blocks smaller than a specific size (e.g., 8×8 blocks) or larger than a specific size (e.g., 64×64). In one embodiment, the IBC mode is always turned off for wide blocks (e.g., a block with its width is M times longer than its height) or long blocks (e.g., a block with its height is N times longer than its width), while the value of M and N may be fixed values (e.g., M=2, N=3) or signaled at sequence or frame level.

### CABAC Context Window

In the current IBC design, there may be one or more IBC mode related flags which are CABAC context coded. For example, the IBC enabling flag at block level is context coded. Since statistics may be different with different slice or frame types, it is desirable to have a context's probability state updated at a rate that may provide more accurate probability estimation (e.g., to more accurately predict the likelihood of one bin having the value of 1 or 0) under the given slice/frame type.

In some embodiments, for each context model related to IBC mode, three windows may be predefined for three different slices, including I, B and P slices, respectively.

In some embodiments, for each context model related to IBC mode, two windows may be predefined for different slices with two different prediction modes, including intra-predicted (I slice) and inter-predicted slices (B and P slices), respectively.

Based on the multiple context windows updated under the given slice/frame type, one or more IBC mode related flags (e.g., motion precision, interpolation filter selection for motion compensated block prediction or/and template prediction, etc) may be further signaled by using different context bins.

In one example, the motion information precision flag may be signaled separately or jointly for different slice/frame type. The signaled motion precision flag may depend on the current supported precision types (e.g., 1-pel, 4-pel, or fractional-pel such as ½, or/and ¼, or/and ⅛-pel, or/and 1/16-pel) under a given slice/frame type.

In another example, the interpolation filter selection (e.g., 12-tap, 6-tap, 4-tap, 2-tap or/and 0-tap filters) may be further signaled separately or jointly for different slice/frame type.

In some embodiments, one or more IBC mode related flags (e.g., motion precision, interpolation filter selection for motion compensated block prediction or/and template prediction, etc.) may be further signaled separately or jointly for different video components type.

In one example, the motion precision flags may be supported and then signaled differently for luma and chroma components. In one embodiment, 4-pel, 1-pel, ½-pel and 1/-4 pel may be supported and signaled for luma components, while only 4-pel, 1-pel and ½-pel precision are supported for chroma components.

In another example, motion precision flags may be supported and then signaled jointly for luma and chroma components, which may indicate that a set of motion precision flags are signaled for all video components (luma and chroma components). In one example, 4-pel, 1-pel, ½-pel and 1/-4 pel may be supported and signaled for all three components. In another example, 4-pel, 1-pel, ½-pel may be supported and signaled for all three components. Yet in another example, 4-pel, 1-pel, ¼-pel may be supported and signaled for all three components, while in this case ½-pel is always converted to ¼-pel precision first before signaling.

When different motion precisions are supported and signaled for different video components, corresponding interpolation filter for each motion precision may be similarly or differently defined for different video components. For example, the 2-tap filter for luma and chroma components may be the same or different. For another example, the interpolation filter used at each motion precision may be the same or different, and the application of the interpolation filter at each motion precision and each video components may be defined separately or jointly.

In some embodiments, one or more IBC mode related flags (e.g., motion precision, interpolation filter selection for motion compensated block prediction or/and template prediction, etc.) may be further signaled separately or jointly by considering different slice/frame type, different video components, and/or different video resolutions.

When multiple windows are defined for different slices or frames, the context window sizes and initialization parameters may also be retrained separately or jointly.

### Interpolation Based Fractional Intra Block Copy

### Fractional Motion Search

In one embodiment, the fractional motion search may be performed at encoder side, and the final motion may be signaled to the decoder side. The signaled motion may be in the format of motion difference after subtracting the motion predictors which are already known to both the encoder and the decoder. The motion search may be performed in three steps:
In step 1, the best N integer motion vectors with minimum distortion cost (e.g., Sum of Absolute Difference (SAD)) may be searched first.
In step 2, half-pel refinement is applied around each of the N integer motion vectors. In this step 2, there may be M best half-pel positions (the best M positions may indicate M half-pel motion differences which have the lowest rate distortion cost) that can be obtained. For example, the encoder or decoder may obtain M best half-pel positions having the lowest rate distortion cost. If K of the N integer motion vectors are selected, the output may be K*M half-pel positions in total.
In step 3, quarter-pel refinement is applied around the best half-pel position of each N integer motion vectors. In this step 3, a set of Q quarter-pel positions may be obtained for each of the K*M half-pel positions obtained in step 2. And the best R quarter-pel positions of all K*M*Q candidate positions may be generated. The best (e.g., the position with minimum rate-distortion) of the R positions may be determined by full rate-distortion calculations and signaled to the decoder. For example, the encoder may generate the best R quarter-pel positions and then select the best one with the minimum rate-distortion of the R positions and signal the best one of the R positions to the decoder. The values of N, M, K, Q, and R are position integer numbers.

After the three-steps, the best refined motion vectors (after half-pel or/and quarter-pel refinement) is signaled (e.g., in the format of motion vector differences). In this disclosure, motion vector is used to be interchangeable with block vector that identifies a reference/prediction block in the same picture/frame in this section and following sections.

In some examples, if the actual highest precision after quarter-pel refinement is only at half-pel (e.g., the highest precision bit or the last bit of the quarter-pel motion vector is zero), the signaling of these refined motion vectors may be performed in two different methods.

In one method, the refined motion vectors are still signaled at quarter-pel or ¼-pel. In this case, half-pel or/½-pel precision is never signaled.

In another method, the refined motion vectors are signaled at actual precision, which is only half-pel or ½-pel. In this case, signaling of half-pel or/½-pel precision is supported.

In another embodiment, the fractional motion search can be performed at both encoder and decoder side, such that the final fractional motion does not need to be signaled. In this method, template matching based method may be used to find the best fractional motion.

In one or more embodiments, an inverse-L shape sample/pixel area adjacent to the coding block may be used as the matching template, the pixel/sample width may be prefixed, or configurable or signaled at sequence or/and picture, or/and slice, or/and CTU level.

Within a constrained search area (defined by a prefixed, or configurable or signaled number of CTUs, or CTU lines, or samples from above, left, or/and above-left spatial areas), the template similarity between any adjacent/non-adjacent reference blocks and the current coding block are calculated, and the best N reference blocks with closest similarity are selected as the candidates in a template list.

An extra flag indicates whether to use the template matching method is signaled. If the flag is true, another index value indicates which candidate in the template list is used shall be further signaled.

In another embodiment, both encoder search method and the template matching method are jointly used. For example, integer motion and fractional refinement method are first employed at the encoder, and then another template refinement are further applied at both the encoder and the decoder side. Since the encoder search method is already accurate enough, the template refinement may be performed at a higher precision and in a small area. For example, encode side motion refinement is performed up to half-pel or quarter-pel precision, while the template refinement may be further performed at quarter-pel or eighth-pel sixteenth-pel.

In order to constrain the complexity during the fractional motion search, several methods may be provided as below.

The best SAD (sum of absolute differences) or SATD (sum of absolute transformed differences) cost of using other coding modes (e.g., other intra coding modes such as angular modes, planar mode) for the current coding block is used as a threshold for early termination of the current fractional motion search. In one example, given that the current best SAD or SATD cost from other coding modes is X, a predefined threshold factor is f (e.g., an example value could be 1.1, 1.2, 1.21, etc.), and the best SAD or SATD cost from current integer motion search of IBC mode is Y, if Y>=f*X, the subsequent fractional motion search may be simplified (e.g., the N best integer motion vectors for further fractional refinement may be reduced to N′, and N′<N) or skipped (e.g., the N best integer motion vectors for further fractional refinement may be reduced to 0). Note that the value of N,N′ and f, may be predefined or signaled or adaptively determined (e.g., based on the texture richness of the current coding block).

The fractional search may be simplified or skipped based on the combination of the other coding modes. For example, if the current coding block is enabled for IBC-CIIP or/and IBC-LIC, the fractional search for IBC may be simplified (e.g., the N best integer motion vectors for further fractional refinement may be reduced to N′, and N′<N) or skipped (e.g., the N best integer motion vectors for further fractional refinement may be reduced to 0). No that the value of N,N′ and f, may be predefined or signaled or adaptively determined (e.g., based on the texture richness of the current coding block).

When the fractional search is simplified, several different simplification methods may be provided as below.

In one example, the N best integer motion vectors selected for further fractional refinement may be reduced to N′, where N′<N.

The N best integer motion vectors selected for further fractional refinement may not be from only the current integer search process, but also come from the previous integer or/and fractional search process (history search process) of the same current coding block or different coding blocks. For example, for the current block, the encoder side may perform several rounds of motion search process, where different modes (e.g., IBC-CIIP, IBC-LIC) may be enabled or disabled for the current block at each round. The later rounds of motion search process may be based on the best output of the previously performed/early rounds of motion search process. For example, when IBC-CIIP or/and IBC-LIC is/are enabled for the current motion search process, the best outputs (e.g., the best M integer/fractional motion vectors, M>=1) of the previous rounds of motion search process, where IBC-CIIP or/and IBC-LIC is/are disabled, may be put into the candidate list and further refined by the current integer/fractional search process.

### Fractional Motion Refinement

With or without fractional motion search process, a start motion vector (MV) may be identified. The start Mv may be adjusted from two reasons:
For smaller signaling overhead, the start Mv may be rounded to a specific precision or value so that the mv difference between the start Mv and a selected mv predictor is minimized.
For smaller signaling overhead, a few least important bits of the start MV may be discarded.

With or without the aforementioned adjustment, the start Mv may need to be refined at the decoder side.

In one or more embodiments, a template matching based on method may be used. In one example, an inverse-L shape sample/pixel area adjacent to the coding block may be used as the matching template. The start Mv may be refined at integer-pel or/and fractional-pel level. The potential refinement set may be {¼-pel, 2/4-pel, ¾-pel} or/and {⅛-pel, ⅜-pel, ⅝-pel, ⅞-pel}, and the refinement directions are two horizontal and two vertical directions (positive and negative values). The refined Mv that generated a prediction block with most similar template is selected as the final Mv. Note that the selected refinement may be implicitly derived by the decoder if the most similar template is selected, or may be explicitly derived by the encoder if multiple refinement Mvs which have N most similar templates are derived.

In one or more embodiments, an extra flag may be signaled to indicate whether this fractional motion refinement is applied or not. The extra flag may be transmitted at sequence, picture, slice or CTU level.

### Conditional Sample/Pixel Padding for Fractional Interpolation

When fractional based Mv is used, interpolation operation may require a larger number of pixels/samples than the current block. The actual number difference depends on the interpolation filter tap length. In case some pixels/samples are not available, a pixel/sample padding process may be needed. Different padding schemes may be used.

In one or more embodiments, one type of repeating padding may be used. The unavailable pixel/sample position may be padded with the same value of the nearest pixels/sample which are available on the same row or column. This repeating padding may be performed at horizontal direction first (left and right boundary padding), and then followed by vertical direction (top and bottom boundary padding). Alternatively, this repeating padding may be performed at vertical direction (top and bottom boundary padding) first, and then followed by horizontal direction (left and right boundary padding).

In one or more embodiments, one type of symmetric padding may be used. The unavailable pixel/sample position may be padded with the pixel at a position symmetric to the padding boundary. This padding may be performed at horizontal direction first (left or right boundary padding), and then followed by vertical direction (top or bottom boundary padding). Alternatively, this repeating padding may be performed at vertical direction (top or bottom boundary padding) first, and then followed by horizontal direction (left or right boundary padding).

In one or more embodiments, the padding process may be conditionally skipped or simplified.

In one embodiment, depending on the value of the fractional part of the motion vector, the padding process may be partially skipped or fully skipped. In one example, if the horizontal or vertical part of the motion vector is equal to zero, the corresponding vertical or horizontal padding may be or may not be skipped. In case both directions of the motion vector are equal to zero, the whole padding process may be fully skipped or may be still performed.

In another embodiment, even if the horizontal or/and vertical part of the motion vector is not equal to zero, the corresponding padding process at horizontal or/and vertical direction may be still skipped in order to reduce computation or/and bandwidth access cost. One example in this case is that the number of unavailable samples needed for interpolation process is less than a threshold value N, N may be predefined value such as 1, or signaled. For example, given a 12-tap interpolation filter, the number of the top and left samples needed for interpolation is 5, while the number of the bottom and right samples needed for interpolation is 6. If the number of unavailable samples needed for interpolation process at horizontal direction (left and right side) or vertical direction (top and bottom side) is less than 2, then the padding process at one direction may be skipped.

In another embodiment, if all the required samples involved in an interpolation process related to a specific motion vector are checked to be valid (e.g., all samples involved in an interpolation process are located inside of the valid reference area, as shown in FIGS. 8, 10, 11), the whole padding process may be fully skipped or may be still performed.

In another embodiment, as for an interpolation process, the number of the required left or the top samples located outside of the reference block pointed by an integer MV or the integer part of the MV is 1 less than the number of the required right or the bottom samples, the padding size for the left and top samples may be reduced by 1. For example, if a 12-tap interpolation filter is used for an IBC coding block with non-zero fractional parts for both horizontal and vertical direction of the motion vector, the padding size for top and left samples are both 5, while the padding size for bottom and right samples are both 6.

In another embodiment, under certain circumstances, the interpolation process is only for motion search (e.g., encoder fractional motion estimation) or motion reordering (e.g., ARMC), motion refinement (e.g., IBC-DBV, IBC template matching), parameter generation for prediction refinement (e.g., template prediction generation for IBC-LIC parameter derivation), but not for final prediction generation of the current coding block, the padding process may be skipped, for example, by forcefully setting the fractional part as zero.

### Interpolation Filter Switch

For different reasons, the interpolation filter may need to be switched. For example, longer tap length of filter may be preferred if the image/video content has rich noises and a smoothing filter effect is desired. While a shorter tap length of filter may be preferred if padding complexity needs to be reduced or the image/video content has rich texture edges.

In one or more embodiments, the filter switch may be decided at the decoder side by analyzing the image/video content (such as histogram of gradients), which requires no signaling bits.

In one or more other embodiments, the filter switch may be evaluated at the encoder side and signaled at different granularities (sequence, picture, slice, CTU level, or region based).

In one or more other embodiments, the filter switch may be evaluated at the encoder side and signaled for different frame/slice types (e.g., I, B and P slices).

In one or more other embodiments, the filter switch may be evaluated at the encoder side and signaled for different video components (e.g., luma and Chroma components, or Y, Cb, and Cr components).

In one or more other embodiments, the filter switch may be evaluated at the encoder side and signaled for motion precisions (e.g., 1-pel, 4-pel, or fractional-pel such as ½, or/and ¼, or/and ⅛-pel, or/and 1/16-pel).

In one or more other embodiments, the filter switch may be evaluated at the encoder side and signaled for different interpolation scenarios (e.g., regular compensated prediction for current block, or compensated prediction for the templates, such as the top or/and left templates, of the current block).

In another embodiment, the filter switch provided above at any combination of above specified scenarios may be predefined and no signaling is needed. For example, 2-tap interpolation filter may be always used if three conditions are satisfied: chroma components, template prediction generation and natural content.

Another example for predefined filter switch without signaling is dependent on the block size:

In one embodiment, for small blocks, shorter interpolation filter length or even no interpolation is applied. In case where luma and chroma components have different ratio, such as YUV420 video format, the sizes of small blocks may be defined different for different components. For example, for chroma blocks with size 2×2, or/and 2×4, or/and 4×2, shorter interpolation filter such as 2-tap filtering process, or even no interpolation is performed. In the case no interpolation process is performed, the non-zero fractional parts of the chroma motion vectors may be clipped or rounded to an integer value. For luma blocks with 4×4, or/and 4×8, or/and 8×4, shorter interpolation filter such as 4-tap or 2-tap filtering process, or even no interpolation is performed. In the case no interpolation process is performed, the non-zero fractional parts of the luma motion vectors may be clipped or rounded to an integer value.

In another embodiment, the filter switch provided above may be dependent on other flags and no signaling is needed as well. For example, if a video block is flagged to be coded at a specific mode (intra TMP mode), or coded at a specific motion precision, the filter switch may be determined accordingly.

In one embodiment, the filter switch is predefined according to a specific mode. For example, when ARMC, IBC template matching mode, IBC-BVDP and IBC-BVPC modes are used, the reference template generation for template matching cost calculation may use an interpolation filter with smaller length (e.g., 2-tap, 4-tap, 6-tap) than the default filter (e.g., default 12-tap or 8-tap filter for luma, while default 6-tap filter for chroma). While for IBC-LIC and processing an IBC chroma sample, the default luma (e.g., 12-tap filter) or/and chroma interpolation filter (e.g., 6-tap filter) may be used, respectively. In another example, for template matching related tools such as ARMC, IBC template matching mode, IBC-BVDP and IBC-BVPC modes, the reference template may be generated by ignoring the fractional parts (e.g., clipped or round to an integer value) and the interpolation process and padding process may be fully skipped.

The above provided filter switch methods may be applied in any combination.

### Multi-Hypotheses Fractional Intra Block Copy

When multiple motion vectors (either from motion search or/and motion refinement) are available, multiple prediction blocks may be generated. In case that the average of multiple similar blocks can generate a better block prediction, multi-hypothesis intra block copy may be used.

In one or more embodiments, the number of multi-hypotheses may be predefined, configured or signaled. In addition, the weight to average the multiple predicted hypothesis may be also predefined, configured or signaled.

In one example, the number of multi-hypothesis may be equal to 2. In this case, the currently uni-predicted IBC mode may be extended to bi-predicted IBC mode. The weights used for combining the two predictions may be inherited from spatial neighbor neighbors, signaled, or derived at the encoder and decoder side without signaling, or reuse the same weights used for inter-predicted blocks, or adaptively selected from a predefined weight set at the encoder side and signaled to the decoder side.

In one or more other embodiments, the number of multi-hypotheses may be implicitly determined at the decoder side. For example, if N prediction blocks may be generated, and the signaled value is N, which out of the range of a valid single prediction block (0 through N−1), it indicates that multi-hypothesis is enabled, and the average of all N prediction blocks may be used.

The multiple hypothesis may be generated from N motion/block vectors, where each motion/block vector may generate one specific motion compensated prediction block, where N is a positive integer number. The N motion motion/block vectors may be obtained from the same candidate list or different candidate lists. In one example, the N motion/block vectors may be obtained from the same IBC merge candidate list or AMVP list, or partially obtained from the IBC merge candidate list and partially from IBC AMVP candidate list. In another example, the N motion/block vectors may be all or partially obtained from the intra template matching method.

### Interpolation Process for Template Matching

In case template based adaptive reordering (ARMC-TM) is applied to IBC merge or/and AMVP mode, or/and template matching based motion refinement is applied to IBC merge or/and AMVP mode, the fractional motion/block vector may need to be adaptively used.

For template based adaptive reordering (ARMC-TM), template-based distortion cost may need to be calculated for each motion/block vector candidate. As this template-based distortion cost is for candidate reordering only, not for the final compensated prediction, the fractional part of each motion/block vector candidate, if there are non-zero fractional parts, may need or not need to be considered for the template-based distortion calculation. Specifically, in one or more examples, a fractional motion-based interpolation process may be or may not be performed for each motion/block vector candidate without non-zero fractional part.

Similarly, when the template distortion cost is calculated for each motion refinement position, the fractional part of each position may need or not need to be considered.

### Signaling of Motion Information

When multiple precisions are supported for the motion vectors in intra block copy, the allowable signaling methods may be defined accordingly.

In one or more embodiments, only one precision is allowed to have zero motion vector difference. This one precision may be predefined, or configurable or signaled. For example, this precision may be predefined as the highest precision supported by the motion vector, such as ¼-pel or ⅛-pel.

In one or more embodiments, multiple precisions are allowed to have zero motion vector difference. These multiple precisions may be predefined, or configurable or signaled. For example, this precision may be predefined as the highest precision or the second-highest precision supported by the motion vector, such as ¼-pel and 1-pel. In case multiple precisions are allowed to have zero motion vector difference, after the signaled indication (1 flag or 1 bit bin) of zero motion vector difference, another one or more flags are additionally transmitted to indicate which precision is used.

In case multiple precisions are supported, the current precision flag may be signed in different ways. In one example, the flag indicating whether the current precision is greater than 0 is signaled first. If yes, then another flag indicating whether the current precision is greater than 1 is further signaled. Alternatively, the second flag indicating whether the current precision is greater than 1 may be implicitly derived at the decoder without explicit signaling. In one example, the values of the motion/block vector difference may be used to achieve this purpose (e.g., even or odd motion/block vector difference may indicate a specific motion precision value). Herein the values of 0, 1 or other values greater than 1 may be predefined or configured for representing different motion vector (or motion vector difference) precisions (e.g., 0 represents 1-pel precision, 1 represents ½-pel precision, 2 represents ¼-pel precision, 3 represents ⅛-pel precision).

In one or more embodiments, multiple MV candidates in the IBC merge/AMVP motion candidate list are separated into different groups. In one example, the group criteria may be the MV precision, where the MV candidates in the same group have the same actual MV precision. The actual MV precision is defined as the MV precision after right shifting all least important zero bits of a Mv.

### IBC Merge/AMVP Motion Candidate List Construction

In one or more embodiments, multiple MV candidates in the IBC merge/AMVP motion candidate list are separated into different groups. In one example, the group criteria may be the Mv precision, where the Mv candidates in the same group have the same actual MV precision. The actual MV precision is defined as the Mv precision after right shifting all least important zero bits of an MV.

In one or more other embodiments, multiple IBC merge/AMVP motion candidate lists other than the exiting lists are created. For each list, only the Mv candidate with the same actual Mv precision are added. Similarly, the actual Mv precision is defined as the Mv precision after right shifting all least important zero bits of a Mv.

In case multiple groups of candidate lists or/and multiple candidate lists are generated, the group index or/and candidate list index needs to be determined first before the actual Mv candidate index can be decided. In one or more other examples, the group index or/and candidate list index may be evaluated at the encoder side and then signaled to the decoder. In other one or more other examples, the group index or/and candidate list index may be inherited from a specific neighbor block, without explicit signaling.

Combination with Intra Template Matching

When a motion vector is determined for an intra block copy, a prediction block may be generated based on this motion vector. When combined with intra template matching, the prediction block generated by the intra block copy is further refined by the intra template matching. Specifically, for a predefined search range around the generated prediction block by the intra block copy, the encoder searches for the most similar template to the current template in a reconstructed part of the current frame and uses the corresponding block as a prediction block. In this method, the prediction block generated by intra block copy is considered as a starting block position, which is used to guide the subsequent block search process in intra template matching method.

The combination of intra block copy and intra template matching prediction mode may be signaled at CU level through a dedicated flag. Alternatively, the original intra block copy flag on top of the original intra template matching mode flag may be used to indicate the combination of intra block copy and intra template matching prediction mode. Alternatively, the original intra template matching mode flag on top of the original intra block copy mode flag may be used to indicate the combination of intra block copy and intra template matching prediction mode.

In one or more other examples, the combination of intra block copy and intra template matching prediction may generate an improved motion vector.

In one example, the intra block copy (IBC) mode provides an initial motion vector, where this initial motion vector may be further refined by the intra template matching method.

In another example, the motion/block vector obtained from the intra template matching method may be reused to generate IBC merge candidate list or IBC AMVP candidate list. In this case, the motion/block vector generated for the spatial adjacent or non-adjacent neighboring blocks may be cached or saved. In one example, the motion/block vector for neighboring blocks which are coded in intra template matching method may be saved in a history motion vector table. In addition, or alternatively, the motion/block vector for neighboring blocks which are coded in intra template matching method may be saved in a local cache of the encoder, and then reused by the encoder during the motion search process.

In other examples, the combination of intra block copy and intra template matching prediction may generate an improved prediction block. In one example, two prediction blocks may be separately generated by the intra block copy and intra template matching prediction methods, and a weighted average of these two prediction blocks may be generated to represent the final prediction block of the current coding block. In another example, multiple prediction blocks (e.g., N>1) may be separately generated, wherein M (e.g., M is smaller or equal to N) of the N prediction blocks may be generated by the intra block copy, and S (e.g., S is smaller or equal to N) of the N prediction blocks may be generated by intra template matching prediction. When combining the N prediction blocks (e.g., N>1), the values of the weight may be derived by using the matching cost values (e.g., one example of matching cost calculation may be based on the L-shape template, and a higher matching cost value may indicate a lower weight value, while a lower matching cost value may indicate a higher weight value) or least square flavor methods.

In another example, more than two prediction blocks may be separately generated by the intra block copy and intra template matching prediction methods. In this case, a multi-hypothesis based prediction mode may be defined. Note that the multiple hypothesis (e.g., multiple prediction blocks) may be from only IBC mode or IntraTMP mode, or may be from both IBC mode and IntraTMP mode.

In the case of multi-hypothesis mode, the IBC encoder may generate multiple prediction blocks based on searching multiple block vectors. For IBC-AMVP mode, the corresponding multiple block vectors may be signaled to the decoder side by a combination of block vector predictor indexes and block vector differences. For IBC-merge mode, the corresponding multiple block vectors may be signaled to the decoder side by a group of candidate indexes from a constructed merge candidate list.

In another example, the intraTMP mode may be unified with or replaced by the IBC mode.

In one embodiment, the existing IBC-TM mode may be extended by reusing the similar searching pattern and searching area in the intraTMP mode, as shown in the FIG. 16.

In another embodiment, a zero block vector, which has both zero horizontal component and zero vertical component, may be added to the IBC-AMVP and IBC-merge list. In this case, when the zero block vector is selected from IBC-AMVP and IBC-merge list, it indicates that the same or similar searching pattern and searching area as used in intraTMP mode may be used in the IBC mode with template matching.

Combination with IBC Merge Mode with Block Vector Differences

With the support of fractional Mv, IBC merge mode with block vector differences may be extended by adopting more candidate distance values. In one or more other embodiments, there may be two distance sets. The first set is the exiting integer distance set, while the second set is additionally added for fractional distance. In one example, the fractional distance set may be {⅛-pel, 2/8-pel, ⅜-pel, 4/8-pel, ⅝-pel, 6/8-pel, ⅞-pel}. In anther example, the fractional distance set may be {⅛-pel, 2/8-pel, 4/8-pel}. The BVD directions for the second sets are also two horizontal and two vertical directions.

In another example, the new distance set may be defined as {¼-pel, ½-pel, 1-pel, 2-pel, 3-pel, 4-pel, 6-pel, 8-pel, 10-pel, 12-pel, 14-pel, 16-pel, 18-pel, 20-pel, 22-pel, 24-pel, 26-pel, 28-pel, 30-pel, 32-pel}.

In another example, the new distance set may be defined as {½-pel, 1-pel, 2-pel, 3-pel, 4-pel, 6-pel, 8-pel, 10-pel, 12-pel, 16-pel, 20-pel, 24-pel, 28-pel, 32-pel, 36-pel, 40-pel, 44-pel, 48-pel, 52-pel, 56-pel}.

In another example, the new distance set may be defined as {½-pel, 1-pel, 2-pel, 3-pel, 4-pel, 6-pel, 8-pel, 10-pel, 12-pel, 14-pel, 16-pel, 18-pel, 20-pel, 22-pel, 24-pel, 26-pel, 28-pel, 30-pel, 32-pel, 34-pel}.

In another example, the new distance set may be defined as {1-pel, 2-pel, 4-pel, 6-pel, 8-pel, 12-pel, 16-pel, 20-pel, 24-pel, 32-pel, 40-pel, 48-pel, 56-pel, 64-pel, 72-pel, 80-pel, 88-pel, 96-pel, 104-pel, 112-pel}.

The above proposed distance sets may be selected by predefined rules or adaptively determined:

In one embodiment, only one of the above sets are used.

In another embodiment, multiple sets may be used, and signaling based selection is used to switch between different sets.

In another embodiment, multiple sets may be used, and condition based selection (e.g., sequence, picture, slice, CTU or coding block level signaling), without signaling, is used to switch between different sets.

In one example, when one or other coding modes (e.g., RRIBC mode, Palette mode) is/are allowed at certain levels (e.g., sequence, picture, slice), one distance set may be selected, while when one or other coding modes is/are not allowed at certain levels, another distance set may be selected.

The base candidates for IBC-MBVD (IBC merge mode with block vector differences) may be extended in below methods:

In one embodiment, the base candidates may be selected from the IBC merge list or/and IBC-TM merge list. Note that the candidates in the IBC-TM merge list may be constructed by refining the candidates in the IBC merge list with the template matching method prior to the encoding process and the decoding process.

In the case that the base candidates of IBC-MBVD may be selected from both IBC merge list and IBC-TM merge list, the selection criteria may be defined in different ways.

In one method, the template matching based reordering process may be applied separately on the IBC merge list and IBC-TM merge list, and the best N candidates from each list may be combined to generate a new list with the size of 2N for final candidate selection, where the value of N may be predefined as a constant value or signaled from encoder to the decoder. A pruning process may be applied to the new list in order to remove redundant candidates or similar candidates with a similarity threshold value, where the value of similarity threshold may be predefined as a constant value or signaled from encoder to the decoder or derived at the decoder side (e.g., the width and height of the current coding unit).

In another method, a new list may be first generated by combining the candidates from the IBC merge list and IBC-TM merge list, and the template matching based reordering process may be applied afterwards. A similar pruning process may be applied to the generation of the new list as well.

In the case that the base candidates of IBC-MBVD may be selected from only IBC merge list or IBC-TM merge list, a switch method may be applied. In one embodiment, the existing IBC-TM flag may be used to indicate whether the base candidate of IBC-MBVD is from the IBC-TM merge list or not. In another embodiment, an extra flag may be signaled to indicate whether IBC-TM merge list is used for IBC-MBVD base candidate selection.

When fractional block vectors are supported, the candidates in the IBC merge list or/and IBC-TM merge list may be at the fractional or integer precisions. In this case, the base candidates of the IBC-MBVD may be selected from the IBC merge list or/and IBC-TM merge list with or without candidate adjustments/modifications. In one embodiment, this adjustment/modification may be based on one type of clipping operation (e.g., directly discard the fractional parts of the fractional motion vector) or rounding operation (e.g., rounded to the nearest integer value). If the adjustments/modifications are applied, it may indicate that the selected base candidates for IBC-MBVD are always at the integer-pel precisions.

In one embodiment, IBC-MBVD may be combined with the Intra template matching prediction (Intra TMP) mode. In the IntraTMP mode, one or multiple block vectors may be derived when searching the most similar template to the current template at the encoder and the decoder side. The one or more block vectors may be further refined by applying IBC-MBVD like block vector differences. In this case, the above proposed IBC-MBVD extension methods may be similarly applied to the IntraTMP mode as well.

Combination of IBC-LIC and IBC with Fractional Motion Vectors

In IBC-LIC, after the prediction block is generated from the reference block by using either integer copy (by using integer motion vector or integer part of the fractional motion vector) or interpolated filtering (by using the fractional motion vector), a linear filtering process is further applied to refine the prediction block. Note that the parameters of the linear filtering process are derived by using the reference template generated by the same motion vector for generating the prediction block of the current block. When an IBC block coded with a fractional motion vector is combined with IBC-LIC mode, the reference template for LIC parameters derivation may be generated in different ways:

In one example, the reference template used for IBC-LIC parameter derivation is generated by using an integer motion vector modified from the fractional motion vector used in the current IBC block. This modification may be based on clipping operation (e.g., directly discard the fractional parts of the fractional motion vector) or rounding operation (e.g., rounded to the nearest integer value).

In another example, the reference template used for IBC-LIC parameter derivation is generated by using the same fractional motion vector used in the current IBC block, however the interpolation filter used for generating the reference template may be the same as or different from the interpolation filter used for prediction block generation of the current block. For example, given an ¼-pel motion vector for the current block, a 12-tap filter may be used for prediction generation, but when reference template is generated for IBC-LIC, the same 12-tap filter or a different filter (e.g., 4-tap or 2-tap filter or 0-tap filter) may be used. Note that, a shorter tap filter may lead to less computations and/or less padding operations if some samples are out of the valid IBC reference area. If a different filter is used for reference template generation, this filter may be predefined or signaled at different levels (sequence, picture, slice, CTU level, or region based).

Combination of DBV and IBC with Fractional or Integer Motion Vectors

When DBV mode is used for an IBC coded block with integer or fractional motion vectors, several methods are proposed to improve the DBV mode:

In the current DBV mode, the luma motion vector is selected from one collocated luma block of the five locations according to a fixed-order of checking process (e.g., center block, top-left block, top-right block, bottom-left block and bottom-right block). It is proposed to improve the luma block selection by encoder signaled or decoder determined methods. In the decoder determined method, one example is to use L-shape chroma template match cost to order the N (N<=5) luma block vectors. Another example is based on the block content analysis (e.g., gradient based edge detection, and choose the luma block on the same edge first).

In the current DBV mode, template based MV refinement is performed. However, the current refinement allows only positive refinement (e.g., +1 or +2 on top of the current mv components). It is proposed to allow negative refinements (e.g., −1 or −2) as well. When the fractional motion vector is supported in the selected luma block, it is proposed to allow fractional refinements (e.g., ½-pel, ¼-pel, −½-pel, ¾-pel refinements) for the current motion vector.

In the current DBV mode, the template based MV refinement is performed for Cb and Cr components separately. If the MV after refinement is different for Cb and Cr, potential artifacts (e.g., Chroma components mis-alignment) may be observed in the predicted samples. It is proposed to improve the mv refinement in different ways:

In one embodiment, MV refinement is only allowed to one chroma component (Cb or Cr), and the refinement MV is reused on the prediction for the other component (Cr or Cb).

In another embodiment, MV refinement is performed for Cb and Cr jointly. In this method, the reference template cost is calculated by combining the match error for both Cb and Cr templates.

When the selected luma motion vector is used to generate the chroma motion vector, different methods may be proposed:

In one embodiment, the fractional part of the luma motion vector, if available, may be clipped or round to an integer value. In this way, the subsequent prediction generation and mv refinement are both performed with integer motion vector, and no interpolation process and padding process are needed.

In another embodiment, the fractional parts of the luma vector, if available, may be kept for deriving the chroma motion vector, and interpolation process is needed for chroma prediction generation, but the fractional parts of the Chroma motion vector may be only clipped or round to an integer value during the template based MV refinement process. After refinement, the fractional parts are added back to the refined chroma motion vector. In this case, no interpolation process and padding process are needed for template based MV refinement process, but are still needed for chroma prediction generation.

In another embodiment, the fractional parts of the luma vector may be considered for both the prediction generation and mv refinement.

When fractional parts are available for the derived chroma motion vector, interpolation filtering may be needed for prediction generation process or/and mv refinement process. Different or the same interpolation filter may be applied for the two processes. In one example, a default interpolation filter, such as the default 6-tap chroma filter, may be applied for both processes. Alternatively, a shorter filter, such as 2-tap or 4-tap filter may be applied for the chroma prediction generation process or/and mv refinement process.

Given a specific interpolation filter, the computation complexity and bandwidth consumption are more expensive for smaller block size. For certain video formats such as YUV420, the minimum size of the chroma block (e.g., 2×2 block) may be smaller than the minimum size of the collocated luma block (e.g., 4×4 block), therefore chroma worst case complexity (e.g., here the worst case indicates the complexity for the interpolation process performed on a coding block with minimum size) is higher than the worst case complexity of the luma component. It may be desirable to constrain the worst case interpolation complexity for chroma components. Under this consideration, interpolation filter process may be desirable to be fully avoided (e.g., no fractional parts or ignore the fractional parts of the chroma motion vector) or simplified by using a shorter-tap filter (e.g., 2-tap filter). Alternatively, a block size dependent filter switch may be proposed. In one example, for chroma blocks with smaller block sizes (e.g., 2×2, 2×4, 4×2, etc.), the fractional part of the luma motion vector, if available, may be clipped or round to an integer value. In another example, for chroma blocks with smaller block sizes (e.g., 2×2, 2×4, 4×2, etc.), an interpolation filter with shorter number of taps (e.g., 2-tap filter, 4-tap filter) than the default Chroma interpolation filter may be used. The selected filter may be predefined or explicitly (e.g., a dedicated flag to indicate a specific filter index) or implicitly (e.g., dependent on other existing flags such as another coding mode) signaled at different granularities (e.g., sequence, picture, slice, CTU level, or region based).

Combination of RRIBC and IBC with Fractional Motion Vectors

When RRIBC is applied to an IBC coded block, the motion vector of this block may indicate one of the three flip types: no flip, horizontal flip and vertical flip. For the horizontal flip or the vertical flip type, the vertical component or the horizontal component of the IBC motion vector is set to zero.

When RRIBC mode is combined with regular IBC AMVP mode, the encoder side fractional motion estimation or/and the decoder side motion refinement may be allowed or not allowed for a motion vector indicating horizontal flip or vertical flip.

When fractional motion vector is not allowed for the two RRIBC flip modes (the horizontal flip and the vertical flip type), the motion precision is limited to an integer pel (e.g., 1-pel or 4-pel). As a result, for IBC AMVP mode, the motion precision signaling is limited to an integer pel as well. In addition, when zero mvd is determined at the decoder side, the corresponding motion precision may be directly derived (e.g., the highest supported integer-pel such as 1-pel) instead of further signaling.

Combination of IBC-BVPC and IBC with Fractional Motion Vectors

When IBC-BVPC applied to an IBC coded block, the motion vector of this block may have both non-null components or one non-null component (e.g., only horizontal or vertical component is non-zero).

When IBC-BVPC mode is combined with regular IBC AMVP mode, the encoder side fractional motion estimation or/and the decoder side motion refinement may be allowed or not allowed for a motion vector with only one non-null component (e.g., only horizontal or vertical component is non-zero).

When fractional motion vector is not allowed for the IBC-BVPC mode with only one non-null component, the motion precision is limited to an integer pel (e.g., 1-pel or 4-pel). As a result, for IBC AMVP mode, the motion precision signaling is limited to an integer pel as well. In addition, when zero MVD is determined at the decoder side, the corresponding motion precision may be directly derived (e.g., the highest supported integer-pel such as 1-pel) instead of further signaling.

Combination of IBC-BVDP and IBC with Fractional Motion Vectors

When IBC-BVDP mode is applied to an IBC block with fractional motion vectors, the most significant bins of magnitude suffixes of BVD horizontal and vertical components may be predicted in different ways:

If the fractional parts of the MVD before the prediction are non-zero (e.g., the horizontal or/and vertical components has/have non-zero fractional parts), the most significant bins of magnitude suffixes selected for prediction may include or exclude the fractional bins.

In one embodiment, when fractional bins are included for prediction, the generated potential motion vectors are sorted together without grouping. For example, if total 4 bins are predicted, while 2 bins are from the integer parts of the MVD, and the other 2 bins are from the fractional parts of the MVD, the total number of the potential motion vectors have a size at 16 before considering the sign prediction. When sorted together, the 16 vectors are compared together with the corresponding template matching cost.

In another embodiment, when fractional bins are included for prediction, the generated potential motion vectors are sorted separately with grouping. For example, if total 4 bins are predicted, while 2 bins are from the integer parts of the MVD, and the other 2 bins are from the fractional parts of the MVD, the total number of the potential motion vectors have a size at 16 before considering the sign prediction. When sorted separately, the prediction of fractional bins is performed separately from the prediction of the integer bins, by fixing one combination of the two integer bins then predicting the two fractional bins, or by fixing one combination of the fractional bins then predicting the two integer bins.

In another embodiment, when fractional bins are excluded for prediction, the fractional bins are always signaled as the current by-pass mode at the entropy coding stage. Once fractional bins are signaled, the remaining integer bins may be predicted as the original IBC-BVDP mode. In this case, the template matching cost calculation may further consider the by-pass signaled fractional bins or not.

In one embodiment, the fractional bins are considered for integer bin prediction such that the reference template is generated by interpolation filtering. The interpolation filter used in the reference template generation may be predefined (e.g., always 2-tap filter) or switched at different granularities (e.g., sequence, picture, slice, CTU level, or region based).

In another embodiment, the fractional bins are not considered for integer bin prediction such that the reference template is generated without interpolation filtering (e.g., based on clipping operation (e.g., directly discard the fractional parts of the fractional motion vector) or rounding operation (e.g., rounded to the nearest integer value)).

### Combination of Pairwise Candidates and Other IBC Coding Modes

In the current IBC mode, a new pairwise IBC candidate can be generated by averaging two previous IBC candidates in the IBC merge/AMVP list.

When the pairwise candidate is generated by averaging two fractional motion candidates, this new candidate may have a higher precision than the currently supported highest precision. For example, when one ½-pel mv and one ¼-pel mv are averaged, the new candidate may be at ⅛-pel precision.

In one embodiment, this new pairwise candidate may be rounded to or clipped at one supported motion precision. For example, a new ⅛-pel pairwise candidate may be clipped at ¼-pel (directly discard the fractional parts higher than ¼-pel) or rounded to ¼-pel.

In another embodiment, this new pairwise candidate may be kept at the current high precision. For IBC-AMVP list, the subsequent rounding procedure will be performed at the encoder side. For IBC-merge list, the current precision will be always kept.

When the pairwise candidate is generated by averaging two prevision candidates, these two candidates may indicate the same or different RRIBC flip mode. For example, one candidate indicates horizontal flip, while the other candidate indicates no flip.

In one embodiment, if the two candidates have the same RRIBC flip mode (e.g., non-flip mode, horizontal flip mode, vertical flip mode), the new pairwise candidate may be set to have the same RRIBC flip mode. Otherwise, the new pairwise candidate may be set to has non-flip mode.

In another embodiment, no matter the two candidates have the same or different RRIBC flip modes, the new pairwise candidate may always be set to has non-flip mode.

When the pairwise candidate is generated by averaging two prevision candidates, these two candidates may indicate the same or different IBC-LIC flag.

In one embodiment, if the two candidates have the same IBC-LIC flag (e.g., both IBC-LIC on or off), the new pairwise candidate may be set to have the same IBC-LIC flag. Otherwise, the new pairwise candidate may be set to has IBC-LIC off.

In another embodiment, if one of the two candidates has the IBC-LIC on, the new pairwise candidate may always be set to has IBC-LIC on.

In another embodiment, no matter the two candidates have the same or different IBC-LIC flags, the new pairwise candidate may always be set to has IBC-LIC off.

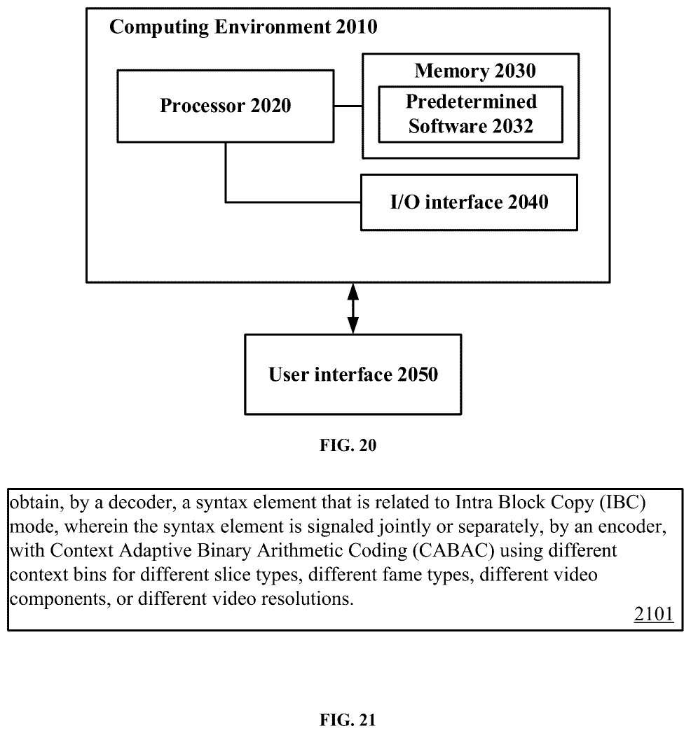

FIG. 20 shows a computing environment 2010 coupled with a user interface 2050. The computing environment 2010 can be part of a data processing server. The computing environment 2010 includes a processor 2020, a memory 2030, and an Input/Output (I/O) interface 2040.

The processor 2020 typically controls overall operations of the computing environment 2010, such as the operations associated with display, data acquisition, data communications, and image processing. The processor 2020 may include one or more processors to execute instructions to perform all or some of the steps in the above-described methods. Moreover, the processor 2020 may include one or more modules that facilitate the interaction between the processor 2020 and other components. The processor may be a Central Processing Unit (CPU), a microprocessor, a single chip machine, a Graphical Processing Unit (GPU), or the like.

The memory 2030 is configured to store various types of data to support the operation of the computing environment 2010. The memory 2030 may include predetermined software 2032. Examples of such data includes instructions for any applications or methods operated on the computing environment 2010, video datasets, image data, etc. The memory 2030 may be implemented by using any type of volatile or non-volatile memory devices, or a combination thereof, such as a Static Random Access Memory (SRAM), an Electrically Erasable Programmable Read-Only Memory (EEPROM), an Erasable Programmable Read-Only Memory (EPROM), a Programmable Read-Only Memory (PROM), a Read-Only Memory (ROM), a magnetic memory, a flash memory, a magnetic or optical disk.

The I/O interface 2040 provides an interface between the processor 2020 and peripheral interface modules, such as a keyboard, a click wheel, buttons, and the like. The buttons may include but are not limited to, a home button, a start scan button, and a stop scan button. The I/O interface 2040 can be coupled with an encoder and decoder.

In an embodiment, there is also provided a non-transitory computer-readable storage medium comprising a plurality of programs, for example, in the memory 2030, executable by the processor 2020 in the computing environment 2010, for performing the above-described methods and/or storing a bitstream generated by the encoding method described above or a bitstream to be decoded by the decoding method described above. In an embodiment, the plurality of programs may be executed by the processor 2020 in the computing environment 2010 to receive (for example, from the video encoder 20 in FIG. 2) a bitstream or data stream including encoded video information (for example, video blocks representing encoded video frames, and/or associated one or more syntax elements, etc.), and may also be executed by the processor 2020 in the computing environment 2010 to perform the decoding method described above according to the received bitstream or data stream. In another example, the plurality of programs may be executed by the processor 2020 in the computing environment 2010 to perform the encoding method described above to encode video information (for example, video blocks representing video frames, and/or associated one or more syntax elements, etc.) into a bitstream or data stream, and may also be executed by the processor 2020 in the computing environment 2010 to transmit the bitstream or data stream (for example, to the video decoder 30 in FIG. 3). Alternatively, the non-transitory computer-readable storage medium may have stored therein a bitstream or a data stream comprising encoded video information (for example, video blocks representing encoded video frames, and/or associated one or more syntax elements etc.) generated by an encoder (for example, the video encoder 20 in FIG. 2) using, for example, the encoding method described above for use by a decoder (for example, the video decoder 30 in FIG. 3) in decoding video data. The non-transitory computer-readable storage medium may be, for example, a ROM, a Random Access Memory (RAM), a CD-ROM, a magnetic tape, a floppy disc, an optical data storage device or the like.

In an embodiment, there is provided a bitstream generated by the encoding method described above or a bitstream to be decoded by the decoding method described above. In an embodiment, there is provided a bitstream comprising encoded video information generated by the encoding method described above or encoded video information to be decoded by the decoding method described above.

In an embodiment, the is also provided a computing device comprising one or more processors (for example, the processor 2020); and the non-transitory computer-readable storage medium or the memory 2030 having stored therein a plurality of programs executable by the one or more processors, wherein the one or more processors, upon execution of the plurality of programs, are configured to perform the above-described methods.

In an embodiment, there is also provided a computer program product having instructions for storage or transmission of a bitstream comprising encoded video information generated by the encoding method described above or encoded video information to be decoded by the decoding method described above. In an embodiment, there is also provided a computer program product comprising a plurality of programs, for example, in the memory 2030, executable by the processor 2020 in the computing environment 2010, for performing the above-described methods. For example, the computer program product may include the non-transitory computer-readable storage medium.

In an embodiment, the computing environment 2010 may be implemented with one or more ASICs, DSPs, Digital Signal Processing Devices (DSPDs), Programmable Logic Devices (PLDs), FPGAs, GPUs, controllers, micro-controllers, microprocessors, or other electronic components, for performing the above methods.

FIG. 21 is a flowchart illustrating a method for video decoding according to an example of the present disclosure. In Step 2101, the method includes: obtaining, by a decoder, a syntax element that is related to Intra Block Copy (IBC) mode, wherein the syntax element is signaled jointly or separately, by an encoder, with Context Adaptive Binary Arithmetic Coding (CABAC) using different context bins for different slice types, different fame types, different video components, or different video resolutions.

In some embodiments of the present disclosure, multiple CABAC context windows are predefined for different slice types or different frame types.

In some embodiments of the present disclosure, the syntax element is used for indicating motion information precision, interpolation filter selection for motion compensated block prediction, or interpolation filter selection for template prediction.

In some embodiments of the present disclosure, the different video components include luma components and chroma components.

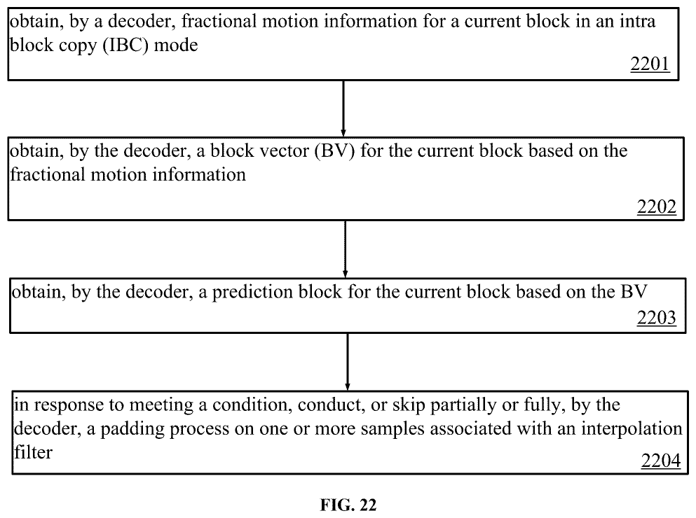

FIG. 22 is a flowchart illustrating a method for video decoding according to an example of the present disclosure. In Step 2201, the method includes: obtaining, by a decoder, fractional motion information for a current block in an intra block copy (IBC) mode. In Step 2202, the method includes: obtaining, by the decoder, a block vector (BV) for the current block based on the fractional motion information. In Step 2203, the method includes: obtaining, by the decoder, a prediction block for the current block based on the BV. In Step 2204, the method includes: in response to meeting a condition, conducting, or skipping partially or fully, by the decoder, a padding process on one or more samples associated with an interpolation filter.

In some embodiments of the present disclosure, the condition includes: determining that the one or more samples associated with the interpolation filter are not available and a value of a fractional part of the BV being zero, the fractional part including a horizontal part or a vertical part, and skipping partially or fully, by the decoder, the padding process on the one or more samples includes: skipping the padding process related to the fractional part of the BV, the value of which is zero.

In some embodiments of the present disclosure, the condition includes: all samples associated with an interpolation filter being located inside of a valid reference area, and skipping partially or fully, by the decoder, the padding process on the one or more samples includes: fully skipping the padding process.

In some embodiments of the present disclosure, conducting, by the decoder, the padding process on the one or more samples includes: determining padding sizes for left or top samples located outside of a reference block pointed by an integer BV or an integer part of a BV as 1 sample size less than padding sizes for right or bottom samples located outside of the reference block.

In some embodiments of the present disclosure, the method further includes: conducting, by the decoder, a padding process for any one or any combination of following processes: motion search, motion refinement, or parameter generation for prediction refinement; or skipping a padding process when applying the interpolation filter on the prediction block to obtain a filtered prediction for the current block.

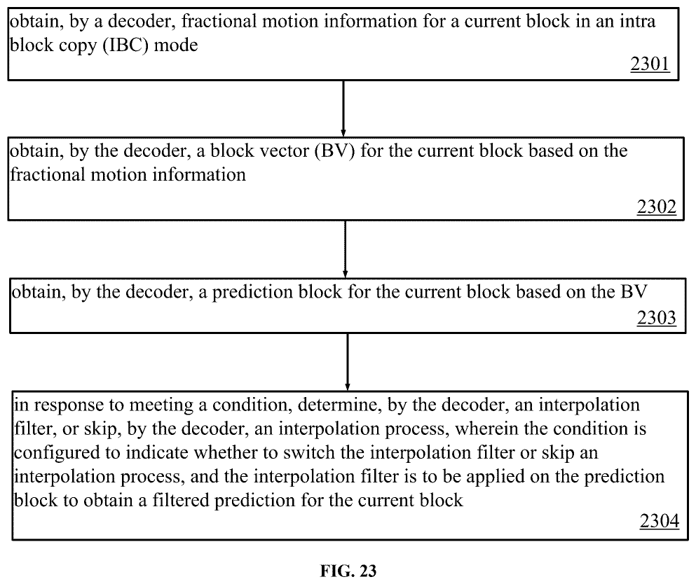

FIG. 23 is a flowchart illustrating a method for video decoding according to an example of the present disclosure. In Step 2301, the method includes: obtaining, by a decoder, fractional motion information for a current block in an intra block copy (IBC) mode. In Step 2302, obtaining, by the decoder, a block vector (BV) for the current block based on the fractional motion information. In Step 2303, the method includes: obtaining, by the decoder, a prediction block for the current block based on the BV. In Step 2304, the method includes: in response to meeting a condition, determining, by the decoder, an interpolation filter, or skipping, by the decoder, an interpolation process, wherein the condition is configured to indicate whether to switch the interpolation filter or skip an interpolation process, and the interpolation filter is to be applied on the prediction block to obtain a filtered prediction for the current block.

In some embodiments of the present disclosure, the condition includes: receiving, by the decoder from an encoder, a syntax element signaled for indicating switching the interpolation filter for any one or any combination of a specific slice type, a specific fame type, a specific video component, a specific IBC mode, or a specific interpolation scenario.

In some embodiments of the present disclosure, the condition includes any one or any combination: processing a specific slice type, processing a specific fame type, processing a specific video component, applying a specific motion precision, applying a specific IBC mode, or applying a specific interpolation scenario.

In some embodiments of the present disclosure, the specific video component includes an IBC luma sample, or an IBC chroma sample; or, the specific IBC mode includes: an Adaptive Reordering of Merge Candidates (ARMC) mode, a template matching mode, a Block Vector Difference Prediction for IBC blocks (IBC-BVDP) mode, a Block Vector Predictor Candidates clustering and Block Vector Difference sign derivation for Reconstruction-Reordered IBC (IBC-BVPC) mode, or an IBC with local illumination compensation (IBC-LIC) mode.

In some embodiments of the present disclosure, the condition includes applying an ARMC mode, a template matching mode, an IBC-BVDP mode, or an IBC-BVPC, and determining, by the decoder, the interpolation filter, or skipping, by the decoder, an interpolation process, includes: determining the interpolation filter as an interpolation filter with a smaller length than a predefined length; or skipping the interpolation process.

In some embodiments of the present disclosure, the condition includes applying an IBC-LIC mode or processing an IBC chroma sample, and determining, by the decoder, the interpolation filter, includes: determining the interpolation filter as a preset luma interpolation filter or a preset chroma interpolation filter.

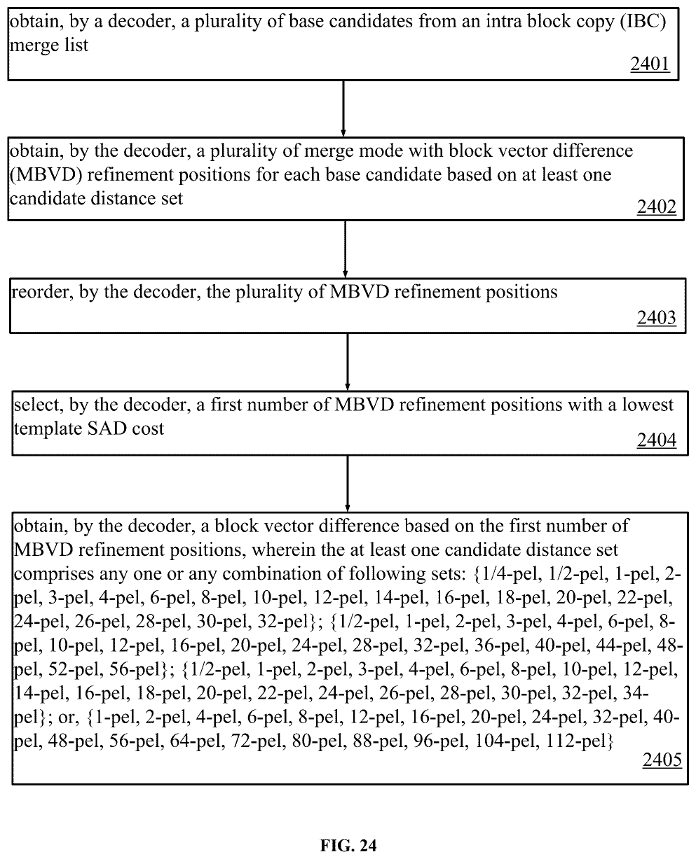

FIG. 24 is a flowchart illustrating a method for video decoding according to an example of the present disclosure. In Step 2401, the method includes: obtaining, by a decoder, a plurality of base candidates from an intra block copy (IBC) merge list. In Step 2402, obtaining, by the decoder, a plurality of merge mode with block vector difference (MBVD) refinement positions for each base candidate based on at least one candidate distance set. In Step 2403, the method includes: reordering, by the decoder, the plurality of MBVD refinement positions. In Step 2404, the method includes: selecting, by the decoder, a first number of MBVD refinement positions with a lowest template SAD cost. In Step 2405, the method includes: obtaining, by the decoder, a block vector difference based on the first number of MBVD refinement positions, wherein the at least one candidate distance set includes any one or any combination of following sets: {¼-pel, ½-pel, 1-pel, 2-pel, 3-pel, 4-pel, 6-pel, 8-pel, 10-pel, 12-pel, 14-pel, 16-pel, 18-pel, 20-pel, 22-pel, 24-pel, 26-pel, 28-pel, 30-pel, 32-pel}; {½-pel, 1-pel, 2-pel, 3-pel, 4-pel, 6-pel, 8-pel, 10-pel, 12-pel, 16-pel, 20-pel, 24-pel, 28-pel, 32-pel, 36-pel, 40-pel, 44-pel, 48-pel, 52-pel, 56-pel}; {½-pel, 1-pel, 2-pel, 3-pel, 4-pel, 6-pel, 8-pel, 10-pel, 12-pel, 14-pel, 16-pel, 18-pel, 20-pel, 22-pel, 24-pel, 26-pel, 28-pel, 30-pel, 32-pel, 34-pel}; or, {1-pel, 2-pel, 4-pel, 6-pel, 8-pel, 12-pel, 16-pel, 20-pel, 24-pel, 32-pel, 40-pel, 48-pel, 56-pel, 64-pel, 72-pel, 80-pel, 88-pel, 96-pel, 104-pel, 112-pel}.

In some embodiments of the present disclosure, obtaining, by the decoder, the plurality of MBVD refinement positions for each base candidate based on the at least one candidate distance set includes: selecting at least one distance set from the at least one candidate distance set based on a syntax element signaled by an encoder; or in response to meeting a condition associated with a specific coding mode, selecting at least one distance set corresponding to the specific coding mode from the at least one candidate distance set.

In some embodiments of the present disclosure, the condition includes: applying a specific coding mode at a specific level.

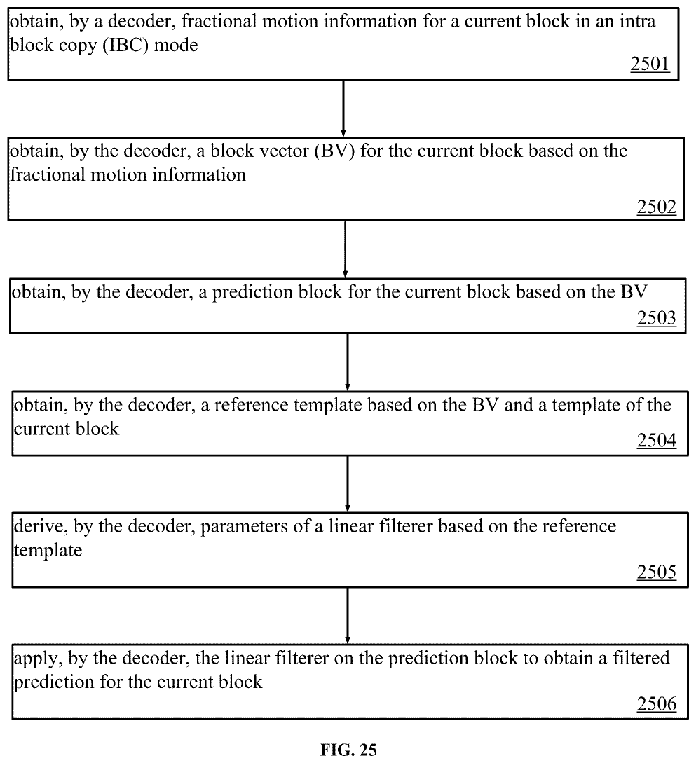

FIG. 25 is a flowchart illustrating a method for video decoding according to an example of the present disclosure. In Step 2501, the method includes: obtaining, by a decoder, fractional motion information for a current block in an intra block copy (IBC) mode. In Step 2502, the method includes: obtaining, by the decoder, a block vector (BV) for the current block based on the fractional motion information. In Step 2503, the method includes: obtaining, by the decoder, a prediction block for the current block based on the BV. In Step 2504, the method includes: obtaining, by the decoder, a reference template based on the BV and a template of the current block. In Step 2505, the method includes: deriving, by the decoder, parameters of a linear filterer based on the reference template. In Step 2506, the method includes: applying, by the decoder, the linear filterer on the prediction block to obtain a filtered prediction for the current block.

In some embodiments of the present disclosure, obtaining, by the decoder, the reference template based on the BV and the template of the current block includes: obtaining an integer motion vector by modifying the BV; and obtaining the reference template based on the integer motion vector and the template of the current block.

In some embodiments of the present disclosure, obtaining an integer motion vector by modifying the BV includes: discarding a fractional part of the BV; or, rounding a value the BV to a nearest integer value.

In some embodiments of the present disclosure, obtaining, by the decoder, the reference template based on the BV and the template of the current block includes: in response to determining that one or more samples associated with a first interpolation filter are not available, conducting a padding process on the one or more samples to obtain the reference template, wherein the first interpolation filter is same as or different from a second interpolation filter to be applied on the prediction block.

In some embodiments of the present disclosure, the first interpolation filter is different from the second interpolation filter to be applied on the prediction block, and the first interpolation filter is predefined, or signaled at a specific level.

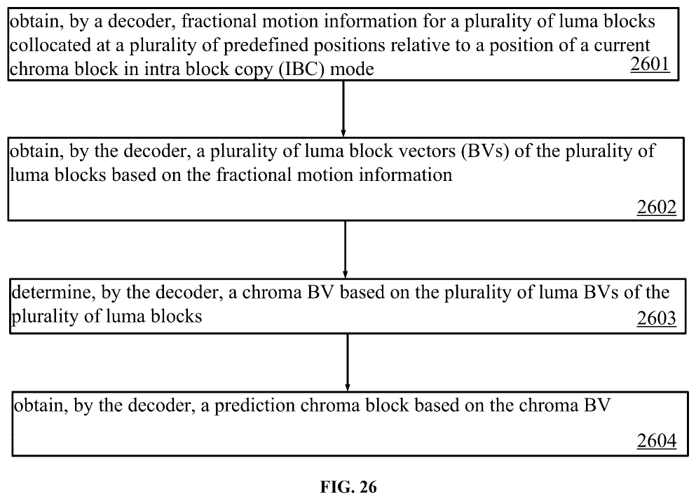

FIG. 26 is a flowchart illustrating a method for video decoding according to an example of the present disclosure. In Step 2601, the method includes: obtaining, by a decoder, fractional motion information for a plurality of luma blocks collocated at a plurality of predefined positions relative to a position of a current chroma block in intra block copy (IBC) mode. In Step 2602, the method includes: obtaining, by the decoder, a plurality of luma block vectors (BVs) of the plurality of luma blocks based on the fractional motion information. In Step 2603, the method includes: determining, by the decoder, a chroma BV based on the plurality of luma BVs of the plurality of luma blocks. In Step 2604, the method includes: obtaining, by the decoder, a prediction chroma block based on the chroma BV.

In some embodiments of the present disclosure, determining, by the decoder, the chroma BV based on the plurality of luma BVs of the plurality of luma blocks includes: calculating, by the decoder, chroma template match cost based on a luma BV of each of the plurality of luma blocks and the current chroma block; and determining, by the decoder, a chroma BV as a luma BV with a lowest chroma template match cost.

In some embodiments of the present disclosure, determining, by the decoder, the chroma BV based on the plurality of luma BVs of the plurality of luma blocks includes: conducting gradient based edge detection on the plurality of luma blocks; and determining, by the decoder, a chroma BV as a luma BV of a luma block having a same edge with the chroma block.

In some embodiments of the present disclosure, the method further includes: obtaining, by the decoder, a template-based BV refinement based on intra template matching (ITM); and obtaining, by the decoder, a refined chroma BV based on the template-based BV refinement and the chroma BV.

In some embodiments of the present disclosure, the prediction refinement includes a positive refinement or a negative refinement.

In some embodiments of the present disclosure, obtaining, by the decoder, the refined chroma BV based on the template-based BV refinement and the chroma BV includes: applying the template-based BV refinement to a first color component of the chroma BV; and reusing the prediction refinement to a second color component of the chroma BV.

In some embodiments of the present disclosure, obtaining, by the decoder, the template-based BV refinement based on includes: obtaining the template-based BV refinement based on reference template cost calculated by combining match errors for both a first color template component and a second color template component, and obtaining, by the decoder, the refined chroma BV based on the template-based BV refinement and the chroma BV includes: applying template-based BV to a first color component and a second color component of the chroma BV.

In some embodiments of the present disclosure, the method further includes: clipping or rounding a value of the chroma BV to an integer value.

In some embodiments of the present disclosure, determining, by the decoder, the chroma block vector (BV) based on the plurality of luma BVs of the plurality of luma blocks includes:

clipping or rounding a plurality of values of the plurality of luma BVs to a plurality of integer values; and determining, by the decoder, the chroma BV based on the plurality of integer values.

In some embodiments of the present disclosure, the method further includes: applying a first interpolation filter on the prediction chroma block to obtain a filtered prediction for the current chroma block, wherein the first interpolation filter is same as or different from a second interpolation filter used to obtain the template-based BV refinement, and the first interpolation filter or the second interpolation filter is predefined.

In some embodiments of the present disclosure, the method further includes: in response to determining that a size of the current chroma block is less than a predefined size, clipping or rounding a value of the chroma BV to an integer value, or, using a filter with a smaller size than a redefined size when conducting a first interpolation process on the prediction chroma block or a second interpolation process on the chroma BV.

In some embodiments of the present disclosure, the filter with the smaller size is predefined or signaled at a specific level.

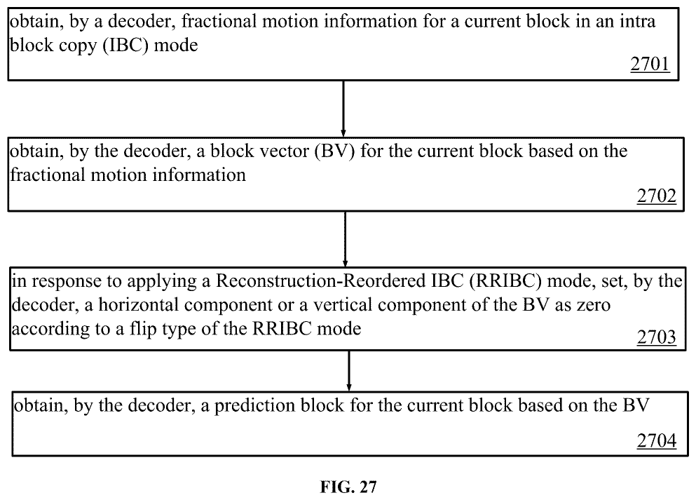

FIG. 27 is a flowchart illustrating a method for video decoding according to an example of the present disclosure. In Step 2701, the method includes: obtaining, by a decoder, fractional motion information for a current block in an intra block copy (IBC) mode. In Step 2702, the method includes: obtaining, by the decoder, a block vector (BV) for the current block based on the fractional motion information. In Step 2703, the method includes: in response to applying a Reconstruction-Reordered IBC (RRIBC) mode, setting, by the decoder, a horizontal component or a vertical component of the BV as zero according to a flip type of the RRIBC mode. In Step 2704, the method includes: obtaining, by the decoder, a prediction block for the current block based on the BV.

In some embodiments of the present disclosure, the method further includes: in response to applying the RRIBC mode and an IBC Advanced Motion Vector Prediction (AMVP) mode, conducting a motion refinement process only on a horizontal component or a vertical component of the BV.

In some embodiments of the present disclosure, the method further includes: in response to that a fractional motion vector is not allowed for applying the RRIBC mode, or, receiving a Motion Vector Difference (MVD) equaling zero, limiting motion precision to an integer pel.

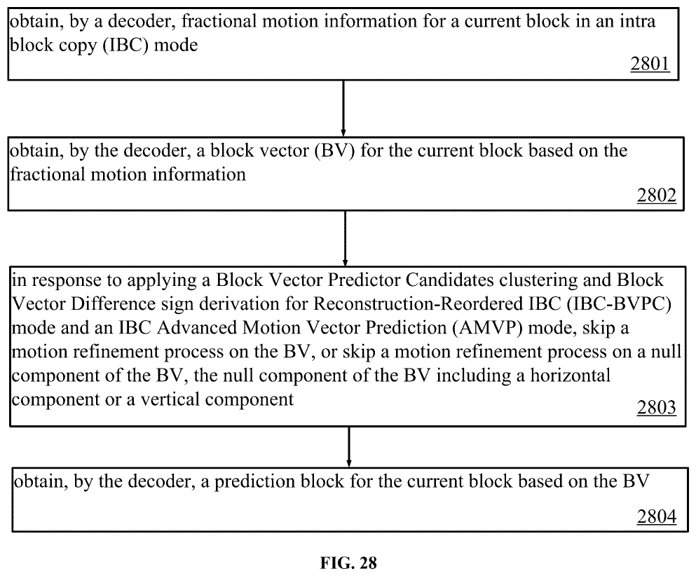

FIG. 28 is a flowchart illustrating a method for video decoding according to an example of the present disclosure. In Step 2801, the method includes: obtaining, by a decoder, fractional motion information for a current block in an intra block copy (IBC) mode. In Step 2802, the method includes: obtaining, by the decoder, a block vector (BV) for the current block based on the fractional motion information. In Step 2803, the method includes: in response to applying a Block Vector Predictor Candidates clustering and Block Vector Difference sign derivation for Reconstruction-Reordered IBC (IBC-BVPC) mode and an IBC Advanced Motion Vector Prediction (AMVP) mode, skipping a motion refinement process on the BV, or skipping a motion refinement process on a null component of the BV, the null component of the BV including a horizontal component or a vertical component. In Step 2804, the method includes: obtaining, by the decoder, a prediction block for the current block based on the BV.

In some embodiments of the present disclosure, the method further includes: in response to that a fractional motion vector is not allowed for applying the IBC-BVPC mode, or, receiving a Motion Vector Difference (MVD) equaling zero, limiting motion precision to an integer pel.

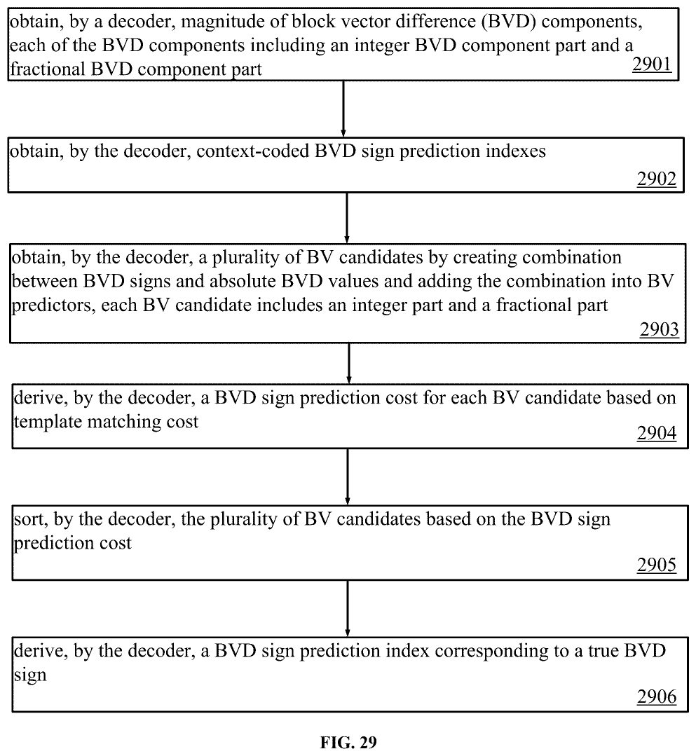

FIG. 29 is a flowchart illustrating a method for video decoding according to an example of the present disclosure. In Step 2901, the method includes: obtaining, by a decoder, magnitude of block vector difference (BVD) components, each of the BVD components including an integer BVD component part and a fractional BVD component part. In Step 2902, the method includes: obtaining, by the decoder, context-coded BVD sign prediction indexes. In Step 2903, the method includes: obtaining, by the decoder, a plurality of BV candidates by creating combination between BVD signs and absolute BVD values and adding the combination into BV predictors, each BV candidate includes an integer part and a fractional part. In Step 2904, the method includes: deriving, by the decoder, a BVD sign prediction cost for each BV candidate based on template matching cost. In Step 2905, the method includes: sorting, by the decoder, the plurality of BV candidates based on the BVD sign prediction cost. In Step 2906, the method includes: deriving, by the decoder, a BVD sign prediction index corresponding to a true BVD sign.

In some embodiments of the present disclosure, the BVD sign prediction index includes integer bins and fractional bins.

In some embodiments of the present disclosure, sorting, by the decoder, the plurality of BV candidates based on the BVD sign prediction cost includes: obtaining a first sorting result by sorting the plurality BV candidates based on a first BVD sign prediction cost derived based on the integer part of each BV candidate; and in response to that a first combination of the integer bins of the BVD sign prediction index has been derived based on the first sorting result, obtaining a second sorting result by sorting the plurality BV candidates based on a second BVD sign prediction cost derived based on the fractional part of each BV candidate, wherein deriving, by the decoder, a BVD sign prediction index corresponding to a true BVD sign includes: deriving the first combination of the integer bins of the BVD sign prediction index based on the first sorting result; and deriving a second combination of the fractional bins of the BVD sign prediction index based on the second sorting result.

In some embodiments of the present disclosure, sorting, by the decoder, the plurality of BV candidates based on the BVD sign prediction cost includes: obtaining a first sorting result by sorting the plurality BV candidates based on a first BVD sign prediction cost derived based on the fractional part of each BV candidate; and in response to that a first combination of the fractional bins of the BVD sign prediction index has been derived based on the first sorting result, obtaining a second sorting result by sorting the plurality BV candidates based on a second BVD sign prediction cost derived based on the integer part of each BV candidate, wherein deriving, by the decoder, a BVD sign prediction index corresponding to a true BVD sign includes: deriving the first combination of the fractional bins of the BVD sign prediction index based on the first sorting result; and deriving a second combination of the integer bins of the BVD sign prediction index based on the second sorting result.

In some embodiments of the present disclosure, the fractional BVD component part is obtained by receiving, by the decoder from an encoder, fractional bins representing the fractional BVD component part, and deriving, by the decoder, the BVD sign prediction cost for each BV candidate based on template matching cost includes: conducting an interpolation filtering process for each BV candidate, wherein an interpolation filter associated with the interpolation filtering process is predefined or switched at different levels; and deriving the BVD sign prediction cost for each BV candidate based on template matching cost calculated by considering both the integer part and the fractional part of each BV candidate.

In some embodiments of the present disclosure, the fractional BVD component part is obtained by receiving, by the decoder from an encoder, fractional bins representing the fractional BVD component part, and deriving, by the decoder, the BVD sign prediction cost for each BV candidate based on template matching cost includes: skipping an interpolation filtering process for each BV candidate; and deriving the BVD sign prediction cost for each BV candidate based on template matching cost calculated by only considering the integer part of each BV candidate.

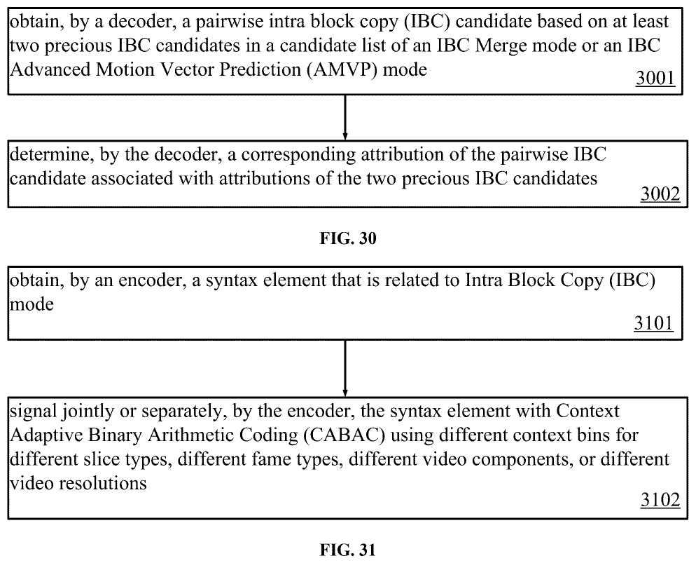

FIG. 30 is a flowchart illustrating a method for video decoding according to an example of the present disclosure. In Step 3001, the method includes: obtaining, by a decoder, a pairwise intra block copy (IBC) candidate based on at least two precious IBC candidates in a candidate list of an IBC Merge mode or an IBC Advanced Motion Vector Prediction (AMVP) mode. In Step 3002, the method includes: determining, by the decoder, a corresponding attribution of the pairwise IBC candidate associated with attributions of the two precious IBC candidates.

In some embodiments of the present disclosure, determining the corresponding attribution of the pairwise IBC candidate associated with attributions of the two precious IBC candidates includes: in response to that the two precious IBC candidates have different attributions, determining a corresponding attribution of the pairwise IBC candidate based on the different attributions of the two precious IBC candidates; in response to that the two precious IBC candidates have a same attribution, determining a corresponding attribution of the pairwise IBC candidate as the same attribution; or, determining the corresponding attribution of the pairwise IBC candidate as a predefined value.

In some embodiments of the present disclosure, in response to that the two precious IBC candidates have different attributions, determining the corresponding attribution of the pairwise IBC candidate based on the different attributions of the two precious IBC candidates includes: in response to that the two precious IBC candidates have different motion precisions, rounding or clipping the pairwise IBC candidate to a predefined motion precision, or, determining a motion precision of the pairwise IBC candidate as a higher precision of the different motion precisions.

In some embodiments of the present disclosure, in response to that the two precious IBC candidates have different attributions, determining the corresponding attribution of the pairwise IBC candidate based on the different attributions of the two precious IBC candidates includes: in response to that the two precious IBC candidates have different Reconstruction-Reordered IBC (RRIBC) flip modes, setting the pairwise IBC candidate to have a non-flip mode, wherein the different RRIBC flip modes include any combination of the non-flip mode, a horizontal flip mode, and a vertical flip mode.

In some embodiments of the present disclosure, in response to that the two precious IBC candidates have a same attribution, determining a corresponding attribution of the pairwise IBC candidate as the same attribution includes: in response to that the two precious IBC candidates a same RRIBC flip mode, setting the pairwise IBC candidate to have the same RRIBC flip mode, wherein the same RRIBC flip mode includes any of the non-flip mode, a horizontal flip mode, and a vertical flip mode.

In some embodiments of the present disclosure, determining the corresponding attribution of the pairwise IBC candidate as a predefined value includes: setting the pairwise IBC candidate to have a RRIBC non-flip mode.

In some embodiments of the present disclosure, in response to that the two precious IBC candidates have different attributions, determining the corresponding attribution of the pairwise IBC candidate based on the different attributions of the two precious IBC candidates includes: in response to that the two precious IBC candidates have different IBC with Local Illumination Compensation (IBC-LIC) flags including an IBC-LIC on flag and an IBC-LIC off flag, setting the pairwise IBC candidate to have the IBC-LIC on flag or the IBC-LIC off flag.

In some embodiments of the present disclosure, in response to that the two precious IBC candidates have a same attribution, determining a corresponding attribution of the pairwise IBC candidate as the same attribution includes: in response to that the two precious IBC candidates a same IBC-LIC flag, setting the pairwise IBC candidate to have the same IBC-LIC flag, wherein the same IBC-LIC flag includes any of an IBC-LIC on flag and an IBC-LIC off flag.

In some embodiments of the present disclosure, determining the corresponding attribution of the pairwise IBC candidate as a predefined value includes: setting the pairwise IBC candidate to have an IBC-LIC off flag.

FIG. 31 is a flowchart illustrating a method for video encoding according to an example of the present disclosure. In Step 3101, the method includes: obtaining, by an encoder, a syntax element that is related to Intra Block Copy (IBC) mode. In Step 3102, the method includes: signaling jointly or separately, by the encoder, the syntax element with Context Adaptive Binary Arithmetic Coding (CABAC) using different context bins for different slice types, different fame types, different video components, or different video resolutions.

In some embodiments of the present disclosure, multiple CABAC context windows are predefined for different slice types or different frame types.

In some embodiments of the present disclosure, the syntax element is used for indicating motion information precision, interpolation filter selection for motion compensated block prediction, or interpolation filter selection for template prediction.

In some embodiments of the present disclosure, the different video components include luma components and chroma components.

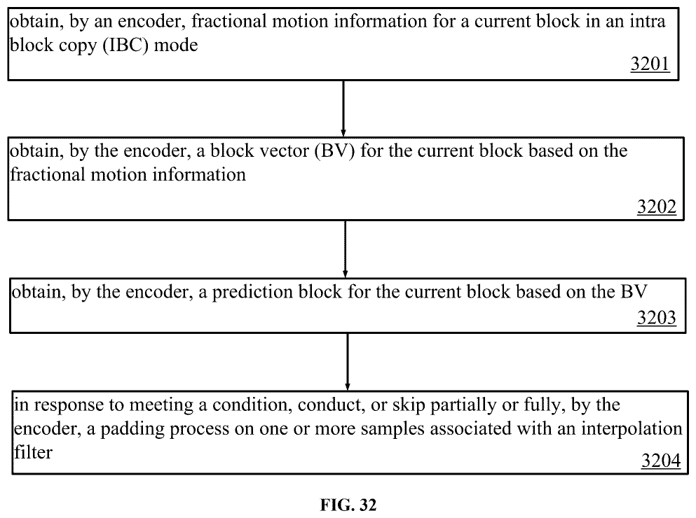

FIG. 32 is a flowchart illustrating a method for video encoding according to an example of the present disclosure. In Step 3201, the method includes: obtaining, by an encoder, fractional motion information for a current block in an intra block copy (IBC) mode. In Step 3202, the method includes: obtaining, by the encoder, a block vector (BV) for the current block based on the fractional motion information. In Step 3203, the method includes: obtaining, by the encoder, a prediction block for the current block based on the BV. In Step 3204, the method includes: in response to meeting a condition, conducting, or skipping partially or fully, by the encoder, a padding process on one or more samples associated with an interpolation filter.

In some embodiments of the present disclosure, the condition includes: determining that the one or more samples associated with the interpolation filter are not available and a value of a fractional part of the BV being zero, the fractional part including a horizontal part or a vertical part, and skipping partially or fully, by the encoder, the padding process on the one or more samples includes: skipping the padding process related to the fractional part of the BV, the value of which is zero.

In some embodiments of the present disclosure, the condition includes: all samples associated with an interpolation filter being located inside of a valid reference area, and skipping partially or fully, by the encoder, the padding process on the one or more samples includes: fully skipping the padding process.

In some embodiments of the present disclosure, conducting, by the encoder, the padding process on the one or more samples includes: determining padding sizes for left or top samples located outside of a reference block pointed by an integer BV or an integer part of a BV as 1 sample size less than padding sizes for right or bottom samples located outside of the reference block.

In some embodiments of the present disclosure, the method further includes: conducting, by the encoder, a padding process for any one or any combination of following processes: motion search, motion refinement, or parameter generation for prediction refinement; or skipping a padding process when applying the interpolation filter on the prediction block to obtain a filtered prediction for the current block.

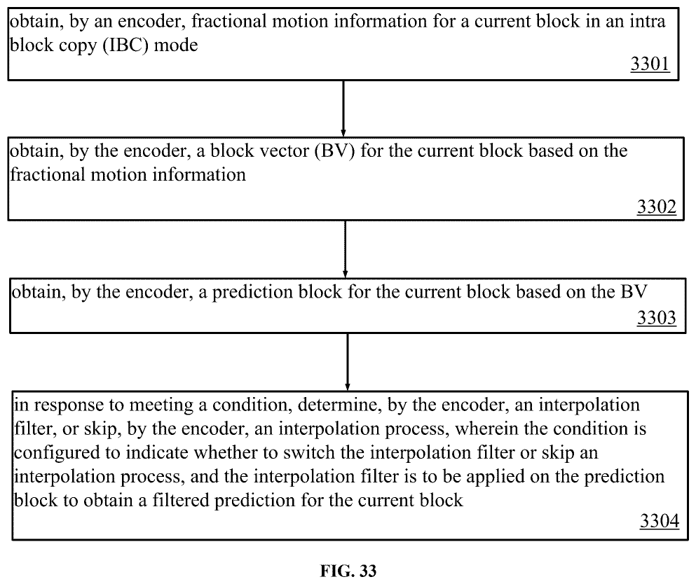

FIG. 33 is a flowchart illustrating a method for video encoding according to an example of the present disclosure. In Step 3301, the method includes: obtaining, by an encoder, fractional motion information for a current block in an intra block copy (IBC) mode. In Step 3302, obtaining, by the encoder, a block vector (BV) for the current block based on the fractional motion information. In Step 3303, the method includes: obtaining, by the encoder, a prediction block for the current block based on the BV. In Step 3304, the method includes: in response to meeting a condition, determining, by the encoder, an interpolation filter, or skipping, by the encoder, an interpolation process, wherein the condition is configured to indicate whether to switch the interpolation filter or skip an interpolation process, and the interpolation filter is to be applied on the prediction block to obtain a filtered prediction for the current block.

In some embodiments of the present disclosure, the condition includes: receiving, by the encoder from an encoder, a syntax element signaled for indicating switching the interpolation filter for any one or any combination of a specific slice type, a specific fame type, a specific video component, a specific IBC mode, or a specific interpolation scenario.

In some embodiments of the present disclosure, the condition includes any one or any combination: processing a specific slice type, processing a specific fame type, processing a specific video component, applying a specific motion precision, applying a specific IBC mode, or applying a specific interpolation scenario.

In some embodiments of the present disclosure, the specific video component includes an IBC luma sample, or an IBC chroma sample; or, the specific IBC mode includes: an Adaptive Reordering of Merge Candidates (ARMC) mode, a template matching mode, a Block Vector Difference Prediction for IBC blocks (IBC-BVDP) mode, a Block Vector Predictor Candidates clustering and Block Vector Difference sign derivation for Reconstruction-Reordered IBC (IBC-BVPC) mode, or an IBC with local illumination compensation (IBC-LIC) mode.

In some embodiments of the present disclosure, the condition includes applying an ARMC mode, a template matching mode, an IBC-BVDP mode, or an IBC-BVPC, and determining, by the encoder, the interpolation filter, or skipping, by the encoder, an interpolation process, includes: determining the interpolation filter as an interpolation filter with a smaller length than a predefined length; or skipping the interpolation process.

In some embodiments of the present disclosure, the condition includes applying an IBC-LIC mode or processing an IBC chroma sample, and determining, by the encoder, the interpolation filter, includes: determining the interpolation filter as a preset luma interpolation filter or a preset chroma interpolation filter.

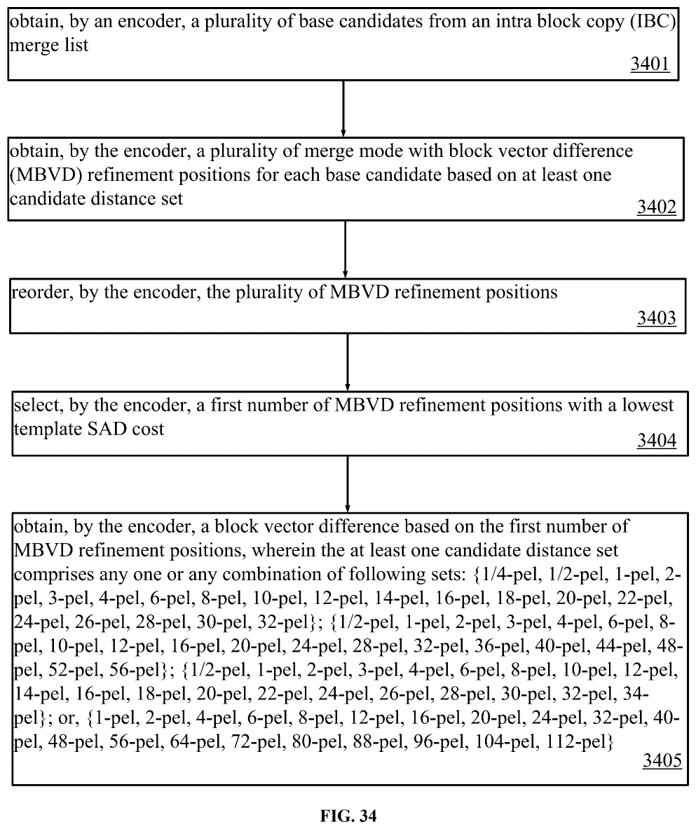

FIG. 34 is a flowchart illustrating a method for video encoding according to an example of the present disclosure. In Step 3401, the method includes: obtaining, by an encoder, a plurality of base candidates from an intra block copy (IBC) merge list. In Step 3402, obtaining, by the encoder, a plurality of merge mode with block vector difference (MBVD) refinement positions for each base candidate based on at least one candidate distance set. In Step 3403, the method includes: reordering, by the encoder, the plurality of MBVD refinement positions. In Step 3404, the method includes: selecting, by the encoder, a first number of MBVD refinement positions with a lowest template SAD cost. In Step 3405, the method includes: obtaining, by the decoder, a block vector difference based on the first number of MBVD refinement positions, wherein the at least one candidate distance set comprises any one or any combination of following sets: {¼-pel, ½-pel, 1-pel, 2-pel, 3-pel, 4-pel, 6-pel, 8-pel, 10-pel, 12-pel, 14-pel, 16-pel, 18-pel, 20-pel, 22-pel, 24-pel, 26-pel, 28-pel, 30-pel, 32-pel}; {½-pel, 1-pel, 2-pel, 3-pel, 4-pel, 6-pel, 8-pel, 10-pel, 12-pel, 16-pel, 20-pel, 24-pel, 28-pel, 32-pel, 36-pel, 40-pel, 44-pel, 48-pel, 52-pel, 56-pel}; {½-pel, 1-pel, 2-pel, 3-pel, 4-pel, 6-pel, 8-pel, 10-pel, 12-pel, 14-pel, 16-pel, 18-pel, 20-pel, 22-pel, 24-pel, 26-pel, 28-pel, 30-pel, 32-pel, 34-pel}; or, {1-pel, 2-pel, 4-pel, 6-pel, 8-pel, 12-pel, 16-pel, 20-pel, 24-pel, 32-pel, 40-pel, 48-pel, 56-pel, 64-pel, 72-pel, 80-pel, 88-pel, 96-pel, 104-pel, 112-pel}.

In some embodiments of the present disclosure, obtaining, by the encoder, the plurality of MBVD refinement positions for each base candidate based on the at least one candidate distance set includes: signaling a syntax element to indicate at least one distance set from the at least one candidate distance set; or in response to meeting a condition associated with a specific coding mode, selecting at least one distance set from the at least one candidate distance set.

In some embodiments of the present disclosure, the condition includes: applying a specific coding mode at a specific level.

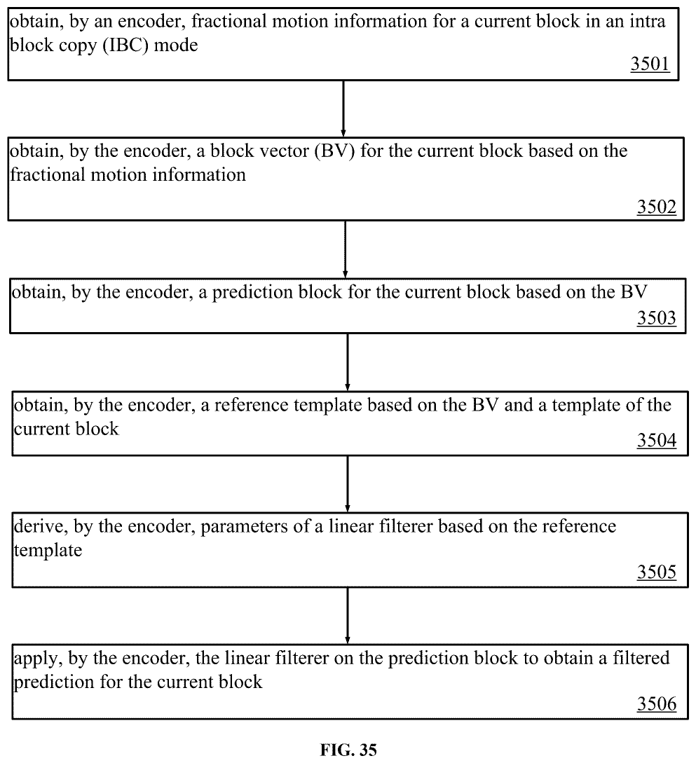

FIG. 35 is a flowchart illustrating a method for video encoding according to an example of the present disclosure. In Step 3501, the method includes: obtaining, by an encoder, fractional motion information for a current block in an intra block copy (IBC) mode. In Step 3502, the method includes: obtaining, by the encoder, a block vector (BV) for the current block based on the fractional motion information. In Step 3503, the method includes: obtaining, by the encoder, a prediction block for the current block based on the BV. In Step 3504, the method includes: obtaining, by the encoder, a reference template based on the BV and a template of the current block. In Step 3505, the method includes: deriving, by the encoder, parameters of a linear filterer based on the reference template. In Step 3506, the method includes: applying, by the encoder, the linear filterer on the prediction block to obtain a filtered prediction for the current block.

In some embodiments of the present disclosure, obtaining, by the encoder, the reference template based on the BV and the template of the current block includes: obtaining an integer motion vector by modifying the BV; and obtaining the reference template based on the integer motion vector and the template of the current block.

In some embodiments of the present disclosure, obtaining an integer motion vector by modifying the BV includes: discarding a fractional part of the BV; or, rounding a value the BV to a nearest integer value.

In some embodiments of the present disclosure, obtaining, by the encoder, the reference template based on the BV and the template of the current block includes: in response to determining that one or more samples associated with a first interpolation filter are not available, conducting a padding process on the one or more samples to obtain the reference template, wherein the first interpolation filter is same as or different from a second interpolation filter to be applied on the prediction block.

In some embodiments of the present disclosure, the first interpolation filter is different from the second interpolation filter to be applied on the prediction block, and the first interpolation filter is predefined, or signaled at a specific level.

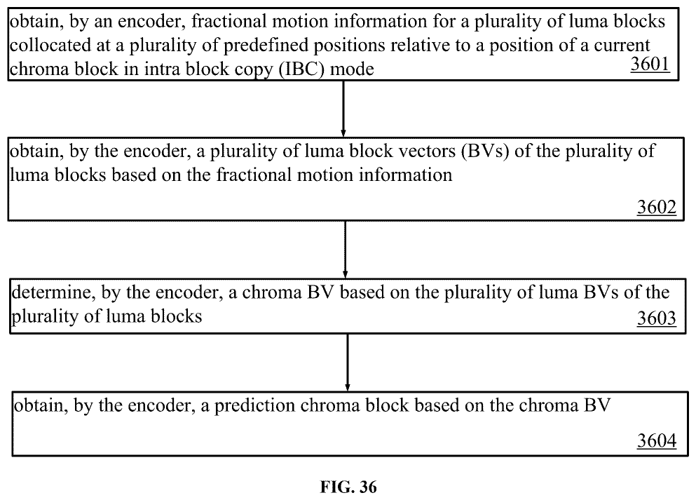

FIG. 36 is a flowchart illustrating a method for video encoding according to an example of the present disclosure. In Step 3601, the method includes: obtaining, by an encoder, fractional motion information for a plurality of luma blocks collocated at a plurality of predefined positions relative to a position of a current chroma block in intra block copy (IBC) mode. In Step 3602, the method includes: obtaining, by the encoder, a plurality of luma block vectors (BVs) of the plurality of luma blocks based on the fractional motion information. In Step 3603, the method includes: determining, by the encoder, a chroma BV based on the plurality of luma BVs of the plurality of luma blocks. In Step 3604, the method includes: obtaining, by the encoder, a prediction chroma block based on the chroma BV.

In some embodiments of the present disclosure, determining, by the encoder, the chroma BV based on the plurality of luma BVs of the plurality of luma blocks includes: calculating, by the encoder, chroma template match cost based on a luma BV of each of the plurality of luma blocks and the current chroma block; and determining, by the encoder, a chroma BV as a luma BV with a lowest chroma template match cost.

In some embodiments of the present disclosure, determining, by the encoder, the chroma BV based on the plurality of luma BVs of the plurality of luma blocks includes: conducting gradient based edge detection on the plurality of luma blocks; and determining, by the encoder, a chroma BV as a luma BV of a luma block having a same edge with the chroma block.

In some embodiments of the present disclosure, the method further includes: obtaining, by the encoder, a template-based BV refinement based on intra template matching (ITM); and obtaining, by the encoder, a refined chroma BV based on the template-based BV refinement and the chroma BV.

In some embodiments of the present disclosure, the prediction refinement includes a positive refinement or a negative refinement.

In some embodiments of the present disclosure, obtaining, by the encoder, the refined chroma BV based on the template-based BV refinement and the chroma BV includes: applying the template-based BV refinement to a first color component of the chroma BV; and reusing the prediction refinement to a second color component of the chroma BV.

In some embodiments of the present disclosure, obtaining, by the encoder, the template-based BV refinement based on includes: obtaining the template-based BV refinement based on reference template cost calculated by combining match errors for both a first color template component and a second color template component, and obtaining, by the encoder, the refined chroma BV based on the template-based BV refinement and the chroma BV includes: applying template-based BV to a first color component and a second color component of the chroma BV.

In some embodiments of the present disclosure, the method further includes: clipping or rounding a value of the chroma BV to an integer value.

In some embodiments of the present disclosure, determining, by the encoder, the chroma block vector (BV) based on the plurality of luma BVs of the plurality of luma blocks includes:

clipping or rounding a plurality of values of the plurality of luma BVs to a plurality of integer values; and determining, by the encoder, the chroma BV based on the plurality of integer values.

In some embodiments of the present disclosure, the method further includes: applying a first interpolation filter on the prediction chroma block to obtain a filtered prediction for the current chroma block, wherein the first interpolation filter is same as or different from a second interpolation filter used to obtain the template-based BV refinement, and the first interpolation filter or the second interpolation filter is predefined.

In some embodiments of the present disclosure, the method further includes: in response to determining that a size of the current chroma block is less than a predefined size, clipping or rounding a value of the chroma BV to an integer value, or, using a filter with a smaller size than a redefined size when conducting a first interpolation process on the prediction chroma block or a second interpolation process on the chroma BV.

In some embodiments of the present disclosure, the filter with the smaller size is predefined or signaled at a specific level.

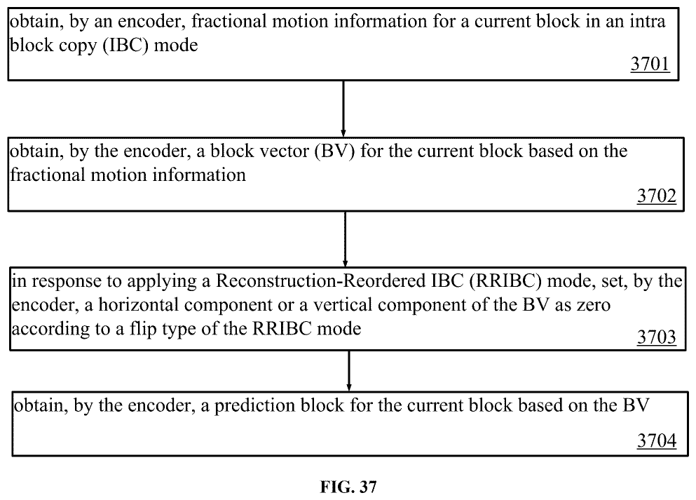

FIG. 37 is a flowchart illustrating a method for video encoding according to an example of the present disclosure. In Step 3701, the method includes: obtaining, by an encoder, fractional motion information for a current block in an intra block copy (IBC) mode. In Step 3702, the method includes: obtaining, by the encoder, a block vector (BV) for the current block based on the fractional motion information. In Step 3703, the method includes: in response to applying a Reconstruction-Reordered IBC (RRIBC) mode, setting, by the encoder, a horizontal component or a vertical component of the BV as zero according to a flip type of the RRIBC mode. In Step 3704, the method includes: obtaining, by the encoder, a prediction block for the current block based on the BV.

In some embodiments of the present disclosure, the method further includes: in response to that a fractional motion vector is not allowed for applying the RRIBC mode, or, receiving a Motion Vector Difference (MVD) equaling zero, limiting motion precision to an integer pel.

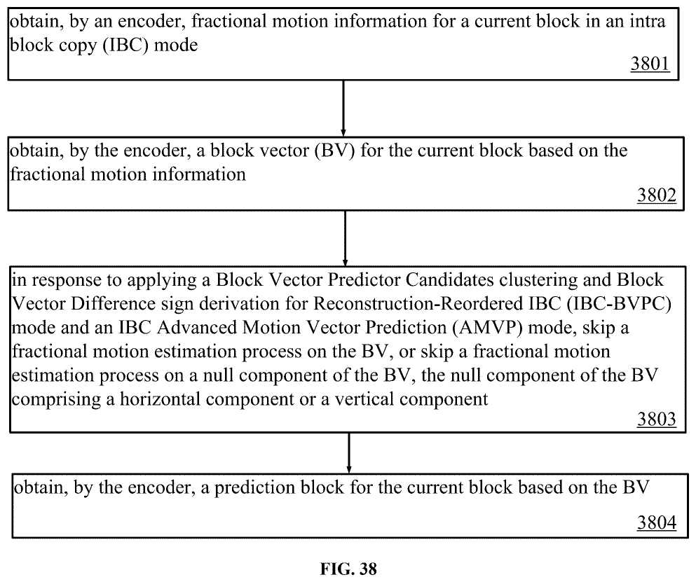

FIG. 38 is a flowchart illustrating a method for video encoding according to an example of the present disclosure. In Step 3801, the method includes: obtaining, by an encoder, fractional motion information for a current block in an intra block copy (IBC) mode. In Step 3802, the method includes: obtaining, by the encoder, a block vector (BV) for the current block based on the fractional motion information. In Step 3803, the method includes: in response to applying a Block Vector Predictor Candidates clustering and Block Vector Difference sign derivation for Reconstruction-Reordered IBC (IBC-BVPC) mode and an IBC Advanced Motion Vector Prediction (AMVP) mode, skipping a fractional motion estimation process on the BV, or skipping a fractional motion estimation process on a null component of the BV, the null component of the BV comprising a horizontal component or a vertical component. In Step 3804, the method includes: obtaining, by the encoder, a prediction block for the current block based on the BV.

In some embodiments of the present disclosure, the method further includes: in response to that a fractional motion vector is not allowed for applying the IBC-BVPC mode, or, receiving a Motion Vector Difference (MVD) equaling zero, limiting motion precision to an integer pel.

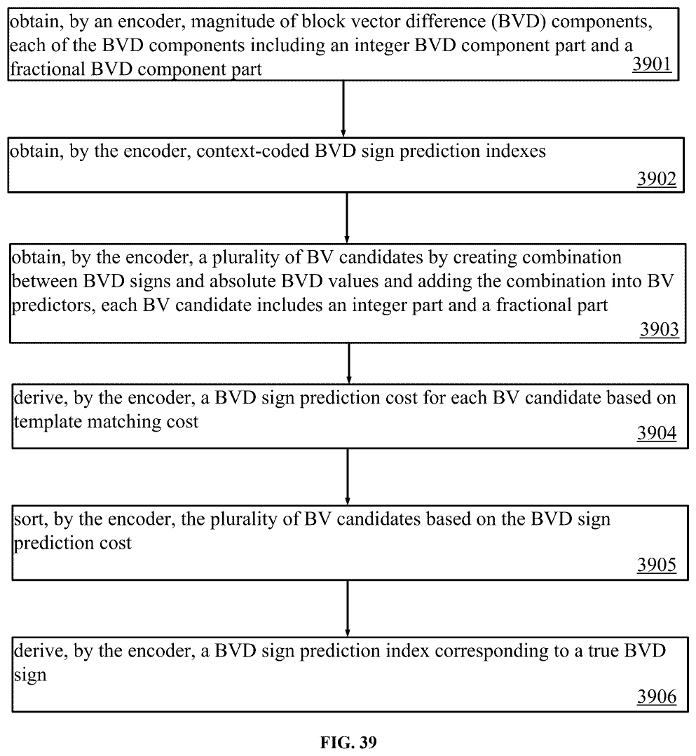

FIG. 39 is a flowchart illustrating a method for video encoding according to an example of the present disclosure. In Step 3901, the method includes: obtaining, by an encoder, magnitude of block vector difference (BVD) components, each of the BVD components comprising an integer BVD component part and a fractional BVD component part. In Step 3902, the method includes: obtaining, by the encoder, context-coded BVD sign prediction indexes. In Step 3903, the method includes: obtaining, by the encoder, a plurality of BV candidates by creating combination between BVD signs and absolute BVD values and adding the combination into BV predictors, each BV candidate comprises an integer part and a fractional part. In Step 3904, the method includes: deriving, by the encoder, a BVD sign prediction cost for each BV candidate based on template matching cost. In Step 3905, the method includes: sorting, by the encoder, the plurality of BV candidates based on the BVD sign prediction cost. In Step 3906, the method includes: deriving, by the encoder, a BVD sign prediction index corresponding to a true BVD sign.

In some embodiments of the present disclosure, the BVD sign prediction index includes integer bins and fractional bins.

In some embodiments of the present disclosure, sorting, by the encoder, the plurality of BV candidates based on the BVD sign prediction cost includes: obtaining a first sorting result by sorting the plurality BV candidates based on a first BVD sign prediction cost derived based on the integer part of each BV candidate; and in response to that a first combination of the integer bins of the BVD sign prediction index has been derived based on the first sorting result, obtaining a second sorting result by sorting the plurality BV candidates based on a second BVD sign prediction cost derived based on the fractional part of each BV candidate, wherein deriving, by the encoder, a BVD sign prediction index corresponding to a true BVD sign includes: deriving the first combination of the integer bins of the BVD sign prediction index based on the first sorting result; and deriving a second combination of the fractional bins of the BVD sign prediction index based on the second sorting result.

In some embodiments of the present disclosure, sorting, by the encoder, the plurality of BV candidates based on the BVD sign prediction cost includes: obtaining a first sorting result by sorting the plurality BV candidates based on a first BVD sign prediction cost derived based on the fractional part of each BV candidate; and in response to that a first combination of the fractional bins of the BVD sign prediction index has been derived based on the first sorting result, obtaining a second sorting result by sorting the plurality BV candidates based on a second BVD sign prediction cost derived based on the integer part of each BV candidate, wherein deriving, by the encoder, a BVD sign prediction index corresponding to a true BVD sign includes: deriving the first combination of the fractional bins of the BVD sign prediction index based on the first sorting result; and deriving a second combination of the integer bins of the BVD sign prediction index based on the second sorting result.

In some embodiments of the present disclosure, the fractional BVD component part is obtained by receiving, by the encoder from an encoder, fractional bins representing the fractional BVD component part, and deriving, by the encoder, the BVD sign prediction cost for each BV candidate based on template matching cost includes: conducting an interpolation filtering process for each BV candidate, wherein an interpolation filter associated with the interpolation filtering process is predefined or switched at different levels; and deriving the BVD sign prediction cost for each BV candidate based on template matching cost calculated by considering both the integer part and the fractional part of each BV candidate.

In some embodiments of the present disclosure, the fractional BVD component part is obtained by receiving, by the encoder from an encoder, fractional bins representing the fractional BVD component part, and deriving, by the encoder, the BVD sign prediction cost for each BV candidate based on template matching cost includes: skipping an interpolation filtering process for each BV candidate; and deriving the BVD sign prediction cost for each BV candidate based on template matching cost calculated by only considering the integer part of each BV candidate.

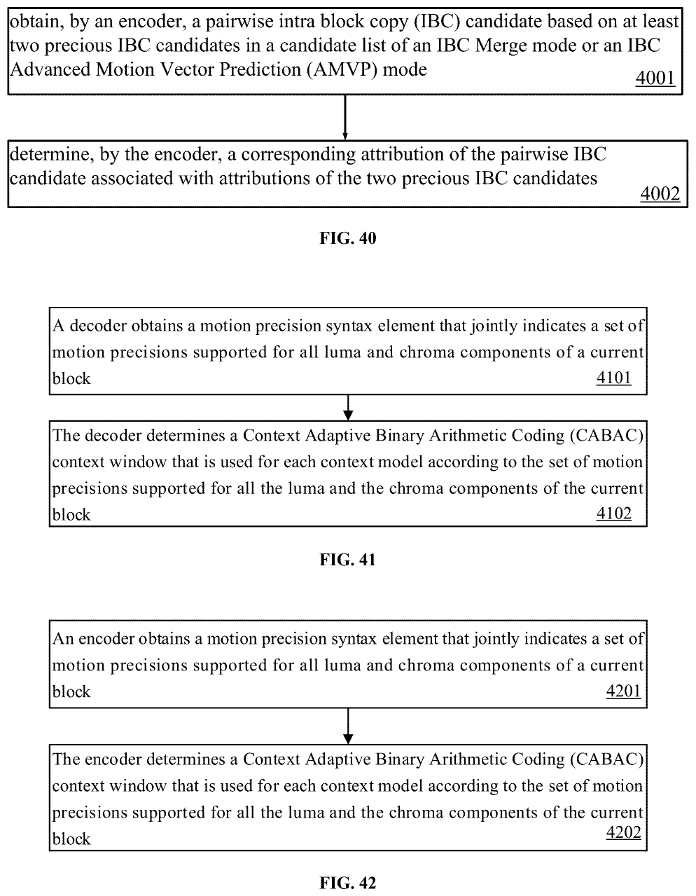

FIG. 40 is a flowchart illustrating a method for video encoding according to an example of the present disclosure. In Step 4001, the method includes: obtaining, by an encoder, a pairwise intra block copy (IBC) candidate based on at least two precious IBC candidates in a candidate list of an IBC Merge mode or an IBC Advanced Motion Vector Prediction (AMVP) mode. In Step 4002, the method includes: determining, by the encoder, a corresponding attribution of the pairwise IBC candidate associated with attributions of the two precious IBC candidates.

In some embodiments of the present disclosure, determining the corresponding attribution of the pairwise IBC candidate associated with attributions of the two precious IBC candidates includes: in response to that the two precious IBC candidates have different attributions, determining a corresponding attribution of the pairwise IBC candidate based on the different attributions of the two precious IBC candidates; in response to that the two precious IBC candidates have a same attribution, determining a corresponding attribution of the pairwise IBC candidate as the same attribution; or, determining the corresponding attribution of the pairwise IBC candidate as a predefined value.

In some embodiments of the present disclosure, in response to that the two precious IBC candidates have different attributions, determining the corresponding attribution of the pairwise IBC candidate based on the different attributions of the two precious IBC candidates includes: in response to that the two precious IBC candidates have different motion precisions, rounding or clipping the pairwise IBC candidate to a predefined motion precision, or, determining a motion precision of the pairwise IBC candidate as a higher precision of the different motion precisions.

In some embodiments of the present disclosure, in response to that the two precious IBC candidates have different attributions, determining the corresponding attribution of the pairwise

IBC candidate based on the different attributions of the two precious IBC candidates includes: in response to that the two precious IBC candidates have different Reconstruction-Reordered IBC (RRIBC) flip modes, setting the pairwise IBC candidate to have a non-flip mode, wherein the different RRIBC flip modes include any combination of the non-flip mode, a horizontal flip mode, and a vertical flip mode.

In some embodiments of the present disclosure, in response to that the two precious IBC candidates have a same attribution, determining a corresponding attribution of the pairwise IBC candidate as the same attribution includes: in response to that the two precious IBC candidates a same RRIBC flip mode, setting the pairwise IBC candidate to have the same RRIBC flip mode, wherein the same RRIBC flip mode includes any of the non-flip mode, a horizontal flip mode, and a vertical flip mode.

In some embodiments of the present disclosure, determining the corresponding attribution of the pairwise IBC candidate as a predefined value includes: setting the pairwise IBC candidate to have a RRIBC non-flip mode.

In some embodiments of the present disclosure, in response to that the two precious IBC candidates have different attributions, determining the corresponding attribution of the pairwise IBC candidate based on the different attributions of the two precious IBC candidates includes: in response to that the two precious IBC candidates have different IBC with Local Illumination Compensation (IBC-LIC) flags including an IBC-LIC on flag and an IBC-LIC off flag, setting the pairwise IBC candidate to have the IBC-LIC on flag or the IBC-LIC off flag.

In some embodiments of the present disclosure, in response to that the two precious IBC candidates have a same attribution, determining a corresponding attribution of the pairwise IBC candidate as the same attribution includes: in response to that the two precious IBC candidates a same IBC-LIC flag, setting the pairwise IBC candidate to have the same IBC-LIC flag, wherein the same IBC-LIC flag includes any of an IBC-LIC on flag and an IBC-LIC off flag.

In some embodiments of the present disclosure, determining the corresponding attribution of the pairwise IBC candidate as a predefined value includes: setting the pairwise IBC candidate to have an IBC-LIC off flag.

In an embodiment, there is also provided a method of storing a bitstream, comprising storing the bitstream on a digital storage medium, wherein the bitstream comprises encoded video information generated by the encoding method described above or encoded video information to be decoded by the decoding method described above.

In an embodiment, there is also provided a method for transmitting a bitstream generated by the encoder described above. In an embodiment, there is also provided a method for receiving a bitstream to be decoded by the decoder described above.

FIG. 41 is a flowchart illustrating a method for video decoding according to an example of the present disclosure. Specifically, FIG. 41 shows methods discussed in the section of “CABAC context window.”

In Step 4101, the processor 2020, at the side of a decoder, may obtain a motion precision syntax element that jointly indicates a set of motion precisions supported for all luma and chroma components of a current block. The motion precision syntax element may be the motion precision flag that is jointly for all luma and chroma components, as discussed in the section of “CABAC context window.”

In Step 4102, the processor 2020, at the side of the decoder, may determine an CABAC context window that is used for each context model according to the set of motion precisions supported for all the luma and the chroma components of the current block.

In some examples, the set of the motion precisions supported for all the luma and the chroma components may include one of following sets: a set of 4-pel, 1-pel, ½-pel and 1/-4 pel; a set of 4-pel, 1-pel, and ½-pel; or a set of 4-pel, 1-pel, and ¼-pel.

In some examples, the set of the motion precisions may include a first motion precision that is converted from a second motion precision, where the second motion precision is not comprised in the set of the motion precisions. For example, 4-pel, 1-pel, ¼-pel may be supported and signaled for all three components, while in this case ½-pel is always converted to ¼-pel precision first before signaling.

FIG. 42 is a flowchart illustrating a method for video encoding corresponding to the method for video decoding as shown in FIG. 41 in accordance with some examples of the present disclosure.

In Step 4201, the processor 2020, at the side of an encoder, may signal a motion precision syntax element that jointly indicates a set of motion precisions supported for all luma and chroma components of a current block. The motion precision syntax element may be the motion precision flag that is jointly for all luma and chroma components, as discussed in the section of “CABAC context window.”

In Step 4202, the processor 2020, at the side of the encoder, may determine an CABAC context window that is used for each context model according to the set of motion precisions supported for all the luma and the chroma components of the current block.

In some examples, the set of the motion precisions supported for all the luma and the chroma components may include one of following sets: a set of 4-pel, 1-pel, ½-pel and 1/-4 pel; a set of 4-pel, 1-pel, and ½-pel; or a set of 4-pel, 1-pel, and ¼-pel.

In some examples, the set of the motion precisions may include a first motion precision that is converted from a second motion precision, where the second motion precision is not comprised in the set of the motion precisions. For example, 4-pel, 1-pel, ¼-pel may be supported and signaled for all three components, while in this case ½-pel is always converted to ¼-pel precision first before signaling.

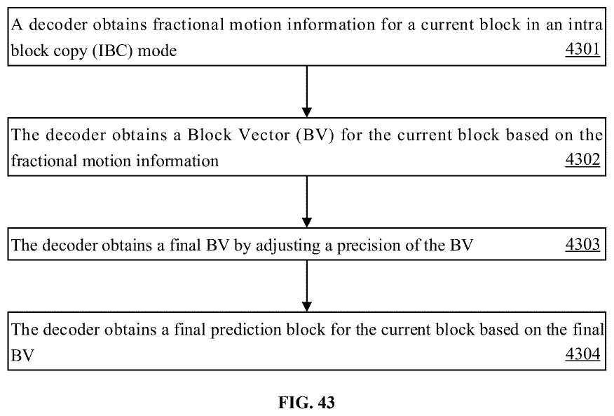

FIG. 43 is a flowchart illustrating a method for video decoding according to an example of the present disclosure. Specifically, FIG. 43 shows methods discussed in the section of “Fractional motion search.”

In Step 4301, the processor 2020, at the side of a decoder, may obtain fractional motion information for a current block in an IBC mode.

In some examples, the fractional motion information may be determined using the three steps as discussed in the section of “Fractional motion search,” including: searching a first number of integer BVs with a minimum distortion cost; applying half-pel refinement around each of the first number of integer BVs by obtaining a second number of best half-pel positions for each of the first number of integer BVs, where the second number of best half-pel positions indicate the second number of half-pel BV differences having a lowest rate distortion cost; obtaining quarter-pel refinement by applying quarter-pel refinement around the second number of best half-pel positions for each of the first number of integer BVs; and obtaining the fractional motion information based on the quarter-pel refinement.

In some examples, searching the first number of integer BVs with the minimum distortion cost may include: searching the first number of integer BVs with the minimum distortion cost according to a threshold. For example, the best SAD (sum of absolute differences) or SATD (sum of absolute transformed differences) cost of using other coding modes (e.g., other intra coding modes such as angular modes, planar mode) for the current coding block is used as a threshold for early termination of the current fractional motion search. In one example, given that the current best SAD or SATD cost from other coding modes is X, a predefined threshold factor is f (e.g., an example value could be 1.1, 1.2, 1.21, etc.), and the best SAD or SATD cost from current integer motion search of IBC mode is Y, if Y>=f*X, the subsequent fractional motion search may be simplified (e.g., the N best integer motion vectors for further fractional refinement may be reduced to N′, and N′<N) or skipped (e.g., the N best integer motion vectors for further fractional refinement may be reduced to 0). The value of N,N′ and f, may be predefined or signaled or adaptively determined (e.g., based on the texture richness of the current coding block).

In some other examples, searching the first number of integer BVs with the minimum distortion cost may include: simplifying or skipping searching the first number of integer BVs according to one or more other coding modes of the current block. In some examples, simplifying searching the first number of integer BVs according to the one or more other coding modes of the current block may include: decreasing the first number to an integer number less than the first number, where the first number and the integer number are predefined or determined based on texture richness of the current block; or searching the first number of integer BVs based on a history search process of the current block or a different block. For example, the first number N may be decreased to the integer number N′, the N best integer motion vectors selected for further fractional refinement may be reduced to N′, where N′<N, as discussed in the section of “Fractional motion search.” Further, the N best integer motion vectors selected for further fractional refinement may not be from only the current integer search process, but also come from the previous integer and/or fractional search process (history search process) of the same current block/coding block or different coding blocks.

In some other examples, searching the first number of integer BVs with the minimum distortion cost may include: determining a sum of absolute differences (SAD) cost or a sum of absolute transformed differences (SATD) cost from the one or more other coding modes of the current block; and determining the minimum distortion cost based on a predefined threshold factor and one of the SAD cost or the SATD cost.

In Step 4302, the processor 2020, at the side of the decoder, may obtain a BV for the current block based on the fractional motion information.

In Step 4303, the processor 2020, at the side of the decoder, may obtain a final BV by adjusting a precision of the BV.

In some examples, a syntax element may be signaled and received by the processor 2020 at the side of the decoder, which indicates the precision of the BV.

In some examples, adjusting a precision of the BV may be implemented by the following steps: determining a highest precision of the BV; in response to determining that the highest precision of the BV is half-pel, obtaining the final BV by adjusting the precision of the BV in one of following manners: adjusting a precision of the final BV to quarter-pel; or maintaining the precision of the final BV as half-pel.

In Step 4304, the processor 2020, at the side of the decoder, may obtain a final prediction block for the current block based on the final BV.

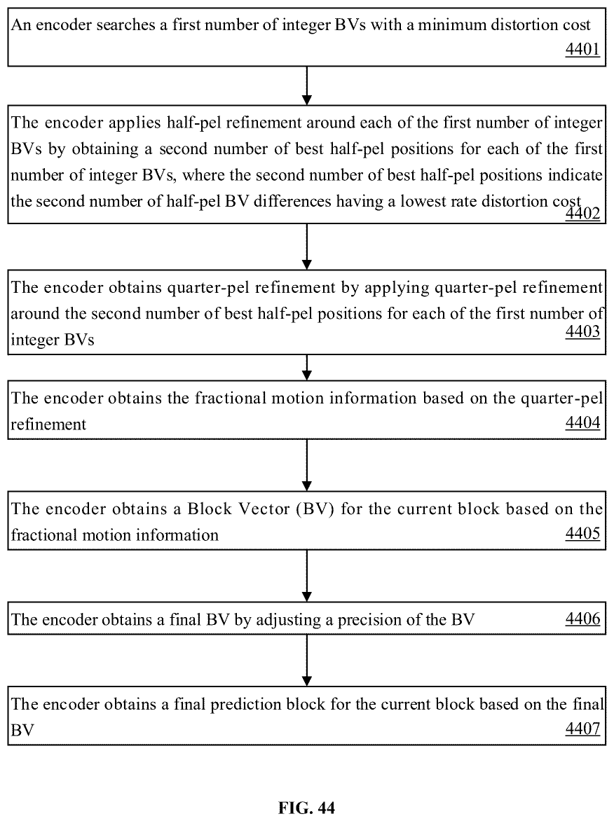

FIG. 44 is a flowchart illustrating a method for video encoding corresponding to the method for video decoding as shown in FIG. 43 according to an example of the present disclosure.

In Step 4401, the processor 2020, at the side of an encoder, may search a first number of integer BVs with a minimum distortion cost.

In some examples, searching the first number of integer BVs with the minimum distortion cost may include: searching the first number of integer BVs with the minimum distortion cost according to a threshold. For example, the best SAD (sum of absolute differences) or SATD (sum of absolute transformed differences) cost of using other coding modes (e.g., other intra coding modes such as angular modes, planar mode) for the current coding block is used as a threshold for early termination of the current fractional motion search. In one example, given that the current best SAD or SATD cost from other coding modes is X, a predefined threshold factor is f (e.g., an example value could be 1.1, 1.2, 1.21, etc.), and the best SAD or SATD cost from current integer motion search of IBC mode is Y, if Y>=f*X, the subsequent fractional motion search may be simplified (e.g., the N best integer motion vectors for further fractional refinement may be reduced to N′, and N′<N) or skipped (e.g., the N best integer motion vectors for further fractional refinement may be reduced to 0). The value of N,N′ and f, may be predefined or signaled or adaptively determined (e.g., based on the texture richness of the current coding block).

In some other examples, searching the first number of integer BVs with the minimum distortion cost may include: simplifying or skipping searching the first number of integer BVs according to one or more other coding modes of the current block. In some examples, simplifying searching the first number of integer BVs according to the one or more other coding modes of the current block may include: decreasing the first number to an integer number less than the first number, where the first number and the integer number are predefined or determined based on texture richness of the current block; or searching the first number of integer BVs based on a history search process of the current block or a different block. For example, the first number N may be decreased to the integer number N′, the N best integer motion vectors selected for further fractional refinement may be reduced to N′, where N′<N, as discussed in the section of “Fractional motion search.” Further, the N best integer motion vectors selected for further fractional refinement may not be from only the current integer search process, but also come from the previous integer and/or fractional search process (history search process) of the same current block/coding block or different coding blocks.

In some other examples, searching the first number of integer BVs with the minimum distortion cost may include: determining a sum of absolute differences (SAD) cost or a sum of absolute transformed differences (SATD) cost from the one or more other coding modes of the current block; and determining the minimum distortion cost based on a predefined threshold factor and one of the SAD cost or the SATD cost.

In Step 4402, the processor 2020, at the side of the encoder, may apply half-pel refinement around each of the first number of integer BVs by obtaining a second number of best half-pel positions for each of the first number of integer BVs, where the second number of best half-pel positions indicate the second number of half-pel BV differences having a lowest rate distortion cost.

In Step 4403, the processor 2020, at the side of the encoder, may obtain quarter-pel refinement by applying quarter-pel refinement around the second number of best half-pel positions for each of the first number of integer BVs.

In Step 4404, the processor 2020, at the side of the encoder, may obtain fractional motion information based on the quarter-pel refinement.

In Step 4405, the processor 2020, at the side of the encoder, may obtain a BV for a current block based on the fractional motion information.

In Step 4406, the processor 2020, at the side of the encoder, may obtain a final BV by adjusting a precision of the BV.

In some examples, a syntax element may be signaled by the encoder which indicates the precision of the BV.

In some examples, adjusting a precision of the BV may be implemented by the following steps: determining a highest precision of the BV; in response to determining that the highest precision of the BV is half-pel, obtaining the final BV by adjusting the precision of the BV in one of following manners: adjusting a precision of the final BV to quarter-pel; or maintaining the precision of the final BV as half-pel.

In Step 4407, the processor 2020, at the side of the encoder, may obtain a final prediction block for the current block based on the final BV.

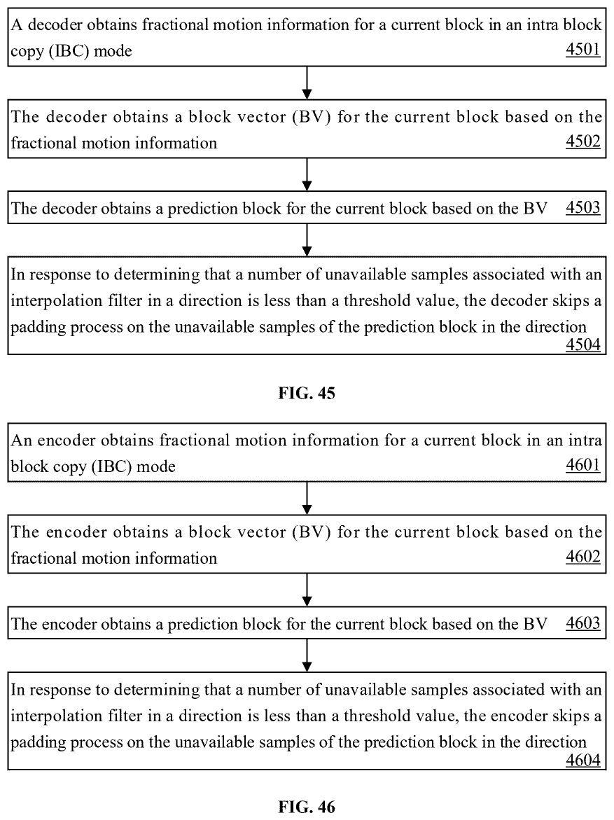

FIG. 45 is a flowchart illustrating a method for video decoding according to an example of the present disclosure. Specifically, FIG. 45 shows methods discussed in the sections of “Conditional sample/pixel padding for fractional interpolation,” “Interpolation filter switch,” and “Multi-hypothesis fractional intra block copy.”

In Step 4501, the processor 2020, at the side of a decoder, may obtain fractional motion information for a current block in an IBC mode.

In Step 4502, the processor 2020, at the side of the decoder, may obtain a BV for the current block based on the fractional motion information.

In Step 4503, the processor 2020, at the side of the decoder, may obtain a prediction block for the current block based on the BV.

In Step 4504, the processor 2020, at the side of the decoder, may skip a padding process on the unavailable samples of the prediction block in a direction in response to determining that a number of unavailable samples associated with an interpolation filter in the direction is less than a threshold value.

In some examples, the threshold value may be predefined or signaled, and the direction may be a horizontal direction or a vertical direction.

In some examples, the interpolation filter may be a 12-tap interpolation filter, and the threshold value is 2. For example, given a 12-tap interpolation filter, the number of the top and left samples needed for interpolation is 5, while the number of the bottom and right samples needed for interpolation is 6. If the number of unavailable samples needed for interpolation process at horizontal direction (left and right side) or vertical direction (top and bottom side) is less than 2, then the padding process at one direction may be skipped.

In some examples, the processor 2020 may apply the interpolation filter with a specific tap length based on a block size of the current block.

In some examples, the processor 2020 may apply the interpolation filter with the specific tap length that is smaller than a threshold tap length in response to determining that the block size of the current block is smaller than a threshold size which may be predefined.

In some examples, for small blocks, shorter interpolation filter length or even no interpolation is applied, as discussed in the section of “Interpolation filter switch.”

In one or more examples where luma and chroma components have different ratio, such as YUV420 video format, the sizes of small blocks may be defined different for different components. For example, the processor 2020 may apply the interpolation filter with the specific tap length that is smaller than a chroma threshold tap length on the chroma component in response to determining that a chroma size of a chroma component of the current block is smaller than a chroma threshold size; the processor 2020 may apply the interpolation filter with the specific tap length that is smaller than a luma threshold tap length on the luma component in response to determining that a luma size of a luma component of the current block is smaller than a luma threshold size.

In some examples, multi-hypothesis fractional intra block copy may be applied. The number of multi-hypothesis may be equal to 2. In this case, the currently uni-predicted IBC mode may be extended to bi-predicted IBC mode. The decoder may combine 2 hypothesis corresponding to 2 BVs to obtain a final prediction result.

In one or more examples, the processor 2020, at the decoder side, may obtain a first BV and a second BV for the current block based on the fractional motion information, where the current block is in bi-predicted IBC mode; obtain a first reference block associated with the first BV and a second reference block associated with the second BV; and obtain the prediction block for the current block by weighted-averaging the first reference block and the second reference block based on a first weight associated with the first BV and a second weight associated with the second BV.

In some examples, the first weight and the second weight may be obtained by one of following manners: inheriting form spatial neighboring blocks of the current block; reusing same weights used for an inter-predicted block; receiving, by the processor at the decoder side, from a bitstream; or deriving, by the processor at the decoder sider, without signaling.

FIG. 46 is a flowchart illustrating a method for video encoding corresponding to the method illustrated in FIG. 45 according to an example of the present disclosure.

In Step 4601, the processor 2020, at the side of an encoder, may obtain fractional motion information for a current block in an IBC mode.

In Step 4602, the processor 2020, at the side of the encoder, may obtain a BV for the current block based on the fractional motion information.

In Step 4603, the processor 2020, at the side of the encoder, may obtain a prediction block for the current block based on the BV.

In Step 4604, the processor 2020, at the side of the encoder, may skip a padding process on the unavailable samples of the prediction block in a direction in response to determining that a number of unavailable samples associated with an interpolation filter in the direction is less than a threshold value.

In some examples, the threshold value may be predefined or signaled, and the direction may be a horizontal direction or a vertical direction.

In some examples, the interpolation filter may be a 12-tap interpolation filter, and the threshold value is 2. For example, given a 12-tap interpolation filter, the number of the top and left samples needed for interpolation is 5, while the number of the bottom and right samples needed for interpolation is 6. If the number of unavailable samples needed for interpolation process at horizontal direction (left and right side) or vertical direction (top and bottom side) is less than 2, then the padding process at one direction may be skipped.

In some examples, the processor 2020 may apply the interpolation filter with a specific tap length based on a block size of the current block.

In some examples, the processor 2020 may apply the interpolation filter with the specific tap length that is smaller than a threshold tap length in response to determining that the block size of the current block is smaller than a threshold size which may be predefined.

In some examples, for small blocks, shorter interpolation filter length or even no interpolation is applied, as discussed in the section of “Interpolation filter switch.”

In one or more examples where luma and chroma components have different ratio, such as YUV420 video format, the sizes of small blocks may be defined different for different components. For example, the processor 2020 may apply the interpolation filter with the specific tap length that is smaller than a chroma threshold tap length on the chroma component in response to determining that a chroma size of a chroma component of the current block is smaller than a chroma threshold size; the processor 2020 may apply the interpolation filter with the specific tap length that is smaller than a luma threshold tap length on the luma component in response to determining that a luma size of a luma component of the current block is smaller than a luma threshold size.

In some examples, multi-hypothesis fractional intra block copy may be applied. The number of multi-hypothesis may be equal to 2. In this case, the currently uni-predicted IBC mode may be extended to bi-predicted IBC mode. The encoder may combine 2 hypothesis corresponding to 2 BVs to obtain a final prediction result.

In one or more examples, the processor 2020, at the encoder side, may obtain a first BV and a second BV for the current block based on the fractional motion information, where the current block is in bi-predicted IBC mode; obtain a first reference block associated with the first BV and a second reference block associated with the second BV; and obtain the prediction block for the current block by weighted-averaging the first reference block and the second reference block based on a first weight associated with the first BV and a second weight associated with the second BV.

In some examples, the first weight and the second weight may be obtained by one of following manners: inheriting form spatial neighboring blocks of the current block; reusing same weights used for an inter-predicted block; signaling, by the processor at the encoder side, a bitstream.

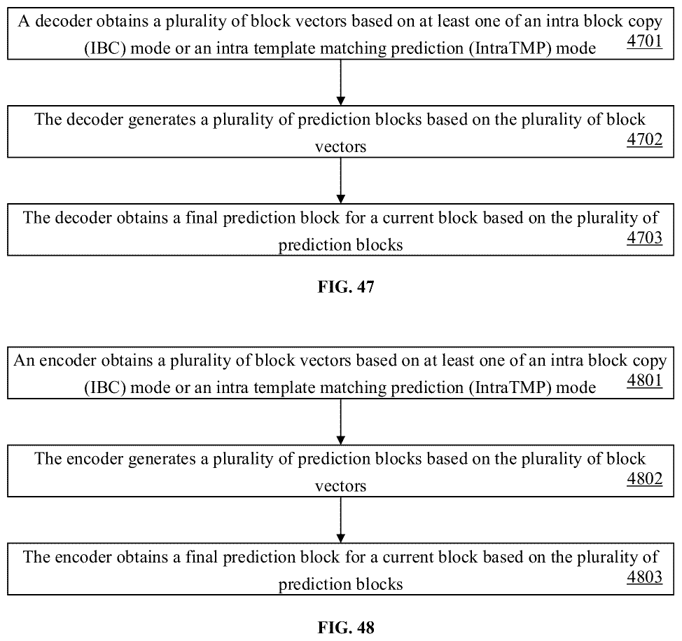

FIG. 47 is a flowchart illustrating a method for video decoding according to an example of the present disclosure. Specifically, FIG. 47 shows methods discussed in the section of “Combination with intra template matching.”

In Step 4701, the processor 2020, at the side of a decoder, may obtain a plurality of block vectors based on at least one of an intra block copy (IBC) mode or an intra template matching prediction (IntraTMP) mode.

In the case of multi-hypothesis mode, the IBC encoder may generate multiple prediction blocks based on searching multiple block vectors. For IBC-AMVP mode, the corresponding multiple block vectors may be signaled to the decoder side by a combination of block vector predictor indexes and block vector differences. For IBC-merge mode, the corresponding multiple block vectors may be signaled to the decoder side by a group of candidate indexes from a constructed merge candidate list. In one or more examples, the processor 2020 may receive information related to one or more block vectors based on the IBC mode from a bitstream. For example, the processor 2020 may receive a plurality of block vector predictor indexes and block vector differences in response to determining that the one or more block vectors are in an intra block copy-advanced motion vector prediction (IBC-AMVP) mode, where the plurality of block vector predictor indexes and block vector differences indicate the one or more block vectors; or receive a plurality of block vector candidate indexes from a constructed merge candidate list in response to determining that the one or more block vectors are in an IBC-merge mode, where the plurality of block vector candidate indexes indicate the one or more block vectors.

In some examples, the IntraTMP mode may be unified with or replaced by the IBC mode. In one or more examples, the processor 2020 may derive one or more block vectors based on the IntraTMP mode. In one example, the processor 2020 may derive one or more initial block vectors based on an intra block copy-template matching (IBC-TM) mode and derive the one or more block vectors by applying the IntraTMP mode to the one or more initial block vectors.

In another example, the processor 2020 may receive an IBC list including zero block vector, where the IBC list may include one of an IBC-AMVP list or an IBC-merge list; and derive the one or more block vectors by applying the IntraTMP mode to the zero block vector.

In Step 4702, the processor 2020, at the side of the decoder, may generate α plurality of prediction blocks based on the plurality of block vectors.

In Step 4703, the processor 2020, at the side of the decoder, may obtain a final prediction block for a current block based on the plurality of prediction blocks.

FIG. 48 is a flowchart illustrating a method for video encoding corresponding to the method for video decoding as shown in FIG. 47 in accordance with some examples of the present disclosure.

In Step 4801, the processor 2020, at the side of an encoder, may obtain a plurality of block vectors based on at least one of an intra block copy (IBC) mode or an intra template matching prediction (IntraTMP) mode.

In the case of multi-hypothesis mode, the IBC encoder may generate multiple prediction blocks based on searching multiple block vectors. For IBC-AMVP mode, the corresponding multiple block vectors may be signaled to the decoder side by a combination of block vector predictor indexes and block vector differences. For IBC-merge mode, the corresponding multiple block vectors may be signaled to the decoder side by a group of candidate indexes from a constructed merge candidate list. In one or more examples, the processor 2020 may signal information related to one or more block vectors based on the IBC mode. For example, the processor 2020 may signal a plurality of block vector predictor indexes and block vector differences in response to determining that the one or more block vectors are in an intra block copy
advanced motion vector prediction (IBC-AMVP) mode, where the plurality of block vector predictor indexes and block vector differences indicate the one or more block vectors; or signal a plurality of block vector candidate indexes from a constructed merge candidate list in response to determining that the one or more block vectors are in an IBC-merge mode, where the plurality of block vector candidate indexes indicate the one or more block vectors.

In some examples, the IntraTMP mode may be unified with or replaced by the IBC mode. In one or more examples, the processor 2020 may derive one or more block vectors based on the IntraTMP mode. In one example, the processor 2020 may derive one or more initial block vectors based on an intra block copy-template matching (IBC-TM) mode and derive the one or more block vectors by applying the IntraTMP mode to the one or more initial block vectors.

In another example, the processor 2020 may generate an IBC list including zero block vector, where the IBC list may include one of an IBC-AMVP list or an IBC-merge list; and derive the one or more block vectors by applying the IntraTMP mode to the zero block vector.

In Step 4802, the processor 2020, at the side of the encoder, may generate α plurality of prediction blocks based on the plurality of block vectors.

In Step 4803, the processor 2020, at the side of the encoder, may obtain a final prediction block for a current block based on the plurality of prediction blocks.

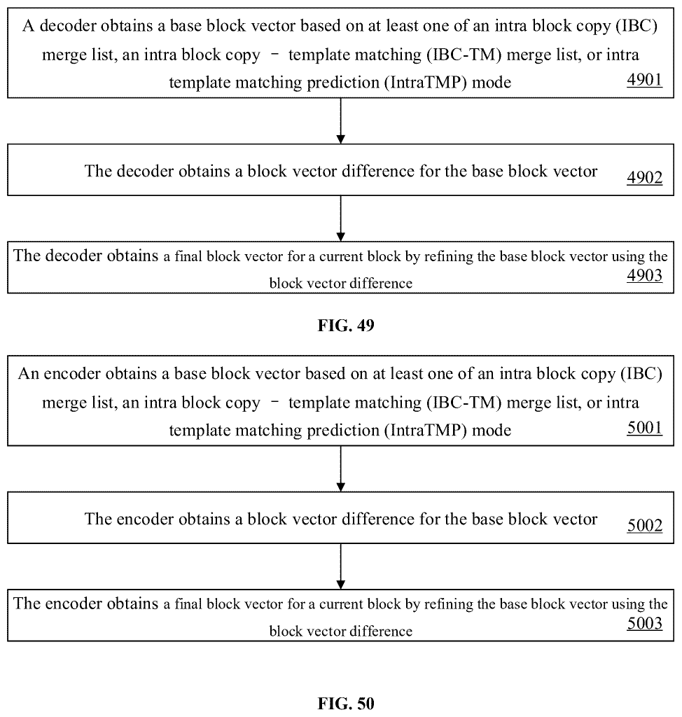

FIG. 49 is a flowchart illustrating a method for video decoding according to an example of the present disclosure. Specifically, FIG. 49 shows methods discussed in the section of “Combination with IBC merge mode with block vector differences.”

In Step 4901, the processor 2020, at the side of a decoder, may obtain a base block vector based on at least one of an intra block copy (IBC) merge list, an intra block copy-template matching (IBC-TM) merge list, or intra template matching prediction (IntraTMP) mode.

For example, the base candidates may be selected from the IBC merge list and/or IBC-TM merge list, where candidates in the IBC-TM merge list may be constructed by refining the candidates in the IBC merge list with the template matching method prior to the encoding process and the decoding process. IBC-MBVD may also be combined with the Intra template matching prediction (Intra TMP) mode.

In some examples, the processor 2020 may generate α first merge list based on the IBC merge list and the IBC-TM merge list and obtain the base block vector from the first merge list. In one or more examples, the first merge list may be generated by obtaining a reordered IBC merge list and a reordered IBC-TM merge list by respectively reordering the IBC merge list and the IBC-TM merge list, selecting a first number of block vectors from the reordered IBC merge list, selecting a second number of block vectors from the reordered IBC-TM merge list, and generating the first merge list based on the first number of block vectors from the reordered IBC merge list and the second number of block vectors from the reordered IBC-TM merge list. Furthermore, the first merge list may be obtained by obtaining a combined merge list by combining the first merge list based on the first number of block vectors from the reordered IBC merge list and the second number of block vectors from the reordered IBC-TM merge list and generating the first merge list by punning the combined merge list.

In one or more examples, the first merge list may be generated by obtaining a combined merge list by combining the IBC merge list and the IBC-TM merge list; obtaining a reordered IBC merge list by reordering the combined merge list based on template matching; and generating the first merge list by pruning the reordered IBC merge list.

In some examples, the processor 2020 may receive a syntax element that indicates whether the base block vector is from the IBC merge list or the IBC-TM merge list. In response to receiving the syntax element that indicates the base block vector is from the IBC merge list, the processor 2020 may obtain the base block vector from the IBC merge list. In response to receiving the syntax element that indicates the base block vector is from the IBC-TM merge list, processor 2020 may obtain the base block vector from the IBC-TM merge list. The syntax element may be an existing IBC-TM flag or an extra flag that indicates whether the base block vector is from the IBC merge list or the IBC-TM merge list.

In some examples, the processor 2020 may obtain an initial base block vector based on the at least one of the IBC merge list, the IBC-TM merge list, or the IntraTMP mode; determine whether the initial base block vector is a fractional block vector; and in response to determining that the initial base block vector is a fractional block vector, obtain the base block vector by adjusting the initial base block vector to be an integer block vector.

In some examples, the processor 2020 may derive the base block vector based on the IntraTMP mode by searching templates similar to a current template of the current block.

In Step 4902, the processor 2020, at the side of the decoder, may obtain a block vector difference for the base block vector.

In Step 4903, the processor 2020, at the side of the decoder, may obtain a final block vector for a current block by refining the base block vector using the block vector difference.

FIG. 50 is a flowchart illustrating a method for video encoding corresponding to the method for video decoding as shown in FIG. 49 according to an example of the present disclosure.

In Step 5001, the processor 2020, at the side of an encoder, may obtain a base block vector based on at least one of an intra block copy (IBC) merge list, an intra block copy-template matching (IBC-TM) merge list, or intra template matching prediction (IntraTMP) mode.

For example, the base candidates may be selected from the IBC merge list and/or IBC-TM merge list, where candidates in the IBC-TM merge list may be constructed by refining the candidates in the IBC merge list with the template matching method prior to the encoding process and the decoding process. IBC-MBVD may also be combined with the Intra template matching prediction (Intra TMP) mode.

In some examples, the processor 2020 may generate α first merge list based on the IBC merge list and the IBC-TM merge list and obtain the base block vector from the first merge list. In one or more examples, the first merge list may be generated by obtaining a reordered IBC merge list and a reordered IBC-TM merge list by respectively reordering the IBC merge list and the IBC-TM merge list, selecting a first number of block vectors from the reordered IBC merge list, selecting a second number of block vectors from the reordered IBC-TM merge list, and generating the first merge list based on the first number of block vectors from the reordered IBC merge list and the second number of block vectors from the reordered IBC-TM merge list. Furthermore, the first merge list may be obtained by obtaining a combined merge list by combining the first merge list based on the first number of block vectors from the reordered IBC merge list and the second number of block vectors from the reordered IBC-TM merge list and generating the first merge list by punning the combined merge list.

In one or more examples, the first merge list may be generated by obtaining a combined merge list by combining the IBC merge list and the IBC-TM merge list; obtaining a reordered IBC merge list by reordering the combined merge list based on template matching; and generating the first merge list by pruning the reordered IBC merge list.

In some examples, the processor 2020 may signal a syntax element that indicates whether the base block vector is from the IBC merge list or the IBC-TM merge list. In response to determining the syntax element that indicates the base block vector is from the IBC merge list, the processor 2020 may obtain the base block vector from the IBC merge list. In response to determining the syntax element that indicates the base block vector is from the IBC-TM merge list, processor 2020 may obtain the base block vector from the IBC-TM merge list. The syntax element may be an existing IBC-TM flag or an extra flag that indicates whether the base block vector is from the IBC merge list or the IBC-TM merge list.

In some examples, the processor 2020 may obtain an initial base block vector based on the at least one of the IBC merge list, the IBC-TM merge list, or the IntraTMP mode; determine whether the initial base block vector is a fractional block vector; and in response to determining that the initial base block vector is a fractional block vector, obtain the base block vector by adjusting the initial base block vector to be an integer block vector.

In some examples, the processor 2020 may derive the base block vector based on the IntraTMP mode by searching templates similar to a current template of the current block.

In Step 5002, the processor 2020, at the side of the encoder, may obtain a block vector difference for the base block vector.

In Step 5003, the processor 2020, at the side of the encoder, may obtain a final block vector for a current block by refining the base block vector using the block vector difference.

The description of the present disclosure has been presented for purposes of illustration and is not intended to be exhaustive or limited to the present disclosure. Many modifications, variations, and alternative implementations will be apparent to those of ordinary skill in the art having the benefit of the teachings presented in the foregoing descriptions and the associated drawings.

Unless specifically stated otherwise, an order of steps of the method according to the present disclosure is only intended to be illustrative, and the steps of the method according to the present disclosure are not limited to the order specifically described above, but may be changed according to practical conditions. In addition, at least one of the steps of the method according to the present disclosure may be adjusted, combined or deleted according to practical requirements.

The examples were chosen and described in order to explain the principles of the disclosure and to enable others skilled in the art to understand the disclosure for various implementations and to best utilize the underlying principles and various implementations with various modifications as are suited to the particular use contemplated. Therefore, it is to be understood that the scope of the disclosure is not to be limited to the specific examples of the implementations disclosed and that modifications and other implementations are intended to be included within the scope of the present disclosure.

According to some embodiments of the present disclosure, there is provided a method for video decoding. In the method, a decoder may obtain a syntax element that is related to Intra Block Copy (IBC) mode, and signal jointly or separately the syntax element with Context Adaptive Binary Arithmetic Coding (CABAC) using different context bins for different slice types, different fame types, different video components, or different video resolutions.

According to some embodiments of the present disclosure, there is provided a method for video decoding. In the method, a decoder may obtain fractional motion information for a current block in an intra block copy (IBC) mode; obtain a block vector (BV) for the current block based on the fractional motion information; obtain a prediction block for the current block based on the BV; and in response to meeting a condition, conduct, or skip partially or fully, by the decoder, a padding process on one or more samples associated with an interpolation filter.

According to some embodiments of the present disclosure, there is provided a method for video decoding. In the method, a decoder may obtain fractional motion information for a current block in an intra block copy (IBC) mode; obtain a block vector (BV) for the current block based on the fractional motion information; obtain a prediction block for the current block based on the BV; and in response to meeting a condition, determine an interpolation filter, or skip an interpolation process, wherein the condition is configured to indicate whether to switch the interpolation filter or skip an interpolation process, and the interpolation filter is to be applied on the prediction block to obtain a filtered prediction for the current block.

According to some embodiments of the present disclosure, there is provided a method for video decoding. In the method, a decoder may obtain a plurality of base candidates from an intra block copy (IBC) merge list; obtain a plurality of merge mode with block vector difference (MBVD) refinement positions for each base candidate based on at least one candidate distance set; reorder the plurality of MBVD refinement positions; select a first number of MBVD refinement positions with a lowest template SAD cost; and obtain a block vector difference based on the first number of MBVD refinement positions, wherein the at least one candidate distance set comprises any one or any combination of following sets: {¼-pel, ½-pel, 1-pel, 2-pel, 3-pel, 4-pel, 6-pel, 8-pel, 10-pel, 12-pel, 14-pel, 16-pel, 18-pel, 20-pel, 22-pel, 24-pel, 26-pel, 28-pel, 30-pel, 32-pel}; {½-pel, 1-pel, 2-pel, 3-pel, 4-pel, 6-pel, 8-pel, 10-pel, 12-pel, 16-pel, 20-pel, 24-pel, 28-pel, 32-pel, 36-pel, 40-pel, 44-pel, 48-pel, 52-pel, 56-pel}; {½-pel, 1-pel, 2-pel, 3-pel, 4-pel, 6-pel, 8-pel, 10-pel, 12-pel, 14-pel, 16-pel, 18-pel, 20-pel, 22-pel, 24-pel, 26-pel, 28-pel, 30-pel, 32-pel, 34-pel}; or, {1-pel, 2-pel, 4-pel, 6-pel, 8-pel, 12-pel, 16-pel, 20-pel, 24-pel, 32-pel, 40-pel, 48-pel, 56-pel, 64-pel, 72-pel, 80-pel, 88-pel, 96-pel, 104-pel, 112-pel}.

According to some embodiments of the present disclosure, there is provided a method for video decoding. In the method, a decoder may obtain fractional motion information for a current block in an intra block copy (IBC) mode; obtain a block vector (BV) for the current block based on the fractional motion information; obtain a prediction block for the current block based on the BV; obtain a reference template based on the BV and a template of the current block; derive parameters of a linear filterer based on the reference template; and apply the linear filterer on the prediction block to obtain a filtered prediction for the current block.

According to some embodiments of the present disclosure, there is provided a method for video decoding. In the method, a decoder may obtain fractional motion information for a plurality of luma blocks collocated at a plurality of predefined positions relative to a position of a current chroma block in intra block copy (IBC) mode; obtain a plurality of luma block vectors (BVs) of the plurality of luma blocks based on the fractional motion information; determine a chroma BV based on the plurality of luma BVs of the plurality of luma blocks; and obtain a prediction chroma block based on the chroma BV.

According to some embodiments of the present disclosure, there is provided a method for video decoding. In the method, a decoder may obtain fractional motion information for a current block in an intra block copy (IBC) mode; obtain a block vector (BV) for the current block based on the fractional motion information; in response to applying a Reconstruction-Reordered IBC (RRIBC) mode, set, by the decoder, a horizontal component or a vertical component of the BV as zero according to a flip type of the RRIBC mode; and obtain a prediction block for the current block based on the BV.

According to some embodiments of the present disclosure, there is provided a method for video decoding. In the method, a decoder may obtain fractional motion information for a current block in an intra block copy (IBC) mode; obtain a block vector (BV) for the current block based on the fractional motion information; in response to applying a Block Vector Predictor Candidates clustering and Block Vector Difference sign derivation for Reconstruction-Reordered IBC (IBC-BVPC) mode and an IBC Advanced Motion Vector Prediction (AMVP) mode, skip a motion refinement process on the BV, or skip a motion refinement process on a null component of the BV, the null component of the BV comprising a horizontal component or a vertical component; and obtain a prediction block for the current block based on the BV.

According to some embodiments of the present disclosure, there is provided a method for video decoding. In the method, a decoder may obtain magnitude of block vector difference (BVD) components, each of the BVD components comprising an integer BVD component part and a fractional BVD component part; obtain context-coded BVD sign prediction indexes; obtain a plurality of BV candidates by creating combination between BVD signs and absolute BVD values and adding the combination into BV predictors, each BV candidate comprises an integer part and a fractional part; derive a BVD sign prediction cost for each BV candidate based on template matching cost; sort the plurality of BV candidates based on the BVD sign prediction cost; and derive a BVD sign prediction index corresponding to a true BVD sign.

According to some embodiments of the present disclosure, there is provided a method for video decoding. In the method, a decoder may obtain a pairwise intra block copy (IBC) candidate based on at least two precious IBC candidates in a candidate list of an IBC Merge mode or an IBC Advanced Motion Vector Prediction (AMVP) mode; and determine a corresponding attribution of the pairwise IBC candidate associated with attributions of the two precious IBC candidates.

According to some embodiments of the present disclosure, there is provided a method for video encoding. In the method, an encoder may obtain a syntax element that is related to Intra Block Copy (IBC) mode, and signal jointly or separately the syntax element with Context Adaptive Binary Arithmetic Coding (CABAC) using different context bins for different slice types, different fame types, different video components, or different video resolutions.

According to some embodiments of the present disclosure, there is provided a method for video encoding. In the method, an encoder may obtain fractional motion information for a current block in an intra block copy (IBC) mode; obtain a block vector (BV) for the current block based on the fractional motion information; obtain a prediction block for the current block based on the BV; and in response to meeting a condition, conduct, or skip partially or fully, by the encoder, a padding process on one or more samples associated with an interpolation filter.

According to some embodiments of the present disclosure, there is provided a method for video encoding. In the method, an encoder may obtain fractional motion information for a current block in an intra block copy (IBC) mode; obtain a block vector (BV) for the current block based on the fractional motion information; obtain a prediction block for the current block based on the BV; and in response to meeting a condition, determine an interpolation filter, or skip an interpolation process, wherein the condition is configured to indicate whether to switch the interpolation filter or skip an interpolation process, and the interpolation filter is to be applied on the prediction block to obtain a filtered prediction for the current block.

According to some embodiments of the present disclosure, there is provided a method for video encoding. In the method, an encoder may obtain a plurality of base candidates from an intra block copy (IBC) merge list; obtain a plurality of merge mode with block vector difference (MBVD) refinement positions for each base candidate based on at least one candidate distance set; reorder the plurality of MBVD refinement positions; select a first number of MBVD refinement positions with a lowest template SAD cost; and obtain a block vector difference based on the first number of MBVD refinement positions, wherein the at least one candidate distance set comprises any one or any combination of following sets: {¼-pel, ½-pel, 1-pel, 2-pel, 3-pel, 4-pel, 6-pel, 8-pel, 10-pel, 12-pel, 14-pel, 16-pel, 18-pel, 20-pel, 22-pel, 24-pel, 26-pel, 28-pel, 30-pel, 32-pel}; {½-pel, 1-pel, 2-pel, 3-pel, 4-pel, 6-pel, 8-pel, 10-pel, 12-pel, 16-pel, 20-pel, 24-pel, 28-pel, 32-pel, 36-pel, 40-pel, 44-pel, 48-pel, 52-pel, 56-pel}; {½-pel, 1-pel, 2-pel, 3-pel, 4-pel, 6-pel, 8-pel, 10-pel, 12-pel, 14-pel, 16-pel, 18-pel, 20-pel, 22-pel, 24-pel, 26-pel, 28-pel, 30-pel, 32-pel, 34-pel}; or, {1-pel, 2-pel, 4-pel, 6-pel, 8-pel, 12-pel, 16-pel, 20-pel, 24-pel, 32-pel, 40-pel, 48-pel, 56-pel, 64-pel, 72-pel, 80-pel, 88-pel, 96-pel, 104-pel, 112-pel}.

According to some embodiments of the present disclosure, there is provided a method for video encoding. In the method, an encoder may obtain fractional motion information for a current block in an intra block copy (IBC) mode; obtain a block vector (BV) for the current block based on the fractional motion information; obtain a prediction block for the current block based on the BV; obtain a reference template based on the BV and a template of the current block; derive parameters of a linear filterer based on the reference template; and apply the linear filterer on the prediction block to obtain a filtered prediction for the current block.

According to some embodiments of the present disclosure, there is provided a method for video encoding. In the method, an encoder may obtain fractional motion information for a plurality of luma blocks collocated at a plurality of predefined positions relative to a position of a current chroma block in intra block copy (IBC) mode; obtain a plurality of luma block vectors (BVs) of the plurality of luma blocks based on the fractional motion information; determine a chroma BV based on the plurality of luma BVs of the plurality of luma blocks; and obtain a prediction chroma block based on the chroma BV.

According to some embodiments of the present disclosure, there is provided a method for video encoding. In the method, an encoder may obtain fractional motion information for a current block in an intra block copy (IBC) mode; obtain a block vector (BV) for the current block based on the fractional motion information; in response to applying a Reconstruction-Reordered IBC (RRIBC) mode, set, by the encoder, a horizontal component or a vertical component of the BV as zero according to a flip type of the RRIBC mode; and obtain a prediction block for the current block based on the BV.

According to some embodiments of the present disclosure, there is provided a method for video encoding. In the method, an encoder may obtain fractional motion information for a current block in an intra block copy (IBC) mode; obtain a block vector (BV) for the current block based on the fractional motion information; in response to applying a Block Vector Predictor Candidates clustering and Block Vector Difference sign derivation for Reconstruction-Reordered IBC (IBC-BVPC) mode and an IBC Advanced Motion Vector Prediction (AMVP) mode, skip a fractional motion estimation process on the BV, or skip a fractional motion estimation process on a null component of the BV, the null component of the BV comprising a horizontal component or a vertical component; and obtain a prediction block for the current block based on the BV.

According to some embodiments of the present disclosure, there is provided a method for video encoding. In the method, an encoder may obtain magnitude of block vector difference (BVD) components, each of the BVD components comprising an integer BVD component part and a fractional BVD component part; obtain context-coded BVD sign prediction indexes; obtain a plurality of BV candidates by creating combination between BVD signs and absolute BVD values and adding the combination into BV predictors, each BV candidate comprises an integer part and a fractional part; derive a BVD sign prediction cost for each BV candidate based on template matching cost; sort the plurality of BV candidates based on the BVD sign prediction cost; and derive a BVD sign prediction index corresponding to a true BVD sign.

According to some embodiments of the present disclosure, there is provided a method for video encoding. In the method, an encoder may obtain a pairwise intra block copy (IBC) candidate based on at least two precious IBC candidates in a candidate list of an IBC Merge mode or an IBC Advanced Motion Vector Prediction (AMVP) mode; and determine a corresponding attribution of the pairwise IBC candidate associated with attributions of the two precious IBC candidates.

Some embodiments of the present disclosure provide an apparatus for video decoding. The apparatus may include one or more processors and a memory coupled to the one or more processors and configured to store instructions executable by the one or more processors. Furthermore, the one or more processors, upon execution of the instructions, are configured to perform the method according to the embodiments.

Some embodiments of the present disclosure provide an apparatus for video encoding. The apparatus may include one or more processors and a memory coupled to the one or more processors and configured to store instructions executable by the one or more processors. Furthermore, the one or more processors, upon execution of the instructions, are configured to perform the method according to the embodiments.

Some embodiments of the present disclosure provide a non-transitory computer readable storage medium for storing computer-executable instructions that, when executed by one or more computer processors, cause the one or more computer processors to perform the method according to the embodiments.

Some embodiments of the present disclosure provide a non-transitory computer readable storage medium for storing computer-executable instructions that, when executed by one or more computer processors, cause the one or more computer processors to perform the method according to the embodiments.

Some embodiments of the present disclosure provide a non-transitory computer-readable storage medium for storing a bitstream to be decoded by the method according to the embodiments.

Some embodiments of the present disclosure provide a non-transitory computer-readable storage medium for storing a bitstream generated by the method according to the embodiments.

According to some embodiments of the present disclosure, there is provided a method for video decoding. In the method, a decoder may obtain a motion precision syntax element that jointly indicates a set of motion precisions supported for all luma and chroma components of a current block. Furthermore, the decoder may determine a Context Adaptive Binary Arithmetic Coding (CABAC) context window that is used for each context model according to the set of motion precisions supported for all the luma and the chroma components of the current block.

According to some embodiments of the present disclosure, there is provided a method for video decoding. In the method, a decoder may obtain fractional motion information for a current block in an intra block copy (IBC) mode. Furthermore, the decoder may obtain a Block Vector (BV) for the current block based on the fractional motion information, obtain a final BV by adjusting a precision of the BV, and obtain a final prediction block for the current block based on the final BV.

According to some embodiments of the present disclosure, there is provided a method for video decoding. In the method, a decoder may obtain fractional motion information for a current block in an IBC mode and obtain a prediction block for the current block based on the BV. Furthermore, the decoder may skip a padding process on the unavailable samples of the prediction block in a direction in response to determining that a number of unavailable samples associated with an interpolation filter in the direction is less than a threshold value.

According to some embodiments of the present disclosure, there is provided a method for video encoding. In the method, an encoder may signal a motion precision syntax element that jointly indicates a set of motion precisions supported for all luma and chroma components of a current block. Furthermore, the encoder may determine a CABAC context window that is used for each context model according to the set of motion precisions supported for all the luma and the chroma components of the current block.

According to some embodiments of the present disclosure, there is provided a method for video encoding. In the method, an encoder may obtain fractional motion information for a current block in an IBC mode. Moreover, the encoder may obtain a BV for a current block based on the fractional motion information, obtain a final BV by adjusting a precision of the BV, and obtain a final prediction block for the current block based on the final BV.

According to some embodiments of the present disclosure, there is provided a method for video encoding. In the method, an encoder may obtain fractional motion information for a current block in an IBC mode. Additionally, the encoder may obtain a BV for the current block based on the fractional motion information and obtain a prediction block for the current block based on the BV. Furthermore, the encoder may skip a padding process on the unavailable samples of the prediction block in a direction in response to determining that a number of unavailable samples associated with an interpolation filter in the direction is less than a threshold value.

According to some embodiments of the present disclosure, there is provided an apparatus for video decoding. The apparatus includes one or more processors; and a memory coupled to the one or more processors and configured to store instructions executable by the one or more processors, where the one or more processors, upon execution of the instructions, are configured to perform the method according to the embodiments.

According to some embodiments of the present disclosure, there is provided a non-transitory computer-readable storage medium for storing computer-executable instructions that, when executed by one or more computer processors, cause the one or more computer processors to perform the method according to the embodiments.

According to some embodiments of the present disclosure, there is provided an apparatus for video encoding. The apparatus includes one or more processors; and a memory coupled to the one or more processors and configured to store instructions executable by the one or more processors, where the one or more processors, upon execution of the instructions, are configured to perform the method according to the embodiments.

According to some embodiments of the present disclosure, there is provided a non-transitory computer-readable storage medium for storing computer-executable instructions that, when executed by one or more computer processors, cause the one or more computer processors to perform the method according to the embodiments.

According to some embodiments of the present disclosure, there is provided a non-transitory computer-readable storage medium for storing a bitstream to be decoded by the method according to the embodiments.

According to some embodiments of the present disclosure, there is provided a non-transitory computer-readable storage medium for storing a bitstream generated by the method according to the embodiments.

According to some embodiments of the present disclosure, there is provided a method for video decoding. In the method, a decoder may obtain a plurality of block vectors based on at least one of an intra block copy (IBC) mode or an intra template matching prediction (IntraTMP) mode. Furthermore, the decoder may generate α plurality of prediction blocks based on the plurality of block vectors. Moreover, the decoder may obtain a final prediction block for a current block based on the plurality of prediction blocks.

According to some embodiments of the present disclosure, there is provided a method for video decoding. In the method, a decoder may obtain a base block vector based on at least one of an intra block copy (IBC) merge list, an intra block copy-template matching (IBC-TM) merge list, or intra template matching prediction (IntraTMP) mode. Furthermore, the decoder may obtain a block vector difference for the base block vector. Moreover, the decoder may obtain a final block vector for a current block by refining the base block vector using the block vector difference.

According to some embodiments of the present disclosure, there is provided a method for video encoding. In the method, an encoder may obtain a plurality of block vectors based on at least one of an IBC mode or an IntraTMP mode. Furthermore, the encoder may generate α plurality of prediction blocks based on the plurality of block vectors. Moreover, the encoder may obtain a final prediction block for a current block based on the plurality of prediction blocks.

According to some embodiments of the present disclosure, there is provided a method for video encoding. In the method, an encoder may obtain a base block vector based on at least one of an IBC merge list, an IBC-TM merge list, or IntraTMP mode. Furthermore, the encoder may obtain a block vector difference for the base block vector. Moreover, the encoder may obtain a final block vector for a current block by refining the base block vector using the block vector difference.

According to some embodiments of the present disclosure, there is provided an apparatus for video decoding. The apparatus includes one or more processors; and a memory coupled to the one or more processors and configured to store instructions executable by the one or more processors, where the one or more processors, upon execution of the instructions, are configured to perform the method according to the embodiments.

According to some embodiments of the present disclosure, there is provided a non-transitory computer-readable storage medium for storing computer-executable instructions that, when executed by one or more computer processors, cause the one or more computer processors to perform the method according to the embodiments.

According to some embodiments of the present disclosure, there is provided an apparatus for video encoding. The apparatus includes one or more processors; and a memory coupled to the one or more processors and configured to store instructions executable by the one or more processors, where the one or more processors, upon execution of the instructions, are configured to perform the method according to the embodiments.

According to some embodiments of the present disclosure, there is provided a non-transitory computer-readable storage medium for storing computer-executable instructions that, when executed by one or more computer processors, cause the one or more computer processors to perform the method according to the embodiments.

According to some embodiments of the present disclosure, there is provided a non-transitory computer-readable storage medium for storing a bitstream to be decoded by the method according to the embodiments.

According to some embodiments of the present disclosure, there is provided a non-transitory computer-readable storage medium for storing a bitstream generated by the method according to the embodiments.

According to some embodiments of the present disclosure, a method for video decoding is provided, comprising: obtaining, by a decoder, fractional motion information for a current block in an intra block copy (IBC) mode; obtaining, by the decoder, a block vector (BV) for the current block based on the fractional motion information; obtaining, by the decoder, a prediction block for the current block based on the BV; and in response to meeting a condition, conducting, or skipping partially or fully, by the decoder, a padding process on one or more samples associated with an interpolation filter.

According to some embodiments of the present disclosure, the condition comprises: determining that the one or more samples associated with the interpolation filter are not available and a value of a fractional part of the BV being zero, the fractional part comprising a horizontal part or a vertical part, and skipping partially or fully, by the decoder, the padding process on the one or more samples comprises: skipping the padding process related to the fractional part of the BV, the value of which is zero.

According to some embodiments of the present disclosure, the condition comprises: all samples associated with an interpolation filter being located inside of a valid reference area, and skipping partially or fully, by the decoder, the padding process on the one or more samples comprises: fully skipping the padding process.

According to some embodiments of the present disclosure, conducting, by the decoder, the padding process on the one or more samples comprises: determining padding sizes for left or top samples located outside of a reference block pointed by an integer BV or an integer part of a BV as 1 sample size less than padding sizes for right or bottom samples located outside of the reference block.

According to some embodiments of the present disclosure, the method further comprises: conducting, by the decoder, a padding process for any one or any combination of following processes: motion search, motion refinement, or parameter generation for prediction refinement.

According to some embodiments of the present disclosure, the method further comprises: skipping a padding process when applying the interpolation filter on the prediction block to obtain a filtered prediction for the current block.

According to some embodiments of the present disclosure, a method for video decoding is provided, comprising: obtaining, by a decoder, fractional motion information for a plurality of luma blocks collocated at a plurality of predefined positions relative to a position of a current chroma block in intra block copy (IBC) mode; obtaining, by the decoder, a plurality of luma block vectors (BVs) of the plurality of luma blocks based on the fractional motion information; determining, by the decoder, a chroma BV based on the plurality of luma BVs of the plurality of luma blocks; and obtaining, by the decoder, a prediction chroma block based on the chroma BV.

According to some embodiments of the present disclosure, determining, by the decoder, the chroma BV based on the plurality of luma BVs of the plurality of luma blocks comprises: calculating, by the decoder, chroma template match cost based on a luma BV of each of the plurality of luma blocks and the current chroma block; and determining, by the decoder, a chroma BV as a luma BV with a lowest chroma template match cost.

According to some embodiments of the present disclosure, determining, by the decoder, the chroma BV based on the plurality of luma BVs of the plurality of luma blocks comprises: conducting gradient based edge detection on the plurality of luma blocks; and determining, by the decoder, a chroma BV as a luma BV of a luma block having a same edge with the chroma block.

According to some embodiments of the present disclosure, the method further comprises: obtaining, by the decoder, a template-based BV refinement based on intra template matching (ITM); and obtaining, by the decoder, a refined chroma BV based on the template-based BV refinement and the chroma BV.

According to some embodiments of the present disclosure, the prediction refinement comprises a positive refinement or a negative refinement.

According to some embodiments of the present disclosure, obtaining, by the decoder, the refined chroma BV based on the template-based BV refinement and the chroma BV comprises: applying the template-based BV refinement to a first color component of the chroma BV; and reusing the prediction refinement to a second color component of the chroma BV.

According to some embodiments of the present disclosure, obtaining, by the decoder, the template-based BV refinement based on comprises: obtaining the template-based BV refinement based on reference template cost calculated by combining match errors for both a first color template component and a second color template component, and obtaining, by the decoder, the refined chroma BV based on the template-based BV refinement and the chroma BV comprises: applying template-based BV to a first color component and a second color component of the chroma BV.

According to some embodiments of the present disclosure, the method further comprises: clipping or rounding a value of the chroma BV to an integer value.

According to some embodiments of the present disclosure, determining, by the decoder, the chroma block vector (BV) based on the plurality of luma BVs of the plurality of luma blocks comprises: clipping or rounding a plurality of values of the plurality of luma BVs to a plurality of integer values; and determining, by the decoder, the chroma BV based on the plurality of integer values.

According to some embodiments of the present disclosure, the method further comprises applying a first interpolation filter on the prediction chroma block to obtain a filtered prediction for the current chroma block, wherein the first interpolation filter is same as or different from a second interpolation filter used to obtain the template-based BV refinement, and the first interpolation filter or the second interpolation filter is predefined.

According to some embodiments of the present disclosure, the method further comprises: in response to determining that a size of the current chroma block is less than a predefined size, clipping or rounding a value of the chroma BV to an integer value, or, using a filter with a smaller size than a redefined size when conducting a first interpolation process on the prediction chroma block or a second interpolation process on the chroma BV.

According to some embodiments of the present disclosure, wherein the filter with the smaller size is predefined or signaled at a specific level.

According to some embodiments of the present disclosure, a method for video decoding is provided, comprising: obtaining, by a decoder, magnitude of block vector difference (BVD) components, each of the BVD components comprising an integer BVD component part and a fractional BVD component part; obtaining, by the decoder, context-coded BVD sign prediction indexes; obtaining, by the decoder, a plurality of BV candidates by creating combination between BVD signs and absolute BVD values and adding the combination into BV predictors, each BV candidate comprises an integer part and a fractional part; deriving, by the decoder, a BVD sign prediction cost for each BV candidate based on template matching cost; sorting, by the decoder, the plurality of BV candidates based on the BVD sign prediction cost; and deriving, by the decoder, a BVD sign prediction index corresponding to a true BVD sign.

According to some embodiments of the present disclosure, wherein the BVD sign prediction index comprises integer bins and fractional bins.

According to some embodiments of the present disclosure, wherein sorting, by the decoder, the plurality of BV candidates based on the BVD sign prediction cost comprises: obtaining a first sorting result by sorting the plurality BV candidates based on a first BVD sign prediction cost derived based on the integer part of each BV candidate; and in response to that a first combination of the integer bins of the BVD sign prediction index has been derived based on the first sorting result, obtaining a second sorting result by sorting the plurality BV candidates based on a second BVD sign prediction cost derived based on the fractional part of each BV candidate, wherein deriving, by the decoder, a BVD sign prediction index corresponding to a true BVD sign comprises: deriving the first combination of the integer bins of the BVD sign prediction index based on the first sorting result; and deriving a second combination of the fractional bins of the BVD sign prediction index based on the second sorting result.

According to some embodiments of the present disclosure, wherein sorting, by the decoder, the plurality of BV candidates based on the BVD sign prediction cost comprises: obtaining a first sorting result by sorting the plurality BV candidates based on a first BVD sign prediction cost derived based on the fractional part of each BV candidate; and in response to that a first combination of the fractional bins of the BVD sign prediction index has been derived based on the first sorting result, obtaining a second sorting result by sorting the plurality BV candidates based on a second BVD sign prediction cost derived based on the integer part of each BV candidate, wherein deriving, by the decoder, a BVD sign prediction index corresponding to a true BVD sign comprises: deriving the first combination of the fractional bins of the BVD sign prediction index based on the first sorting result; and deriving a second combination of the integer bins of the BVD sign prediction index based on the second sorting result.

According to some embodiments of the present disclosure, wherein the fractional BVD component part is obtained by receiving, by the decoder from an encoder, fractional bins representing the fractional BVD component part, and deriving, by the decoder, the BVD sign prediction cost for each BV candidate based on template matching cost comprises: conducting an interpolation filtering process for each BV candidate, wherein an interpolation filter associated with the interpolation filtering process is predefined or switched at different levels; and deriving the BVD sign prediction cost for each BV candidate based on template matching cost calculated by considering both the integer part and the fractional part of each BV candidate.

According to some embodiments of the present disclosure, wherein the fractional BVD component part is obtained by receiving, by the decoder from an encoder, fractional bins representing the fractional BVD component part, and deriving, by the decoder, the BVD sign prediction cost for each BV candidate based on template matching cost comprises: skipping an interpolation filtering process for each BV candidate; and deriving the BVD sign prediction cost for each BV candidate based on template matching cost calculated by only considering the integer part of each BV candidate.

According to some embodiments of the present disclosure, a method for video encoding is provided, comprising: obtaining, by an encoder, fractional motion information for a current block in an intra block copy (IBC) mode; obtaining, by the encoder, a block vector (BV) for the current block based on the fractional motion information; obtaining, by the encoder, a prediction block for the current block based on the BV; and in response to meeting a condition, conducting, or skipping partially or fully, by the encoder, a padding process on one or more samples associated with an interpolation filter.

According to some embodiments of the present disclosure, the condition comprises: determining that the one or more samples associated with the interpolation filter are not available and a value of a fractional part of the BV being zero, the fractional part comprising a horizontal part or a vertical part, and skipping partially or fully, by the encoder, the padding process on the one or more samples comprises: skipping the padding process related to the fractional part of the BV, the value of which is zero.

According to some embodiments of the present disclosure, the condition comprises: all samples associated with an interpolation filter being located inside of a valid reference area, and skipping partially or fully, by the encoder, the padding process on the one or more samples comprises: fully skipping the padding process.

According to some embodiments of the present disclosure, conducting, by the encoder, the padding process on the one or more samples comprises: determining padding sizes for left or top samples located outside of a reference block pointed by an integer BV or an integer part of a BV as 1 sample size less than padding sizes for right or bottom samples located outside of the reference block.

According to some embodiments of the present disclosure, the method further comprises: conducting, by the encoder, a padding process for any one or any combination of following processes: motion search, motion refinement, or parameter generation for prediction refinement.

According to some embodiments of the present disclosure, the method further comprises: skipping a padding process when applying the interpolation filter on the prediction block to obtain a filtered prediction for the current block.

According to some embodiments of the present disclosure, a method for video encoding is provided, comprising: obtaining, by an encoder, fractional motion information for a plurality of luma blocks collocated at a plurality of predefined positions relative to a position of a current chroma block in intra block copy (IBC) mode; obtaining, by the encoder, a plurality of luma block vectors (BVs) of the plurality of luma blocks based on the fractional motion information; determining, by the encoder, a chroma BV based on the plurality of luma BVs of the plurality of luma blocks; and obtaining, by the encoder, a prediction chroma block based on the chroma BV.

According to some embodiments of the present disclosure, determining, by the encoder, the chroma BV based on the plurality of luma BVs of the plurality of luma blocks comprises: calculating, by the encoder, chroma template match cost based on a luma BV of each of the plurality of luma blocks and the current chroma block; and determining, by the encoder, a chroma BV as a luma BV with a lowest chroma template match cost.

According to some embodiments of the present disclosure, determining, by the encoder, the chroma BV based on the plurality of luma BVs of the plurality of luma blocks comprises: conducting gradient based edge detection on the plurality of luma blocks; and determining, by the encoder, a chroma BV as a luma BV of a luma block having a same edge with the chroma block.

According to some embodiments of the present disclosure, the method further comprises: obtaining, by the encoder, a template-based BV refinement based on intra template matching (ITM); and obtaining, by the encoder, a refined chroma BV based on the template-based BV refinement and the chroma BV.

According to some embodiments of the present disclosure, the prediction refinement comprises a positive refinement or a negative refinement.

According to some embodiments of the present disclosure, obtaining, by the encoder, the refined chroma BV based on the template-based BV refinement and the chroma BV comprises: applying the template-based BV refinement to a first color component of the chroma BV; and reusing the prediction refinement to a second color component of the chroma BV.

According to some embodiments of the present disclosure, obtaining, by the encoder, the template-based BV refinement based on comprises: obtaining the template-based BV refinement based on reference template cost calculated by combining match errors for both a first color template component and a second color template component, and obtaining, by the encoder, the refined chroma BV based on the template-based BV refinement and the chroma BV comprises: applying template-based BV to a first color component and a second color component of the chroma BV.

According to some embodiments of the present disclosure, the method further comprises: clipping or rounding a value of the chroma BV to an integer value.

According to some embodiments of the present disclosure, determining, by the encoder, the chroma block vector (BV) based on the plurality of luma BVs of the plurality of luma blocks comprises: clipping or rounding a plurality of values of the plurality of luma BVs to a plurality of integer values; and determining, by the encoder, the chroma BV based on the plurality of integer values.

According to some embodiments of the present disclosure, the method further comprises applying a first interpolation filter on the prediction chroma block to obtain a filtered prediction for the current chroma block, wherein the first interpolation filter is same as or different from a second interpolation filter used to obtain the template-based BV refinement, and the first interpolation filter or the second interpolation filter is predefined.

According to some embodiments of the present disclosure, the method further comprises in response to determining that a size of the current chroma block is less than a predefined size, clipping or rounding a value of the chroma BV to an integer value, or, using a filter with a smaller size than a redefined size when conducting a first interpolation process on the prediction chroma block or a second interpolation process on the chroma BV.

According to some embodiments of the present disclosure, the filter with the smaller size is predefined or signaled at a specific level.

According to some embodiments of the present disclosure, a method for video encoding is provided, comprising: obtaining, by an encoder, magnitude of block vector difference (BVD) components, each of the BVD components comprising an integer BVD component part and a fractional BVD component part; obtaining, by the encoder, context-coded BVD sign prediction indexes; obtaining, by the encoder, a plurality of BV candidates by creating combination between BVD signs and absolute BVD values and adding the combination into BV predictors, each BV candidate comprises an integer part and a fractional part; deriving, by the encoder, a BVD sign prediction cost for each BV candidate based on template matching cost; sorting, by the encoder, the plurality of BV candidates based on the BVD sign prediction cost; and deriving, by the encoder, a BVD sign prediction index corresponding to a true BVD sign.

According to some embodiments of the present disclosure, the BVD sign prediction index comprises integer bins and fractional bins.

According to some embodiments of the present disclosure, sorting, by the encoder, the plurality of BV candidates based on the BVD sign prediction cost comprises: obtaining a first sorting result by sorting the plurality BV candidates based on a first BVD sign prediction cost derived based on the integer part of each BV candidate; and in response to that a first combination of the integer bins of the BVD sign prediction index has been derived based on the first sorting result, obtaining a second sorting result by sorting the plurality BV candidates based on a second BVD sign prediction cost derived based on the fractional part of each BV candidate, wherein deriving, by the encoder, a BVD sign prediction index corresponding to a true BVD sign comprises: deriving the first combination of the integer bins of the BVD sign prediction index based on the first sorting result; and deriving a second combination of the fractional bins of the BVD sign prediction index based on the second sorting result.

According to some embodiments of the present disclosure, sorting, by the encoder, the plurality of BV candidates based on the BVD sign prediction cost comprises: obtaining a first sorting result by sorting the plurality BV candidates based on a first BVD sign prediction cost derived based on the fractional part of each BV candidate; and in response to that a first combination of the fractional bins of the BVD sign prediction index has been derived based on the first sorting result, obtaining a second sorting result by sorting the plurality BV candidates based on a second BVD sign prediction cost derived based on the integer part of each BV candidate, wherein deriving, by the encoder, a BVD sign prediction index corresponding to a true BVD sign comprises: deriving the first combination of the fractional bins of the BVD sign prediction index based on the first sorting result; and deriving a second combination of the integer bins of the BVD sign prediction index based on the second sorting result.

According to some embodiments of the present disclosure, the method further comprises: signaling, by the encoder, the fractional BVD component part, fractional bins representing the fractional BVD component part, wherein deriving, by the encoder, the BVD sign prediction cost for each BV candidate based on template matching cost comprises: conducting an interpolation filtering process for each BV candidate, wherein an interpolation filter associated with the interpolation filtering process is predefined or switched at different levels; and deriving the BVD sign prediction cost for each BV candidate based on template matching cost calculated by considering both the integer part and the fractional part of each BV candidate.

According to some embodiments of the present disclosure, the method further comprises: signaling, by the encoder, the fractional BVD component part, fractional bins representing the fractional BVD component part, wherein deriving, by the encoder, the BVD sign prediction cost for each BV candidate based on template matching cost comprises: skipping an interpolation filtering process for each BV candidate; and deriving the BVD sign prediction cost for each BV candidate based on template matching cost calculated by only considering the integer part of each BV candidate.

According to some embodiments of the present disclosure, a method for video decoding is provided, comprising: obtaining, by a decoder, a motion precision syntax element that jointly indicates a set of motion precisions supported for all luma and chroma components of a current block; and determining, by the decoder, a Context Adaptive Binary Arithmetic Coding (CABAC) context window that is used for each context model according to the set of motion precisions supported for all the luma and the chroma components of the current block.

According to some embodiments of the present disclosure, the set of the motion precisions supported for all the luma and the chroma components comprise one of following sets: a set of 4-pel, 1-pel, ½-pel and 1/-4 pel; a set of 4-pel, 1-pel, and ½-pel; or a set of 4-pel, 1-pel, and ¼-pel.

According to some embodiments of the present disclosure, the set of the motion precisions comprises a first motion precision that is converted from a second motion precision, wherein the second motion precision is not comprised in the set of the motion precisions.

According to some embodiments of the present disclosure, a method for video decoding is provided, comprising: obtaining, by a decoder, fractional motion information for a current block in an intra block copy (IBC) mode; obtaining, by the decoder, a Block Vector (BV) for the current block based on the fractional motion information; obtaining, by the decoder, a final BV by adjusting a precision of the BV; and obtaining, by the decoder, a final prediction block for the current block based on the final BV.

According to some embodiments of the present disclosure, the fractional motion information is determined by: searching a first number of integer BVs with a minimum distortion cost; applying half-pel refinement around each of the first number of integer BVs by obtaining a second number of best half-pel positions for each of the first number of integer BVs, wherein the second number of best half-pel positions indicate the second number of half-pel BV differences having a lowest rate distortion cost; obtaining quarter-pel refinement by applying quarter-pel refinement around the second number of best half-pel positions for each of the first number of integer BVs; and obtaining the fractional motion information based on the quarter-pel refinement.

According to some embodiments of the present disclosure, obtaining the final BV by adjusting the precision of the BV comprises: determining a highest precision of the BV; in response to determining that the highest precision of the BV is half-pel, obtaining the final BV by adjusting the precision of the BV in one of following manners: adjusting a precision of the final BV to quarter-pel; or maintaining the precision of the final BV as half-pel.

According to some embodiments of the present disclosure, the method further comprises: receiving, by the decoder, a syntax element indicating the precision of the BV.

According to some embodiments of the present disclosure, searching the first number of integer BVs with the minimum distortion cost comprises at least one of followings: searching the first number of integer BVs with the minimum distortion cost according to a threshold; or simplifying or skipping searching the first number of integer BVs according to one or more other coding modes of the current block.

According to some embodiments of the present disclosure, searching the first number of integer BVs with the minimum distortion cost according to the threshold comprises: determining a sum of absolute differences (SAD) cost or a sum of absolute transformed differences (SATD) cost from the one or more other coding modes of the current block; and determining the minimum distortion cost based on a predefined threshold factor and one of the SAD cost or the SATD cost.

According to some embodiments of the present disclosure, simplifying searching the first number of integer BVs according to the one or more other coding modes of the current block comprises: decreasing the first number to an integer number less than the first number, wherein the first number and the integer number are predefined or determined based on texture richness of the current block.

According to some embodiments of the present disclosure, simplifying searching the first number of integer BVs according to the one or more other coding modes of the current block comprises: searching the first number of integer BVs based on a history search process of the current block or a different block.

According to some embodiments of the present disclosure, a method for video decoding is provided, comprising: obtaining, by a decoder, fractional motion information for a current block in an intra block copy (IBC) mode; obtaining, by the decoder, a block vector (BV) for the current block based on the fractional motion information; obtaining, by the decoder, a prediction block for the current block based on the BV; and in response to determining that a number of unavailable samples associated with an interpolation filter in a direction is less than a threshold value, skipping, by the decoder, a padding process on the unavailable samples of the prediction block in the direction.

According to some embodiments of the present disclosure, the threshold value is predefined or signaled, and wherein the direction is a horizontal direction or a vertical direction.

According to some embodiments of the present disclosure, the interpolation filter is a 12-tap interpolation filter, and the threshold value is 2.

According to some embodiments of the present disclosure, the method further comprises: applying, by the decoder, the interpolation filter with a specific tap length based on a block size of the current block.

According to some embodiments of the present disclosure, applying the interpolation filter with the specific tap length based on the block size of the current block comprises: in response to determining that the block size of the current block is smaller than a threshold size, applying the interpolation filter with the specific tap length that is smaller than a threshold tap length.

According to some embodiments of the present disclosure, in response to determining that the block size of the current block is smaller than the threshold size, applying the interpolation filter with the specific tap length that is smaller than the threshold tap length further comprises at least one of followings: in response to determining that a chroma size of a chroma component of the current block is smaller than a chroma threshold size, applying the interpolation filter with the specific tap length that is smaller than a chroma threshold tap length on the chroma component; or in response to determining that a luma size of a luma component of the current block is smaller than a luma threshold size, applying the interpolation filter with the specific tap length that is smaller than a luma threshold tap length on the luma component.

According to some embodiments of the present disclosure, obtaining the BV for the current block based on the fractional motion information and obtaining the prediction block for the current block based on the BV comprises: obtaining, by the decoder, a first BV and a second BV for the current block based on the fractional motion information, wherein the current block is in bi-predicted IBC mode; obtaining, by the decoder, a first reference block associated with the first BV and a second reference block associated with the second BV; and obtaining, by the decoder, the prediction block for the current block by weighted-averaging the first reference block and the second reference block based on a first weight associated with the first BV and a second weight associated with the second BV.

According to some embodiments of the present disclosure, the first weight and the second weight are obtained by one of following manners: inheriting form spatial neighboring blocks of the current block; reusing same weights used for an inter-predicted block; receiving, by the decoder, from a bitstream; or deriving, by the decoder, without signaling.

According to some embodiments of the present disclosure, a method for video encoding is provided, comprising: signaling, by an encoder, a motion precision syntax element that jointly indicates a set of motion precisions supported for all luma and chroma components of a current block; and determining, by the encoder, a Context Adaptive Binary Arithmetic Coding (CABAC) context window that is used for each context model according to the set of motion precisions supported for all the luma and the chroma components of the current block.

According to some embodiments of the present disclosure, the set of the motion precisions supported for all the luma and the chroma components comprise one of following sets: a set of 4-pel, 1-pel, ½-pel and 1/-4 pel; a set of 4-pel, 1-pel, and ½-pel; or a set of 4-pel, 1-pel, and ¼-pel.

According to some embodiments of the present disclosure, the method further comprises: in response to determining that a current precision of the current block is different from any motion precision in the set of motion precisions, converting the current precision to a motion precision in the set of motion precisions.

According to some embodiments of the present disclosure, a method for video encoding is provided, comprising: obtaining, by an encoder, fractional motion information for a current block in an intra block copy (IBC) mode; obtaining, by the encoder, a Block Vector (BV) for a current block based on the fractional motion information; obtaining, by the encoder, a final BV by adjusting a precision of the BV; and obtaining, by the encoder, a final prediction block for the current block based on the final BV.

According to some embodiments of the present disclosure, obtaining the fractional motion information for the current block in the IBC mode comprises: searching a first number of integer BVs with a minimum distortion cost; applying half-pel refinement around each of the first number of integer BVs by obtaining a second number of best half-pel positions for each of the first number of integer BVs, wherein the second number of best half-pel positions indicate the second number of half-pel BV differences having a lowest rate distortion cost; obtaining quarter-pel refinement by applying quarter-pel refinement around the second number of best half-pel positions for each of the first number of integer BVs; and obtaining the fractional motion information based on the quarter-pel refinement.

According to some embodiments of the present disclosure, obtaining the final BV by adjusting the precision of the BV comprises: determining a highest precision of the BV; in response to determining that the highest precision of the BV is half-pel, obtaining the final BV by adjusting the precision of the BV in one of following manners: adjusting a precision of the final BV to quarter-pel; or maintaining the precision of the final BV as half-pel.

According to some embodiments of the present disclosure, the method further comprises: signaling, by the encoder, a syntax element indicating the precision of the BV.

According to some embodiments of the present disclosure, searching the first number of integer BVs with the minimum distortion cost comprises at least one of followings: searching the first number of integer BVs with the minimum distortion cost according to a threshold; or simplifying or skipping searching the first number of integer BVs according to one or more other coding modes of the current block.

According to some embodiments of the present disclosure, searching the first number of integer BVs with the minimum distortion cost according to the threshold comprises: determining a sum of absolute differences (SAD) cost or a sum of absolute transformed differences (SATD) cost from the one or more other coding modes of the current block; and determining the minimum distortion cost based on a predefined threshold factor and one of the SAD cost or the SATD cost.

According to some embodiments of the present disclosure, simplifying searching the first number of integer BVs according to the one or more other coding modes of the current block comprises: decreasing the first number to an integer number less than the first number, wherein the first number and the integer number are predefined or determined based on texture richness of the current block.

According to some embodiments of the present disclosure, simplifying searching the first number of integer BVs according to the one or more other coding modes of the current block comprises: searching the first number of integer BVs based on a history search process of the current block or a different block.

According to some embodiments of the present disclosure, a method for video encoding is provided, comprising: obtaining, by an encoder, fractional motion information for a current block in an intra block copy (IBC) mode; obtaining, by the encoder, a block vector (BV) for the current block based on the fractional motion information; obtaining, by the encoder, a prediction block for the current block based on the BV; and in response to determining that a number of unavailable samples associated with an interpolation filter in a direction is less than a threshold value, skipping, by the encoder, a padding process on the unavailable samples of the prediction block in the direction.

According to some embodiments of the present disclosure, the threshold value is predefined or signaled, and wherein the direction is a horizontal direction or a vertical direction.

According to some embodiments of the present disclosure, the interpolation filter is a 12-tap interpolation filter, and the threshold value is 2.

According to some embodiments of the present disclosure, the method further comprises: applying, by the encoder, the interpolation filter with a specific tap length based on a block size of the current block.

According to some embodiments of the present disclosure, applying the interpolation filter with the specific tap length based on the block size of the current block comprises: in response to determining that the block size of the current block is smaller than a threshold size, applying the interpolation filter with the specific tap length that is smaller than a threshold tap length.

According to some embodiments of the present disclosure, in response to determining that the block size of the current block is smaller than the threshold size, applying the interpolation filter with the specific tap length that is smaller than the threshold tap length further comprises at least one of followings: in response to determining that a chroma size of a chroma component of the current block is smaller than a chroma threshold size, applying the interpolation filter with the specific tap length that is smaller than a chroma threshold tap length on the chroma component; or in response to determining that a luma size of a luma component of the current block is smaller than a luma threshold size, applying the interpolation filter with the specific tap length that is smaller than a luma threshold tap length on the luma component.

According to some embodiments of the present disclosure, obtaining the BV for the current block based on the fractional motion information and obtaining the prediction block for the current block based on the BV comprises: obtaining, by the encoder, a first BV and a second BV for the current block based on the fractional motion information, wherein the current block is in bi-predicted IBC mode; obtaining, by the encoder, a first reference block associated with the first BV and a second reference block associated with the second BV; and obtaining, by the encoder, the prediction block for the current block by weighted-averaging the first reference block and the second reference block based on a first weight associated with the first BV and a second weight associated with the second BV.

According to some embodiments of the present disclosure, the first weight and the second weight are obtained by one of following manners: inheriting form spatial neighboring blocks of the current block; reusing same weights used for an inter-predicted block; or signaling, by the encoder, into a bitstream.

According to some embodiments of the present disclosure, a method for video decoding is provided, comprising: obtaining, by a decoder, a plurality of block vectors based on at least one of an intra block copy (IBC) mode or an intra template matching prediction (IntraTMP) mode; generating, by the decoder, a plurality of prediction blocks based on the plurality of block vectors; and obtaining, by the decoder, a final prediction block for a current block based on the plurality of prediction blocks.

According to some embodiments of the present disclosure, obtaining the plurality of block vectors according to the at least one of the IBC mode or the IntraTMP mode further comprises: receiving information related to one or more block vectors based on the IBC mode from a bitstream.

According to some embodiments of the present disclosure, receiving the information related to the one or more block vectors based on the IBC mode from the bitstream comprises one of following steps: receiving a plurality of block vector predictor indexes and block vector differences in response to determining that the one or more block vectors are in an intra block copy-advanced motion vector prediction (IBC-AMVP) mode, wherein the plurality of block vector predictor indexes and block vector differences indicate the one or more block vectors; or receiving a plurality of block vector candidate indexes from a constructed merge candidate list in response to determining that the one or more block vectors are in an IBC-merge mode, wherein the plurality of block vector candidate indexes indicate the one or more block vectors.

According to some embodiments of the present disclosure, obtaining the plurality of block vectors based on the at least one of the IBC mode or the IntraTMP mode further comprises: deriving one or more block vectors based on the IntraTMP mode.

According to some embodiments of the present disclosure, deriving the one or more block vectors based on the IntraTMP mode comprises: deriving one or more initial block vectors based on an intra block copy-template matching (IBC-TM) mode; and deriving the one or more block vectors by applying the IntraTMP mode to the one or more initial block vectors.

According to some embodiments of the present disclosure, deriving the one or more block vectors based on the IntraTMP mode comprises: receiving an IBC list including zero block vector, wherein the IBC list comprises one of an IBC-AMVP list or an IBC-merge list; and deriving the one or more block vectors by applying the IntraTMP mode to the zero block vector.

According to some embodiments of the present disclosure, a method for video decoding is provided, comprising: obtaining, by a decoder, a base block vector based on at least one of an intra block copy (IBC) merge list, an intra block copy-template matching (IBC-TM) merge list, or intra template matching prediction (IntraTMP) mode; obtaining, by the decoder, a block vector difference for the base block vector; and obtaining, by the decoder, a final block vector for a current block by refining the base block vector using the block vector difference.

According to some embodiments of the present disclosure, obtaining the base block vector based on at least one of the IBC merge list, the IBC-TM merge list, or the IntraTMP mode comprises: generating a first merge list based on the IBC merge list and the IBC-TM merge list; and obtaining the base block vector from the first merge list.

According to some embodiments of the present disclosure, generating the first merge list based on the IBC merge list and the IBC-TM merge list further comprises: obtaining a reordered IBC merge list and a reordered IBC-TM merge list by respectively reordering the IBC merge list and the IBC-TM merge list; selecting a first number of block vectors from the reordered IBC merge list; selecting a second number of block vectors from the reordered IBC-TM merge list; and generating the first merge list based on the first number of block vectors from the reordered IBC merge list and the second number of block vectors from the reordered IBC-TM merge list.

According to some embodiments of the present disclosure, generating the first merge list based on the first number of block vectors from the reordered IBC merge list and the second number of block vectors from the reordered IBC-TM merge list comprises: obtaining a combined merge list by combining the first merge list based on the first number of block vectors from the reordered IBC merge list and the second number of block vectors from the reordered IBC-TM merge list; and generating the first merge list by punning the combined merge list.

According to some embodiments of the present disclosure, generating the first merge list based on the IBC merge list and the IBC-TM merge list further comprises: obtaining a combined merge list by combining the IBC merge list and the IBC-TM merge list; obtaining a reordered IBC merge list by reordering the combined merge list based on template matching; and generating the first merge list by pruning the reordered IBC merge list.

According to some embodiments of the present disclosure, obtaining the base block vector based on at least one of the IBC merge list, the IBC-TM merge list, or the IntraTMP mode comprises: receiving a syntax element that indicates whether the base block vector is from the IBC merge list or the IBC-TM merge list; in response to receiving the syntax element that indicates the base block vector is from the IBC merge list, obtaining the base block vector from the IBC merge list; and in response to receiving the syntax element that indicates the base block vector is from the IBC-TM merge list, obtaining the base block vector from the IBC-TM merge list.

According to some embodiments of the present disclosure, the syntax element comprises one of an existing IBC-TM flag or an extra flag indicating whether the base block vector is from the IBC merge list or the IBC-TM merge list.

According to some embodiments of the present disclosure, obtaining the base block vector based on at least one of the IBC merge list, the IBC-TM merge list, or the IntraTMP mode comprises: obtaining an initial base block vector based on the at least one of the IBC merge list, the IBC-TM merge list, or the IntraTMP mode; determining whether the initial base block vector is a fractional block vector; and in response to determining that the initial base block vector is a fractional block vector, obtaining the base block vector by adjusting the initial base block vector to be an integer block vector.

According to some embodiments of the present disclosure, obtaining the base block vector based on at least one of the IBC merge list, the IBC-TM merge list, or the IntraTMP mode comprises: deriving the base block vector based on the IntraTMP mode by searching templates similar to a current template of the current block.

According to some embodiments of the present disclosure, a method for video encoding is provided, comprising: obtaining, by an encoder, a plurality of block vectors based on at least one of an intra block copy (IBC) mode or an intra template matching prediction (IntraTMP) mode; generating, by the encoder, a plurality of prediction blocks based on the plurality of block vectors; and obtaining, by the encoder, a final prediction block for a current block based on the plurality of prediction blocks.

According to some embodiments of the present disclosure, obtaining the plurality of block vectors according to the at least one of the IBC mode or the IntraTMP mode further comprises: signaling information related to one or more block vectors based on the IBC mode.

According to some embodiments of the present disclosure, signaling the information related to the one or more block vectors based on the IBC mode comprises one of following steps: signaling a plurality of block vector predictor indexes and block vector differences, wherein the one or more block vectors are in an intra block copy-advanced motion vector prediction (IBC-AMVP) mode, and the plurality of block vector predictor indexes and block vector differences indicate the one or more block vectors; or signaling a plurality of block vector candidate indexes from a constructed merge candidate list, wherein the one or more block vectors are in an IBC-merge mode, and the plurality of block vector candidate indexes indicate the one or more block vectors.

According to some embodiments of the present disclosure, obtaining the plurality of block vectors based on the at least one of the IBC mode or the IntraTMP mode further comprises: deriving one or more block vectors based on the IntraTMP mode.

According to some embodiments of the present disclosure, deriving the one or more block vectors based on the IntraTMP mode comprises: deriving one or more initial block vectors based on an intra block copy-template matching (IBC-TM) mode; and deriving the one or more block vectors by applying the IntraTMP mode to the one or more initial block vectors.

According to some embodiments of the present disclosure, deriving the one or more block vectors based on the IntraTMP mode comprises: generating an IBC list including zero block vector, wherein the IBC list comprises one of an IBC-AMVP list or an IBC-merge list; and deriving the one or more block vectors by applying the IntraTMP mode to the zero block vector.

According to some embodiments of the present disclosure, a method for video encoding is provided, comprising: obtaining, by an encoder, a base block vector based on at least one of an intra block copy (IBC) merge list, an intra block copy-template matching (IBC-TM) merge list, or intra template matching prediction (IntraTMP) mode; obtaining, by the encoder, a block vector difference for the base block vector; and obtaining, by the encoder, a final block vector for a current block by refining the base block vector using the block vector difference.

According to some embodiments of the present disclosure, obtaining the base block vector based on at least one of the IBC merge list, the IBC-TM merge list, or the IntraTMP mode comprises: generating a first merge list based on the IBC merge list and the IBC-TM merge list; and obtaining the base block vector from the first merge list.

According to some embodiments of the present disclosure, generating the first merge list based on the IBC merge list and the IBC-TM merge list further comprises: obtaining a reordered IBC merge list and a reordered IBC-TM merge list by respectively reordering the IBC merge list and the IBC-TM merge list; selecting a first number of block vectors from the reordered IBC merge list; selecting a second number of block vectors from the reordered IBC-TM merge list; and generating the first merge list based on the first number of block vectors from the reordered IBC merge list and the second number of block vectors from the reordered IBC-TM merge list.

According to some embodiments of the present disclosure, generating the first merge list based on the first number of block vectors from the reordered IBC merge list and the second number of block vectors from the reordered IBC-TM merge list comprises: obtaining a combined merge list by combining the first merge list based on the first number of block vectors from the reordered IBC merge list and the second number of block vectors from the reordered IBC-TM merge list; and generating the first merge list by punning the combined merge list.

According to some embodiments of the present disclosure, generating the first merge list based on the IBC merge list and the IBC-TM merge list further comprises: obtaining a combined merge list by combining the IBC merge list and the IBC-TM merge list; obtaining a reordered IBC merge list by reordering the combined merge list based on template matching; and generating the first merge list by pruning the reordered IBC merge list.

According to some embodiments of the present disclosure, obtaining the base block vector based on at least one of the IBC merge list, the IBC-TM merge list, or the IntraTMP mode comprises: signaling a syntax element that indicates whether the base block vector is from the IBC merge list or the IBC-TM merge list; in response to determining that the syntax element that indicates the base block vector is from the IBC merge list, obtaining the base block vector from the IBC merge list; and in response to determining that the syntax element that indicates the base block vector is from the IBC-TM merge list, obtaining the base block vector from the IBC-TM merge list.

According to some embodiments of the present disclosure, the syntax element comprises one of an existing IBC-TM flag or an extra flag indicating whether the base block vector is from the IBC merge list or the IBC-TM merge list.

According to some embodiments of the present disclosure, obtaining the base block vector based on at least one of the IBC merge list, the IBC-TM merge list, or the IntraTMP mode comprises: obtaining an initial base block vector based on the at least one of the IBC merge list, the IBC-TM merge list, or the IntraTMP mode; determining whether the initial base block vector is a fractional block vector; and in response to determining that the initial base block vector is a fractional block vector, obtaining the base block vector by adjusting the initial base block vector to be an integer block vector.

According to some embodiments of the present disclosure, obtaining the base block vector based on at least one of the IBC merge list, the IBC-TM merge list, or the IntraTMP mode comprises: deriving the base block vector based on the IntraTMP mode by searching templates similar to a current template of the current block.

What is claimed is:

1. A method for video decoding, comprising:
obtaining, by a decoder, fractional motion information for a current block in an intra block copy (IBC) mode;
obtaining, by the decoder, a block vector (BV) for the current block based on the fractional motion information;
obtaining, by the decoder, a prediction block for the current block based on the BV; and
in response to meeting a condition, conducting, or skipping partially or fully, by the decoder, a padding process on one or more samples associated with an interpolation filter.

2. The method according to claim 1, wherein the condition comprises: determining that the one or more samples associated with the interpolation filter are not available and a value of a fractional part of the BV being zero, the fractional part comprising a horizontal part or a vertical part, and
wherein skipping partially or fully, by the decoder, the padding process on the one or more samples comprises:
skipping, by the decoder, the padding process related to the fractional part of the BV, the value of which is zero.

3. The method according to claim 1, wherein the condition comprises: all samples associated with the interpolation filter being located inside of a valid reference area, and
wherein skipping partially or fully, by the decoder, the padding process on the one or more samples comprises:
fully skipping, by the decoder, the padding process.

4. The method according to claim 1, wherein conducting, by the decoder, the padding process on the one or more samples comprises:
determining, by the decoder, padding sizes for left or top samples located outside of a reference block pointed by an integer BV or an integer part of a BV as 1 sample size less than padding sizes for right or bottom samples located outside of the reference block.

5. The method according to claim 1, further comprising:
conducting, by the decoder, the padding process for any one or any combination of the following processes: motion search, motion refinement, or parameter generation for prediction refinement.

6. The method according to claim 1, further comprising:
skipping the padding process when applying the interpolation filter on the prediction block to obtain a filtered prediction for the current block.

7. An apparatus for video decoding, comprising:
one or more processors; and
a memory coupled to the one or more processors and configured to store instructions executable by the one or more processors,
wherein the one or more processors, upon execution of the instructions, are configured to perform operations comprising:
obtaining fractional motion information for a current block in an intra block copy (IBC) mode;
obtaining a block vector (BV) for the current block based on the fractional motion information;
obtaining a prediction block for the current block based on the BV; and
in response to meeting a condition, conducting, or skipping partially or fully, a padding process on one or more samples associated with an interpolation filter.

8. The apparatus of claim 7, wherein the condition comprises: determining that the one or more samples associated with the interpolation filter are not available and a value of a fractional part of the BV being zero, the fractional part comprising a horizontal part or a vertical part, and
wherein skipping partially or fully the padding process on the one or more samples comprises:
skipping the padding process related to the fractional part of the BV, the value of which is zero.

9. The apparatus of claim 7, wherein the condition comprises: all samples associated with the interpolation filter being located inside of a valid reference area, and
wherein skipping partially or fully the padding process on the one or more samples comprises:
fully skipping the padding process.

10. The apparatus of claim 7, wherein conducting the padding process on the one or more samples comprises:
determining padding sizes for left or top samples located outside of a reference block pointed by an integer BV or an integer part of a BV as 1 sample size less than padding sizes for right or bottom samples located outside of the reference block.

11. The apparatus of claim 7, wherein the operations further comprise:
conducting the padding process for any one or any combination of the following processes: motion search, motion refinement, or parameter generation for prediction refinement.

12. The apparatus of claim 7, wherein the operations further comprise:
skipping the padding process when applying the interpolation filter on the prediction block to obtain a filtered prediction for the current block.

13. A non-transitory computer-readable storage medium storing a bitstream to be decoded by the method according to claim 1.

14. The non-transitory computer-readable storage medium according to claim 13, wherein the condition comprises: determining that the one or more samples associated with the interpolation filter are not available and a value of a fractional part of the BV being zero, the fractional part comprising a horizontal part or a vertical part, and
wherein skipping partially or fully, by the decoder, the padding process on the one or more samples comprises:
skipping, by the decoder, the padding process related to the fractional part of the BV, the value of which is zero.

15. The non-transitory computer-readable storage medium according to claim 13, wherein the condition comprises: all samples associated with the interpolation filter being located inside of a valid reference area, and
wherein skipping partially or fully, by the decoder, the padding process on the one or more samples comprises:
fully skipping, by the decoder, the padding process.

16. The non-transitory computer-readable storage medium according to claim 13, wherein conducting, by the decoder, the padding process on the one or more samples comprises:
determining, by the decoder, padding sizes for left or top samples located outside of a reference block pointed by an integer BV or an integer part of a BV as 1 sample size less than padding sizes for right or bottom samples located outside of the reference block.

17. The non-transitory computer-readable storage medium according to claim 13, wherein the method further comprises:
conducting, by the decoder, the padding process for any one or any combination of the following processes: motion search, motion refinement, or parameter generation for prediction refinement.

18. The non-transitory computer-readable storage medium according to claim 13, wherein the method further comprises:
skipping the padding process when applying the interpolation filter on the prediction block to obtain a filtered prediction for the current block.

19. A method for storing a bitstream, comprising:
generating a bitstream by performing an encoding method; and
storing the bitstream,
wherein the encoding method comprises:
obtaining, by an encoder, fractional motion information for a current block in an intra block copy (IBC) mode;
obtaining, by the encoder, a block vector (BV) for the current block based on the fractional motion information;
obtaining, by the encoder, a prediction block for the current block based on the BV; and
in response to meeting a condition, conducting, or skipping partially or fully, by the encoder, a padding process on one or more samples associated with an interpolation filter.

20. The method according to claim 19, wherein the condition comprises: determining that the one or more samples associated with the interpolation filter are not available and a value of a fractional part of the BV being zero, the fractional part comprising a horizontal part or a vertical part, and
wherein skipping partially or fully, by the encoder, the padding process on the one or more samples comprises:
skipping, by the encoder, the padding process related to the fractional part of the BV, the value of which is zero.
